(19) United States
(12) Patent Application Publication
(10) Pub. No.: US 2025/0310796 A1
(43) Pub. Date: Oct. 2, 2025

(54) METHOD AND APPARATUS FOR OPTIMIZING CAPACITY AND COVERAGE IN WIRELESS COMMUNICATION SYSTEM

(71) Applicant: Samsung Electronics Co., Ltd., Gyeonggi-do (KR)

(72) Inventors: Yanru WANG, Beijing (CN); Lixiang XU, Beijing (CN); Hong WANG, Beijing (CN)

(21) Appl. No.: 19/092,222

(22) Filed: Mar. 27, 2025

(30) Foreign Application Priority Data
Mar. 27, 2024 (CN) 202410362838.9
Apr. 12, 2024 (CN) 202410447896.1

(51) Int. Cl. H04W 24/02; H04L 41/16; H04W 92/20; H04W 92/24

(52) U.S. Cl. CPC H04W 24/02; H04L 41/16; H04W 92/20; H04W 92/24

(57) ABSTRACT

The disclosure relates to a 5G or 6G communication system for supporting a higher data transmission rate. A method performed by a first node in a wireless communication system includes transmitting, to a second node, via an Xn interface or an F1 interface, first information including prediction information on an optimization of a capacity and a coverage, and receiving, from the second node, via the Xn interface or the F1 interface, second information based on the first information.

### CROSS-REFERENCE TO RELATED APPLICATION(S)

This application is based on and claims priority under 35 U.S.C. § 119 to Chinese Patent Application Nos. 202410362838.9 and 202410447896.1, which were filed in the Chinese Patent Office on Mar. 27, 2024, and Apr. 12, 2024, respectively, the entire disclosure of each of which is incorporated herein by reference.

### BACKGROUND

### 1. Field

The disclosure relates generally to wireless communication, and more particularly, to a node and a user equipment (UE) for optimizing capacity and coverage in a wireless communication system and methods performed by the same.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure has been made to address at least the above-mentioned problems and/or disadvantages and to provide at least the advantages described below.

Accordingly, an aspect of the disclosure is to provide a method and apparatus in a wireless communication system that effectively enable the nodes and/or UE to perform coverage and capacity optimization by exchanging information related to coverage and/or capacity of the nodes between the nodes and/or the UE.

In accordance with an aspect of the disclosure, a method performed by a first node in a wireless communication system includes transmitting, to a second node via an Xn interface or an F1 interface, first information including prediction information on an optimization of a capacity and a coverage, and receiving, from the second node via the Xn interface or the F1 interface, second information based on the first information.

In accordance with an aspect of the disclosure, a method performed by a second node in a wireless communication system, includes receiving, from a first node via Xn interface or F1 interface, first information including prediction information on an optimization of a capacity and a coverage, and transmitting, to the first node via the Xn interface or the F1 interface, second information generated based on the first information.

In accordance with an aspect of the disclosure, a first node in a wireless communication system includes a transceiver, and at least one processor coupled with the transceiver and configured to transmit, to a second node via Xn interface or F1 interface, first information including prediction information on an optimization of a capacity and a coverage, and receive, from the second node via the Xn interface or the F1 interface, second information based on the first information.

In accordance with an aspect of the disclosure, a second node in a wireless communication system includes a transceiver; and at least one processor coupled with the transceiver and configured to receive, from a first node via Xn interface or F1 interface, first information including prediction information on an optimization of a capacity and a coverage, and transmit, to the first node via the Xn interface or the F1 interface, second information generated based on the first information.

### BRIEF DESCRIPTION OF DRAWINGS

The above and other aspects, features and advantages of certain embodiments of the present disclosure will be more apparent from the following description taken in conjunction with the accompanying drawings, in which:

FIG. 1 illustrates a system architecture of system architecture evolution (SAE) according to an embodiment;

FIG. 2 illustrates a system architecture according to an embodiment;

FIGS. 3A and 3B illustrate a method for supporting coverage optimization according to an embodiment;

FIG. 4 illustrates a method for supporting coverage optimization according to an embodiment;

FIGS. 5A, 5B, 5C, and 5D illustrate a method for supporting coverage optimization according to an embodiment;

FIGS. 6A, 6B, and 6C illustrate a method for supporting coverage optimization according to an embodiment;

FIGS. 7A and 7B illustrate a method for supporting coverage optimization according to an embodiment;

FIGS. 8A, 8B, 8C, 8D, 8E, and 8F illustrate a method for supporting coverage optimization according to an embodiment;

FIGS. 9A and 9B illustrate a method for supporting coverage optimization according to an embodiment;

FIG. 10 illustrates a method performed by a first node in a wireless communication system according to an embodiment;

FIG. 11 illustrates a method performed by a second node in a wireless communication system according to an embodiment;

FIG. 12 illustrates a method performed by a third node in a wireless communication system according to an embodiment;

FIG. 13 illustrates a method performed by a UE in a wireless communication system according to an embodiment;

FIG. 14 illustrates a node according to an embodiment; and

FIG. 15 illustrates a UE according to an embodiment.

### DETAILED DESCRIPTION

The following description with reference to the accompanying drawings is provided to assist in a comprehensive understanding of various embodiments of the disclosure. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Descriptions of well-known functions and constructions may be omitted for the sake of clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the disclosure.

Singular forms “a,” “an,” and “the” include plural referents unless the context clearly dictates otherwise. Thus, e.g., reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure pertains. Such terms as those defined in a generally used dictionary are to be interpreted to have meanings equal to the contextual meanings in the relevant field of art and are not to be interpreted to have ideal or excessively formal meanings unless clearly defined in the present disclosure.

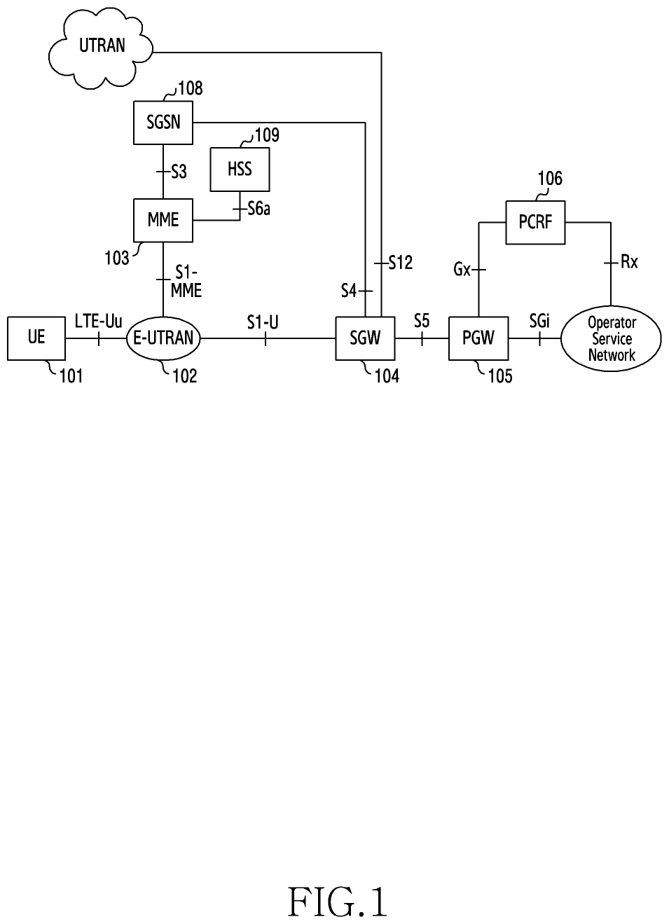

FIG. 1 illustrates a system architecture 100 of an SAE according to an embodiment.

Referring to FIG. 1, the UE 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the UE, an address of a serving node, user security information, and packet data context of the UE, etc.

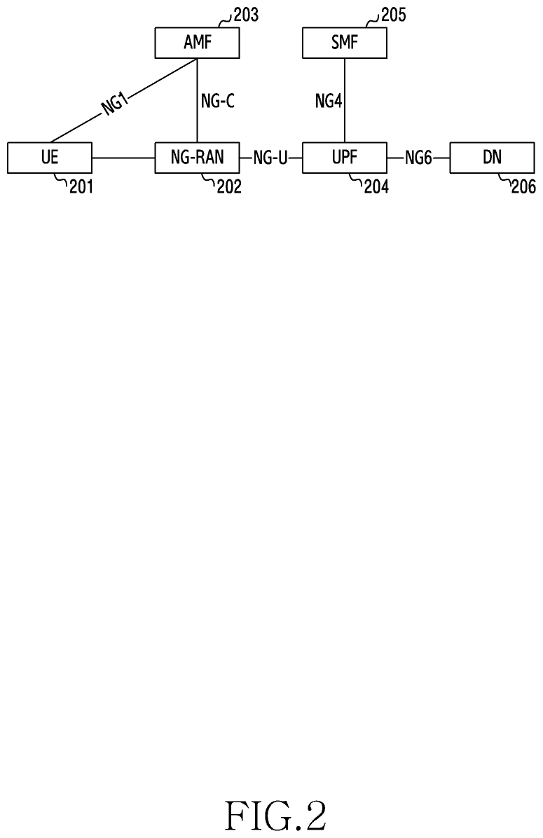

FIG. 2 illustrates a system architecture 200 according to an embodiment. Other embodiments of the system architecture 200 can be used without departing from the scope of the present disclosure.

Referring to FIG. 2, the UE 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function (AMF) 203 entity is responsible for managing mobility context and security information of the UE. A user plane function (UPF) 204 entity mainly provides functions of user plane. A session management function (SMF) 205 entity is responsible for session management. A data network (DN) 206 includes, e.g., services of operators, access of Internet and service of third parties.

Nodes mentioned in the present disclosure may include: gNB, gNB central unit (gNB-CU), gNB distributed unit (gNB-DU), gNB CU control plane (gNB-CU-CP), gNB CU user plane (gNB CU-UP), en-gNB, eNB, ng-eNB, UE, access and mobility management function (AMF), session management function (SMF), mobility management entity (MME) and other network entities or network logic units, and cells and/or beams managed by them, etc.

The information and/or field described in the present disclosure may be an average value, an instantaneous value, a maximum value, a minimum value, etc., but the disclosure is not limited thereto.

The information and/or field described in the present disclosure may be used to represent one or more of UL, DL, UL and DL, and UL or DL.

The information and/or fields described in the present disclosure may be a measured value and/or an actual value, or may be a predicted value.

The signal strength and/or signal quality and/or measurement report result and/or measurement result mentioned in the present disclosure may be a received signal strength indicator (RSSI), a reference signal receiving power, RSRP), a reference signal receiving quality (RSRQ), and a signal to interference plus noise ratio (SINR), etc.

A slice identification may be identified by one or more single network slice selection assistance information (S-NSSAI).

A failure type and/or problem type may also be referred to as a report type.

Reports related to a self-optimization network (SON) may include a connection establishment failure (CEF) report, a random access report, a successful handover report, a radio link failure (RLF) report, a measurement report, or other reports related to wireless connection.

RLF contains radio link and handover failure.

A TA value obtained in advance and a TA value in a layer 1 (L1)/L2 triggered mobility (LTM) command may refer to each other.

The network self-optimization decision mentioned in the present disclosure may include network energy saving, load balancing, coverage and/or capacity optimization, mobility optimization and/or management, making and/or updating configuration, etc.

A result and a report may refer to each other.

Time may be represented by timestamp, time point, time interval, timer, period of time, time length, time period, time spacing, etc. The time length may be the length of time from a certain time point, which may be the current time. The time may be relative or absolute. The period of time may be represented by separate fields, e.g., by a combination of a start time and an end time, or by a combination of a start time and a time period.

Quality of experience (QoE) parameters and/or user experience parameters may include round-trip time, jitter duration, corruption duration, average throughput, initial playout delay, playout delay at initial startup, device information, rendered viewports, codec information, buffer level, representation switch events, playlist, media presentation description (MPD) information, interactivity summary, interactivity event list, etc., and the satisfaction of QoE parameters. The satisfaction of QoE parameters may include whether QoE parameters meet QoE requirements, the proportion of QoE parameters which meet QoE requirements, proportion of QoE parameters which do not meet QoE requirements, information of time when QoE parameters meet the requirements, information of time when QoE parameters do not meet the requirements, cells for which their QoE parameters meet the requirements (ID and/or ID list), cells for which their QoE parameters do not meet the requirements (ID and/or ID list), beams for which their QoE parameters meet the requirements (ID and/or ID list), beams for which their QoE parameters do not meet the requirements (ID and/or ID list), slices for which their QoE parameters meet the requirements (ID and/or ID list), slices for which their QoE parameters do not meet the requirements (ID and/or ID list), nodes for which their QoE parameters meet the requirements (ID and/or ID list), nodes for which their QoE parameters do not meet the requirements, information of locations where QoE parameters meet the requirements, information of locations where QoE parameters do not meet the requirements, etc.

QoS parameters and/or QOS may include at least one of packet loss rate, delay, throughput, data rate, etc., and the satisfaction of QOS parameters. The satisfaction of QoS parameters may include whether QoS parameters meet QoS requirements, proportion of QoS parameters which meet QoS requirements, proportion of QoS parameters which do not meet QoS requirements, information of time when QoS parameters meet requirements, information of time when QoS parameters do not meet requirements, cells for which their QoS parameters meet the requirements (ID and/or ID list), cells for which their QoS parameters do not meet the requirements (ID and/or ID list), beams for which their QoS parameters meet the requirements (ID and/or ID list), beams for which their QoS parameters do not meet the requirements (ID and/or ID list), slices for which their QoS parameters meet the requirements (ID and/or ID list), slices for which their QoS parameters do not meet the requirements (ID and/or ID list), nodes for which their QoS parameters meet the requirements (ID and/or ID list), nodes for which their QoS parameters do not meet the requirements (ID and/or ID list), information of locations where QoS parameters meet the requirements, information of locations where QoS parameters do not meet the requirements, etc.

Load condition and/or load information and/or resource status information may include a physical resource block (PRB) usage ratio, available PRB number, allocated PRB number, scheduling PDCCH control channel element (CCE) usage, Transport Network Layer (TNL) capacity indication, radio resource status, comprehensive available capacity group, comprehensive available resource group, number of active user terminals, radio resource control (RRC) connection number, slice available capacity, hardware capacity indication, S1 TNL load indication, hardware load indication, almost blank subframe (ABS) status, reference signal received power (RSRP) measurement report list, reference signal receiving quality (RSRQ) measurement report, signal to interference plus noise ratio (SINR) measurement report, channel state information (CSI) report, cell report indication, channel occupancy time ratio, energy detection threshold, signal strength and/or signal quality, channel busy ratio, data volume, and Jitter of the various parameters, etc.

Load condition and/or load information may refer to resource status.

Predicted capacity information may be QoS requirement, QoS level, capacity status, average QoS requirement, average QoS level, average capacity status identification, proportion of one or more QoS requirements, proportion of one or more QoS levels, proportion of one or more capacity status identifications, etc., whether QoS parameters meet QoS requirements, proportion of QOS parameters which meet QoS requirements, and proportion of QoS parameters which do not meet QoS requirements. The capacity status is represented by an identification, where one identification represents one capacity configuration. The QoS level may be represented by an identification, such as a mapped 5G QoS identifier (5QI) or a QoS class identifier (QCI).

Capacity prediction information may be a predicted value of the capacity information.

The predicted coverage information may be coverage status, cell coverage status, beam coverage status, replacing cell information, beam coverage change information, slice coverage status, slice coverage status change information, information of coverage increase and/or decrease, proportion of coverage increase and/or decrease, information of load at cell edge, information of load that changes from within coverage to outside coverage due to coverage change, the coverage cannot meet coverage requirements, the coverage can meet the coverage requirements, information of time when the coverage meets the requirements, information of time when the coverage does not meet the requirements, cells for which their coverage meets the requirements (ID and/or ID list), cells for which their coverage does not meet the requirements (ID and/or ID list), beams for which their coverage meets the requirements (ID and/or ID list), beams for which their coverage does not meet the requirements (ID and/or ID list), slices for which their coverage meets the requirements (ID and/or ID list), slices for which their coverage does not meet the requirements (ID and/or ID list), nodes for which their coverage meets the requirements (ID and/or ID list), nodes for which their coverage does not meet the requirements (ID and/or ID list), information of locations where the coverage meets the requirements, information of locations where the coverage does not meet the requirements, etc. The coverage status may be represented by an identification, where one identification represents one coverage configuration.

Coverage prediction information may be a predicted value of the coverage information.

Coverage and/or capacity, coverage change, coverage and/or capacity optimization may refer to each other.

The predicted coverage and/or capacity policy (information) may include cell identification, cell status, cell deployment status indication, replacing cell information, beam coverage change information, slice deployment status indication, slice coverage status, slice coverage change information, slice identification, slice status, reasons for coverage change, etc.

The predicted replacing cell information may include identification of a replacing cell, identification of a replaced cell, proportion of the replacing cells which can replace a replaced cell, etc.

A replacing cell may refer to a cell that can replace a cell whose coverage has changed, to ensure coverage.

The beam coverage change information may include beam identification, beam coverage status, etc.

The slice coverage change information may include slice identification, slice coverage status, etc.

A beam may refer to an SSB beam or any other beam.

A location scope may be referred to by coordinate, area, cell identification, beam identification, identification for indicating a location and/or area, and the like. The cell identification may be accessing cell identification, connecting cell identification, serving cell identification, etc. The beam identification may be access beam identification, connecting beam identification, accessed beam identification, etc. The identification for indicating a location and/or area is used to represent one or more locations and/or one or more areas. This may also be an area with a distance greater than or equal to or less than a threshold, which is represented by an identification. Alternatively, it may be an area with a signal quality greater than or equal to or less than a threshold, which is represented by an identification.

A target node may also be a candidate target node, a target master node, a target secondary node, a candidate target master node, a candidate target secondary node, and the like.

A source node may also be a source master node, a source secondary node, and the like.

A UE and a user, a terminal and the like may refer to each other.

Collection and measurement may also be used interchangeably.

Policy and decision may also be used interchangeably.

Coverage and/or capacity policy may be used interchangeably with coverage and/or capacity optimization policy.

In some implementations, for example, a policy and/or a decision and/or a determination may be generated by an AI ML model.

Prediction information may be generated by an AI ML model.

Problems of coverage and/or capacity optimization may include a coverage hole, weak coverage, pilot pollution, overshoot coverage, DL and UL channel coverage mismatch, insufficient capacity, capacity is too low, capacity cannot meet the requirements, capacity cannot meet the QoS requirements, capacity cannot meet the QoE requirements, capacity is too high, capacity does not match the load, capacity is greater than the load, capacity is lower than the load, coverage is too large, coverage is too low, coverage does not conform the requirements, actual coverage does not conform a coverage and/or capacity policy, actual coverage is less than the coverage set by a coverage and/or capacity policy, actual coverage is greater than the coverage set by a coverage and/or capacity policy, actual coverage is inconsistent with the coverage set by a coverage and/or capacity policy, actual capacity does not conform a coverage and/or capacity policy, actual capacity is less than the coverage set by a coverage and/or capacity policy, actual capacity is greater than the coverage set by a coverage and/or capacity policy, and actual capacity is inconsistent with the coverage set by a coverage and/or capacity policy, and information related to the problems, etc. For example, the information related to the problems may include the time when a problem occurs, cells where a problem occurs (ID and/or ID list), nodes where the problem occurs (ID and/or ID list), slices where a problem occurs (ID and/or ID list), UEs affected by an occurred problem (ID and/or ID list), the coverage and/or capacity policy corresponding to a problem, and so on.

Problems of predicted coverage and/or capacity optimization may be formulated based on a predicted coverage and/or capacity policy, or based on a current capacity and/or coverage policy.

### Example 1

Disclosed is a method for supporting coverage optimization, including a first node transmits a first message containing a request for coverage and/or capacity-related prediction information to a second node to request the second node to report the requested coverage and/or capacity-related prediction information. The first node can make a self-optimization decision based on the coverage and/or capacity-related prediction information obtained from the second node, e.g., make a coverage and/or capacity optimization decision, set an appropriate coverage and/or capacity status, or predict a coverage and/or capacity optimization decision. The first node may request the second node to report the coverage and/or capacity prediction information corresponding to the second node. That is, after the second node receives the request, the second node predicts the coverage and/or capacity information of the second node and reports the predicted coverage and/or capacity prediction information to the first node. Alternatively, the first node may request the second node to report the coverage and/or capacity prediction information corresponding to the first node. That is, after the second node receives the request, the second node predicts the coverage and/or capacity information of the first node and reports the predicted coverage and/or capacity prediction information to the first node. Alternatively, the first node may request the second node to report the coverage and/or capacity prediction information corresponding to a neighboring cell, which may be a neighboring cell of the first node and/or the second node. That is, after receiving the request, the second node obtains the coverage and/or capacity prediction information of the neighboring cell from the neighboring cell, and/or predicts the coverage and/or capacity information of the neighboring cell, and transmits the coverage and/or capacity prediction information of the neighboring cell to the first node.

The first message may be included in one or more of the following:
a RESOURCE STATUS REQUEST message or an NG-RAN NODE CONFIGURATION UPDATE message or an NG-RAN NODE CONFIGURATION UPDATE ACKNOWLEDGE message or an XN SETUP REQUEST message or an XN SETUP RESPONSE message or a DATA COLLECTION REQUEST message of Xn;
or an NG SETUP REQUEST message or an NG SETUP RESPONSE message or a RAN CONFIGURATION UPDATE message or a RAN CONFIGURATION UPDATE ACKNOWLEDGE message or an AMF CONFIGURATION UPDATE message or an AMF CONFIGURATION UPDATE ACKNOWLEDGE message or an AMF STATUS INDICATION message or an OVERLOAD START message or an OVERLOAD STOP message of NG;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS REQUEST message of F1;
or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a GNB-CU-CP CONFIGURATION UPDATE ACKNOWLEDGE message or a GNB-CU-UP STATUS INDICATION message or a RESOURCE STATUS REQUEST message of E1;
or a newly defined RRC and/or Xn and/or X2 and/or F1 and/or E1 and/or NG message and/or RRC container and/or medium access control (MAC) control element (CE), etc.

The first message may include one or more of the following information and/or fields:
Transmitting node ID is used to identify the node that transmits the message.
Receiving node ID is used to identify the node that receives the message.
Request ID is used to identify a request.
Prediction ID is used to identify a prediction request.
Measurement ID is used to identify a measurement request.
Report ID is used to identify a report request.
Configuration ID is used to identify a measurement and/or prediction and/or reporting configuration.

Identification of a request for coverage and/or capacity prediction information is used to indicate a request for coverage and/or capacity prediction information. This field may be represented by a single bit. For example, when the bit is 1, this indicates that coverage and/or capacity prediction information is requested, and when the bit is 0, this indicates that coverage and/or capacity prediction information is not requested; alternatively, when the bit is 0, this indicates that coverage and/or capacity prediction information is requested, and when the bit is 1, this indicates that coverage and/or capacity prediction information is not requested. Alternatively, when this field is present, this indicates that coverage and/or capacity prediction information is requested, and when this field is not present, this indicates that coverage and/or capacity prediction information is not requested.

Prediction registration request is used to indicate the type of a prediction request. For example, it may include start, end, add, update, etc.

Registration request is used to indicate the type of a request. For example, it may include start, end, add, update, etc.

Report registration request is used to indicate the type of a report request. For example, it may include start, end, add, update, etc.

Requested prediction time is used to indicate a time and/or time interval for prediction. The time may be relative or absolute. The time interval may be indicated by a timer, a combination of a start time and an end time, and a combination of a start time and a time duration, etc. The time interval may be represented by 2*n bits, e.g., the first n bits represent the prediction start time and the last n bits represent the prediction end time. It may also be represented by separate fields, including one or more of the following:

Prediction start time is used to indicate the start time of a prediction. The start time may be relative or absolute.

Prediction end time is used to indicate the end time of a prediction. The end time may be relative or absolute.

Applicable/validity time of a requested prediction content is used to indicate the time and/or time interval corresponding to the prediction content. The time may be relative or absolute. The time interval may be indicated by a timer, a combination of a start time and an end time, or a combination of a start time and a time duration, etc. The time interval may be represented by 2*n bits, e.g., the first n bits represent the start time and the last n bits represent the end time. It may also be represented by separate fields, including one or more of the following:

Start time is used to indicate the start time of the applicable/validity time. The start time may be relative or absolute.

End time is used to indicate the end time of the applicable/validity time. The end time may be relative or absolute.

Reporting time of a requested prediction content is used to indicate the time and/or time interval for reporting the prediction content. The time may be relative or absolute. The time interval may be indicated by a timer, a combination of a start time and an end time, or a combination of a start time and a time duration, etc. The time interval may be represented by 2*n bits, e.g., the first n bits represent the start time and the last n bits represent the end time. It may also be represented by separate fields, including one or more of the following:

Start time is used to indicate the start time of the reporting time. The start time may be relative or absolute.

End time is used to indicate the end time of the reporting time. The end time may be relative or absolute.

Reporting mode of a prediction content is used to indicate a requested content reporting mode. It may include single reporting, periodic reporting, on-demand reporting and event-triggered reporting, etc.

Reporting period of a prediction content is used to indicate a time spacing of periodic reporting of a prediction content. The reporting period may also be a prediction time of the reported data. For example, if there is no content about this field, a single reporting is indicated, and the reporting time of the single reporting is from the prediction start time to the prediction end time.

Content requested to be predicted is used to indicate a content requested to be predicted. The content may include capacity information, coverage information, QoS level, proportion corresponding to a QoS level, location information corresponding to a QoS level, information of coverage increase and/or decrease, proportion of coverage increase and/or decrease, information of load at cell edge, information of load that changes from within coverage to outside coverage due to coverage change, coverage and/or capacity optimization problems, etc. The QoS level may be represented by an identification, e.g., a mapped 5QI or a QCI.

Configuration of coverage and/or capacity prediction information indicates a configuration of the coverage and/or capacity prediction information, which may be a report configuration or a prediction configuration. The configuration information of the coverage and/or capacity prediction information may include one or more of the following:

Cell ID indicates a cell corresponding to the requested coverage and/or capacity prediction information. It may be an ID or a list of IDs. The cell ID may be a cell ID corresponding to a cell managed by the first node, a cell ID corresponding to a cell managed by the second node, a cell ID of a neighboring cell of the first node and/or the second node, or a cell ID of any cell.

Node ID indicates a node corresponding to the requested coverage and/or capacity prediction information. It may be an ID or a list of IDs.

Beam ID indicates a beam corresponding to the requested coverage and/or capacity prediction information. It may be an ID or a list of IDs. The beam ID may be a beam ID corresponding to a cell managed by the first node, a beam ID corresponding to a cell managed by the second node, a beam ID corresponding to a neighboring cell of the first node and/or the second node, or a beam ID corresponding to any cell.

Slice ID indicates a slice corresponding to the requested coverage and/or capacity prediction information. It may be an ID or a list of IDs.

User ID indicates a user corresponding to the requested capacity prediction information. It may be an ID or a list of IDs.

Event and/or condition that triggers reporting: when the event and/or condition that triggers reporting is met, the predicted coverage and/or capacity prediction information needs to be reported. The event and/or condition that triggers reporting includes one or more of the following:
the difference between the capacity prediction information and the current capacity is greater than or equal to or less than a predetermined threshold. Configuration of the event and/or condition may include event and/or condition identification, a predetermined threshold, a time when the event and/or condition is met, a time when the prediction information meets the event and/or condition, etc.
the difference between the coverage prediction information and the current coverage is greater than or equal to or less than a predetermined threshold. Configuration of the event and/or condition may include event and/or condition identification, a predetermined threshold, a time when the event and/or condition is met, a time when the prediction information meets the event and/or condition, etc.
the capacity prediction information is inconsistent with the current capacity information. Configuration of the event and/or condition may include event and/or condition identification, a time when the event and/or condition is met, a time when the prediction information meets the event and/or condition, etc.
the coverage prediction information is inconsistent with the current coverage information. Configuration of the event and/or condition may include event and/or condition identification, a time when the event and/or condition is met, a time when the prediction information meets the event and/or condition, etc.
a new QoS level that has not appeared at present appears.
proportion corresponding to one or more QoS levels is greater than or equal to or less than a predetermined threshold. Configuration of the event and/or condition may include event and/or condition identification, a predetermined threshold, a time when the event and/or condition is met, a time when the prediction information meets the event and/or condition, etc.
a change value of the proportion corresponding to one or more QoS levels is greater than or equal to or less than a predetermined threshold. Configuration of the event and/or condition may include event and/or condition identification, a predetermined threshold, a time when the event and/or condition is met, a time when the prediction information meets the event and/or condition, etc.
location information corresponding to one or more QoS levels is greater than or equal to or less than a predetermined scope and/or threshold. Configuration of the event and/or condition may include event and/or condition identification, a predetermined scope and/or threshold, a time when the event and/or condition is met, a time when the prediction information meets the event and/or condition, etc.
a change amount of the location information corresponding to one or more QoS levels is greater than or equal to or less than a predetermined scope and/or threshold. Configuration of the event and/or condition may include event and/or condition identification, a predetermined scope and/or threshold, a time when the event and/or condition is met, a time when the prediction information meets the event and/or condition, etc.
it is predicted that a coverage and/or capacity optimization problem will occur. The event and/or condition includes event and/or condition identification, meeting time, event and/or condition.
a coverage and/or capacity optimization problem is found. The event and/or condition includes event and/or condition identification, meeting time, event and/or condition.

Corresponding scope of requested coverage prediction and/or capacity prediction and/or coverage prediction information reporting and/or capacity prediction information reporting is used to indicate a corresponding scope of the requested coverage prediction and/or capacity prediction and/or coverage prediction information reporting and/or capacity prediction information reporting. The scope may be the identification and/or identification list of slice, service, scenario, node, UE, cell, beam, channel, protocol data unit (PDU) session, data radio bearer (DRB), QOS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

After receiving the first message containing the request for coverage and/or capacity-related prediction information from the first node, the second node transmits a second message containing a response of the coverage and/or capacity-related prediction information to the first node, to inform the first node whether the second node can perform reporting and/or prediction according to the first message. For example, if the second message received by the first node indicates that the second node can report and/or predict coverage and/or capacity-related information, the first node may subsequently receive coverage and/or capacity prediction information reported by the second node, e.g., reported through a subsequent third message.

The second message may be included in one or more of the following:
a RESOURCE STATUS RESPONSE message or a RESOURCE STATUS FAILURE message or an NG-RAN NODE CONFIGURATION UPDATE message or an NG-RAN NODE CONFIGURATION UPDATE ACKNOWLEDGE message or a XN SETUP REQUEST message or a XN SETUP RESPONSE message or a DATA COLLECTION RESPONSE message or a DATA COLLECTION FAILURE message of Xn;
or an NG SETUP REQUEST message or an NG SETUP RESPONSE message or a RAN CONFIGURATION UPDATE message or a RAN CONFIGURATION UPDATE ACKNOWLEDGE message or an AMF CONFIGURATION UPDATE message or an AMF CONFIGURATION UPDATE ACKNOWLEDGE message or an AMF STATUS INDICATION message or an OVERLOAD START message or an OVERLOAD STOP message of NG;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS RESPONSE message or a RESOURCE STATUS FAILURE message of F1;
or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a GNB-CU-CP CONFIGURATION UPDATE ACKNOWLEDGE message or a GNB-CU-UP STATUS INDICATION message or a RESOURCE STATUS RESPONSE message or a RESOURCE STATUS FAILURE message of E1;
or another and/or newly defined RRC and/or Xn and/or X2 and/or F1 and/or E1 and/or NG message and/or RRC container and/or MAC CE, etc.

The second message may include one or more of the following information and/or fields:

Transmitting node ID is used to identify the node that transmits the message.

Receiving node ID is used to identify the node that receives the message.

Measurement ID is used to identify a measurement. For example, the measurement ID may be consistent with the measurement ID in the first message, to associate the response message with the request message.

Request ID is used to identify a request. For example, the request ID may be consistent with the request ID in the first message, to associate the response message with the request message.

Prediction ID is used to identify a prediction request. For example, the prediction ID may be consistent with the prediction ID in the first message, to associate the response message with the request message.

Report ID is used to identify a report request. For example, the report ID may be consistent with the report ID in the first message, to associate the response message with the request message.

Configuration ID is used to identify a measurement and/or prediction and/or reporting configuration. For example, the configuration ID may be consistent with the configuration ID in the first message, to associate the response message with the request message.

Confirmation/Acknowledge of the request for coverage and/or capacity prediction is used to indicate whether coverage and/or capacity prediction information can be predicted and/or reported. This information may indicate whether the coverage and/or capacity prediction information can be predicted and/or reported by one bit.

Content that can be reported and/or predicted: the content may include capacity information, coverage information, QoS level, proportion corresponding to a QoS level, location information corresponding to a QoS level, information of coverage increase and/or decrease, proportion of coverage increase and/or decrease, information of load at cell edge, information of load that changes from within coverage to outside coverage due to coverage change, coverage and/or capacity optimization problems, prediction precision and/or accuracy, etc. The QoS level may be represented by an identification, e.g., a mapped 5QI or a QOS QCI.

Corresponding scope in which coverage prediction and/or capacity prediction and/or coverage prediction information reporting and/or capacity prediction information reporting can be performed is used to indicate a corresponding scope in which the coverage prediction and/or capacity prediction and/or coverage prediction information reporting and/or capacity prediction information reporting can be performed. The scope may be the identification and/or identification list of slice, service, scenario, node, UE, cell, beam, channel, protocol data unit (PDU) session, a data radio bearer (DRB), QoS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

Information of a reporting and/or prediction that can be performed, which may include the prediction time corresponding to a reporting and/or prediction that can be performed, the applicable/validity time of a prediction content corresponding to a reporting and/or prediction that can be performed, the reporting time of a prediction content corresponding to a reporting and/or prediction that can be performed, the reporting mode of a prediction content corresponding to a reporting and/or prediction that can be performed, the reporting period of a prediction content corresponding to a reporting and/or prediction that can be performed, the configuration of coverage and/or capacity prediction information corresponding to a reporting and/or prediction that can be performed, the event and/or condition that triggers reporting corresponding to a reporting and/or prediction that can be performed, etc. The specific contents of the prediction time, the applicable/validity time of a prediction content, the reporting time of a prediction content, the reporting mode of a prediction content, the reporting period of a prediction content, the configuration of coverage and/or capacity prediction information, and the event and/or condition that triggers reporting may refer to the first message.

Corresponding scope in which coverage prediction and/or capacity prediction and/or coverage prediction information reporting and/or capacity prediction information reporting cannot be performed is used to indicate a corresponding scope in which the coverage prediction and/or capacity prediction and/or coverage prediction information reporting and/or capacity prediction information reporting cannot be performed. The scope may be the identification and/or identification list of slice, service, scenario, node, UE, cell, beam, channel, PDU session, DRB, QoS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

Content that cannot be reported and/or predicted: the content may include capacity information, coverage information, QoS level, proportion corresponding to a QoS level, location information corresponding to a QoS level, information of coverage increase and/or decrease, proportion of coverage increase and/or decrease, information of load at cell edge, information of load that changes from within coverage to outside coverage due to coverage change, coverage and/or capacity optimization problems, prediction precision and/or accuracy, etc. The QoS level may be represented by an identification, e.g., a mapped 5QI or a QCI.

Information of a reporting and/or prediction that cannot be performed, which may include the prediction time corresponding to a reporting and/or prediction that cannot be performed, the applicable/validity time of a prediction content corresponding to a reporting and/or prediction that cannot be performed, the reporting time of a prediction content corresponding to a reporting and/or prediction that cannot be performed, the reporting mode of a prediction content corresponding to a reporting and/or prediction that cannot be performed, the reporting period of a prediction content corresponding to a reporting and/or prediction that cannot be performed, the configuration of coverage and/or capacity prediction information corresponding to a reporting and/or prediction that cannot be performed, the event and/or condition that triggers reporting corresponding to a reporting and/or prediction that cannot be performed, etc. The specific contents of the prediction time, the applicable/validity time of a prediction content, the reporting time of a prediction content, the reporting mode of a prediction content, the reporting period of a prediction content, the configuration of coverage and/or capacity prediction information, and the event and/or condition that triggers reporting may refer to the first message.

Cause/reason indicates the reason why prediction and/or reporting cannot be performed. The reasons may include the reporting time is unavailable, the reporting period is unavailable, the coverage and/or capacity prediction is unavailable, the prediction is unavailable, the prediction is temporarily unavailable, the coverage and/or capacity prediction is temporarily unavailable, the prediction time is unavailable, the prediction reporting time is unavailable, the valid time of prediction information is unavailable, the reporting period of prediction information is unavailable, the reporting time is unsupported, the reporting period is unsupported, the coverage and/or capacity prediction is unsupported, the prediction is unsupported, the prediction is temporarily unsupported, the coverage and/or capacity prediction is temporarily unsupported, the prediction time is unsupported, the prediction reporting time is unsupported, the valid time of prediction information is unsupported, the reporting period of prediction information is unsupported, etc.

The second node transmits a third message containing coverage and/or capacity prediction information to the first node according to its own situation and/or according to the first message containing a request for coverage and/or capacity prediction information received from the first node. The first node can make a self-optimization decision based on the capacity and/or coverage-related prediction information obtained from the second node, e.g., make a coverage and/or capacity optimization decision, set an appropriate coverage and/or capacity status, or predict a coverage and/or capacity optimization decision. In some implementations, for example, when the predicted capacity information indicates that a requirement for capacity is large at a certain time (period) in the future, the node can plan ahead to reduce its coverage scope at the certain time in the future to improve the capacity of this scope. The second node may report the coverage and/or capacity prediction information corresponding to the second node. That is, the second node predicts the coverage and/or capacity information of the second node and reports the predicted coverage and/or capacity prediction information to the first node. Alternatively, the second node may report the coverage and/or capacity prediction information corresponding to the first node. That is, the second node predicts the coverage and/or capacity information of the first node and reports the predicted coverage and/or capacity prediction information to the first node. Alternatively, the second node may report the coverage and/or capacity prediction information corresponding to a neighboring cell, which may be a neighboring cell of the first node and/or the second node. That is, the second node obtains the coverage and/or capacity prediction information of the neighboring cell from the neighboring cell, and/or predicts the coverage and/or capacity information of the neighboring cell, and transmits the coverage and/or capacity prediction information of the neighboring cell to the first node. The first node can make and/or adjust the coverage and/or capacity decision by using the predicted coverage and/or capacity optimization problem, and can also forward it to other nodes for the other nodes to make and/or adjust the coverage and/or capacity decision.

The third message may be included in one or more of the following:
a RESOURCE STATUS UPDATE message or an NG-RAN NODE CONFIGURATION UPDATE message or an NG-RAN NODE CONFIGURATION UPDATE ACKNOWLEDGE message or an XN SETUP REQUEST message or an XN SETUP RESPONSE message or a DATA COLLECTION UPDATE message of Xn;
or an NG SETUP REQUEST message or an NG SETUP RESPONSE message or a RAN CONFIGURATION UPDATE message or a RAN CONFIGURATION UPDATE ACKNOWLEDGE message or an AMF CONFIGURATION UPDATE message or an AMF CONFIGURATION UPDATE ACKNOWLEDGE message or an AMF STATUS INDICATION message or an OVERLOAD START message or an OVERLOAD STOP message of NG;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS UPDATE message of F1;
or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a GNB-CU-CP CONFIGURATION UPDATE ACKNOWLEDGE message or a GNB-CU-UP STATUS INDICATION message or a RESOURCE STATUS UPDATE message of E1;
or another and/or newly defined RRC and/or Xn and/or X2 and/or F1 and/or E1 and/or NG message and/or RRC container and/or MAC CE, etc.

The third message may include one or more of the following information and/or fields:

Transmitting node ID is used to identify the node that transmits the message.

Receiving node ID is used to identify the node that receives the message.

Measurement ID is used to identify a measurement. For example, the measurement ID may be consistent with the measurement ID in the first message, to associate the reporting message with the request message.

Request ID is used to identify a request. For example, the request ID may be consistent with the request ID in the first message, to associate the reporting message with the request message.

Prediction ID is used to identify a prediction request. For example, the prediction ID may be consistent with the prediction ID in the first message, to associate the reporting message with the request message.

Report ID is used to identify a report request. For example, the report ID may be consistent with the report ID in the first message, to associate the reporting message with the request message.

Configuration ID is used to identify a measurement and/or prediction and/or reporting configuration. For example, the configuration ID may be consistent with the configuration ID in the first message, to associate the reporting message with the request message.

Predicted coverage and/or capacity information is used to indicate the predicted coverage and/or capacity information. The content may include capacity information, coverage information, QOS level, proportion corresponding to a QoS level, location information corresponding to a QoS level, information of coverage increase and/or decrease, proportion of coverage increase and/or decrease, information of load at cell edge, information of load that changes from within coverage to outside coverage due to coverage change, coverage and/or capacity optimization problems, prediction precision and/or accuracy, etc. The QoS level may be represented by an identification, e.g., a mapped 5QI or a QCI.

Applicable/validity scope corresponding to the predicted coverage and/or capacity information is used to indicate a scope corresponding to the predicted coverage and/or capacity. The scope may be the identification and/or identification list of slice, service, scenario, node, UE, cell, beam, channel, PDU session, DRB, QOS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

Applicable/validity time corresponding to the predicted coverage and/or capacity information is used to indicate the time and/or time interval corresponding to the predicted coverage and/or capacity information. The time may be relative or absolute. The time interval may be indicated by a timer, a combination of a start time and an end time, or a combination of a start time and a time duration, etc. The time interval may be represented by 2*n bits, e.g., the first n bits represent the start time and the last n bits represent the end time. It may also be represented by separate fields, including one or more of the following:

Start time is used to indicate the start time of the applicable/validity time. The start time may be relative or absolute.

End time is used to indicate the end time of the applicable/validity time. The end time may be relative or absolute.

Event and/or condition that triggered reporting indicates the event and/or condition that triggered the reporting. The event and/or condition that triggered the reporting may be an event and/or condition of the events and/or conditions that trigger reporting in the first message.

### Example 2

A method for supporting coverage optimization as disclosed herein includes a third node transmits a fourth message containing a suggested and/or allowed coverage and/or capacity policy to a fourth node to inform the fourth node of the suggested and/or allowed coverage and/or capacity policy. In an implementation, the fourth node may formulate a coverage and/or capacity policy according to the suggested and/or allowed coverage and/or capacity policy.

The fourth message may be included in one or more of the following:
a RESOURCE STATUS REQUEST message or a RESOURCE STATUS RESPONSE message or a RESOURCE STATUS FAILURE message or a RESOURCE STATUS UPDATE message or an NG-RAN NODE CONFIGURATION UPDATE message or an NG-RAN NODE CONFIGURATION UPDATE ACKNOWLEDGE message or an XN SETUP REQUEST message or an XN SETUP RESPONSE message or a DATA COLLECTION REQUEST message or a DATA COLLECTION RESPONSE message or a DATA COLLECTION FAILURE message or a DATA COLLECTION UPDATE message;
or an NG SETUP REQUEST message or an NG SETUP RESPONSE message or a RAN CONFIGURATION UPDATE message or a RAN CONFIGURATION UPDATE ACKNOWLEDGE message or an AMF CONFIGURATION UPDATE message or an AMF CONFIGURATION UPDATE ACKNOWLEDGE message or an AMF STATUS INDICATION message or an OVERLOAD START message or an OVERLOAD STOP message of NG;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS REQUEST message or a RESOURCE STATUS RESPONSE message or a RESOURCE STATUS FAILURE message or a RESOURCE STATUS UPDATE message of F1;
or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a GNB-CU-CP CONFIGURATION UPDATE ACKNOWLEDGE message or a GNB-CU-UP STATUS INDICATION message or a RESOURCE STATUS REQUEST message or a RESOURCE STATUS RESPONSE message or a RESOURCE STATUS FAILURE message or a RESOURCE STATUS UPDATE message of E1;
or another and/or newly defined RRC and/or Xn and/or X2 and/or F1 and/or E1 and/or NG message and/or RRC container and/or MAC CE, etc.

The fourth message may include one or more of the following information and/or fields:

Transmitting node ID is used to identify the node that transmits the message.

Receiving node ID is used to identify the node that receives the message.

Suggested coverage and/or capacity policy, which may include one or more of the following:
the suggested coverage and/or capacity policy
cell ID
beam ID
node ID
time corresponding to the suggested coverage and/or capacity policy

Identification of whether the message receiving node is allowed to change the coverage and/or capacity policy indicates whether the message receiving node is allowed to change the coverage and/or capacity policy.

Scope in which the change of coverage and/or capacity policy is allowed: this scope may be a single scope or a scope list. The scope may include one or more of the following:
cell ID may be an ID or an ID list.
beam ID may be an ID or an ID list.
node ID may be an ID or an ID list.

Time when the change of coverage and/or capacity policy is allowed.

Location scope in which the change of coverage and/or capacity policy is allowed.

Areas where the change of coverage and/or capacity policy is allowed are areas where the signal strength is greater than or equal to or less than a predetermined threshold, or areas where the signal strength is within a predetermined scope. This information may include a predetermined threshold, a predetermined scope, a signal strength type, etc. The signal strength type may include RSRQ, RSRP, SINR, etc.

Coverage and/or capacity policy allowed to be set may include one or more of the following:

Maximum and/or minimum values of the coverage and/or capacity policy allowed to be set.

Coverage and/or capacity policy allowed to be set may be a capacity and/or coverage status (and/or status list) allowed to be set, where the capacity and/or coverage status may be represented by an identification.

Minimum coverage and/or maximum coverage corresponding to the coverage allowed to be set.

Coverage status allowed to be set may be a coverage status (and/or status list) allowed to be set, where the coverage status may be represented by an identification.

Maximum capacity and/or minimum capacity corresponding to the capacity allowed to be set

Capacity status allowed to be set may be a capacity status (and/or status list) allowed to be set, where the capacity status may be represented by an identification.

Identification and/or identification list of cells (and/or beams) which can be served as replacing cells (and/or beams).

Scope in which the change of coverage and/or capacity policy is not allowed: this scope may be a single scope or a scope list. The scope may include one or more of the following:
cell ID may be an ID or an ID list.
beam ID may be an ID or an ID list.
node ID may be an ID or an ID list.

Time when the change of coverage and/or capacity policy is not allowed.

Location scope in which the change of coverage and/or capacity policy is not allowed.

Areas where the change of coverage and/or capacity policy is not allowed are areas where the signal strength is greater than or equal to or less than a predetermined threshold, or areas where the signal strength is within a predetermined scope. This information may include a predetermined threshold, a predetermined scope, a signal strength type, etc. The signal strength type may include RSRQ, RSRP, SINR, etc.

Coverage and/or capacity policy not allowed to be set may include one or more of the following:

Maximum and/or minimum values of the coverage and/or capacity policy that is not allowed to be set.

Coverage and/or capacity policy that is not allowed to be set may be a capacity and/or coverage status (and/or status list) that is not allowed to be set, where the capacity and/or coverage status may be represented by an identification.

Minimum coverage and/or maximum coverage corresponding to the coverage that is not allowed to be set.

Coverage status that is not allowed to be set may be a coverage status (and/or status list) that is not allowed to be set, where the coverage status may be represented by an identification.

Maximum capacity and/or minimum capacity corresponding to the capacity that is not allowed to be set.

Capacity status that is not allowed to be set may be a capacity status (and/or status list) that is not allowed to be set, where the capacity status may be represented by an identification.

Identification and/or identification list of cells (and/or beams) which cannot be served as replacing cells (and/or beams).

Cause/reason indicates the reason for the suggested and/or allowed coverage and/or capacity policy mentioned above. The reasons may include coverage guarantee, capacity guarantee, avoiding of coverage hole, etc.

### Example 3

Disclosed is a method for supporting coverage optimization, including a fifth node transmits a fifth message containing a request for coverage and/or capacity policy related prediction information to a sixth node to request the sixth node to transmit a predicted coverage and/or capacity policy. The fifth node can make relevant self-optimization decisions by using the predicted coverage and/or capacity policy. For example, if a predicted coverage and/or capacity policy of a neighboring cell is received, which is that the neighboring cell will reduce its coverage at a certain time in the future, the node will not select this neighboring cell as a handover target cell when performing handover for a UE, to avoid the need for handover again when the coverage of the neighboring cell is reduced after the UE is handed over to the neighboring cell.

The fifth message may be included in one or more of the following:
a RESOURCE STATUS REQUEST message or an NG-RAN NODE CONFIGURATION UPDATE message or an NG-RAN NODE CONFIGURATION UPDATE ACKNOWLEDGE message or an XN SETUP REQUEST message or an XN SETUP RESPONSE message or a DATA COLLECTION REQUEST message of Xn;
or an NG SETUP REQUEST message or an NG SETUP RESPONSE message or a RAN CONFIGURATION UPDATE message or a RAN CONFIGURATION UPDATE ACKNOWLEDGE message or an AMF CONFIGURATION UPDATE message or an AMF CONFIGURATION UPDATE ACKNOWLEDGE message or an AMF STATUS INDICATION message or an OVERLOAD START message or an OVERLOAD STOP message of NG;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS REQUEST message of F1;
or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a GNB-CU-CP CONFIGURATION UPDATE ACKNOWLEDGE message or a GNB-CU-UP STATUS INDICATION message or a RESOURCE STATUS REQUEST message of E1;
or another and/or newly defined RRC and/or Xn and/or X2 and/or F1 and/or E1 and/or NG message and/or RRC container and/or MAC CE, etc.

The fifth message may include one or more of the following information and/or fields:

Transmitting node ID is used to identify the node that transmits the message.

Receiving node ID is used to identify the node that receives the message.

Request ID is used to identify a request.

Prediction ID is used to identify a prediction request.

Measurement ID is used to identify a measurement request.

Report ID is used to identify a report request.

Configuration ID is used to identify a measurement and/or prediction and/or reporting configuration.

Identification of a request for coverage and/or capacity policy prediction information is used to indicate a request for prediction information of a coverage and/or capacity policy. This field may be represented by a single bit. For example, when the bit is 1, this indicates that the prediction information of a coverage and/or capacity policy is requested, and when the bit is 0, this indicates that the prediction information of a coverage and/or capacity policy is not requested. Alternatively, when the bit is 0, this indicates that the prediction information of a coverage and/or capacity policy is requested, and when the bit is 1, this indicates that the prediction information of a coverage and/or capacity policy is not requested. Alternatively, when this field is present, this indicates that the prediction information of a coverage and/or capacity policy is requested, and when this field is not present, this indicates that the prediction information of a coverage and/or capacity policy is not requested.

Prediction registration request is used to indicate the type of a prediction request. For example, it may include start, end, add, update, etc.

Registration request is used to indicate the type of a request. For example, it may include start, end, add, update, etc.

Report registration request is used to indicate the type of a report request. For example, it may include start, end, add, update, etc.

Requested prediction time is used to indicate a time and/or time interval for prediction. The time may be relative or absolute. The time interval may be indicated by a timer, a combination of a start time and an end time, and a combination of a start time and a time duration, etc. The time interval may be represented by 2*n bits, e.g., the first n bits represent the prediction start time and the last n bits represent the prediction end time and may also be represented by separate fields, including one or more of the following:

Prediction start time is used to indicate the start time of a prediction. The start time may be relative or absolute.

Prediction end time is used to indicate the end time of a prediction. The end time may be relative or absolute.

Applicable/validity time of a requested prediction content is used to indicate the time and/or time interval corresponding to the prediction content. The time may be relative or absolute. The time interval may be indicated by a timer, a combination of a start time and an end time, or a combination of a start time and a time duration, etc. The time interval may be represented by 2*n bits, e.g., the first n bits represent the start time and the last n bits represent the end time. It may also be represented by separate fields, including one or more of the following:

Start time is used to indicate the start time of the applicable/validity time. The start time may be relative or absolute.

End time is used to indicate the end time of the applicable/validity time. The end time may be relative or absolute.

Reporting time of a requested prediction content is used to indicate the time and/or time interval for reporting the prediction content. The time may be relative or absolute. The time interval may be indicated by a timer, a combination of a start time and an end time, or a combination of a start time and a time duration, etc. The time interval may be represented by 2*n bits, e.g., the first n bits represent the start time and the last n bits represent the end time. It may also be represented by separate fields, including one or more of the following:

Start time is used to indicate the start time of the reporting time. The start time may be relative or absolute.

End time is used to indicate the end time of the reporting time. The end time may be relative or absolute.

Reporting mode of a prediction content is used to indicate a requested content reporting mode. It may include single reporting, periodic reporting, on-demand reporting and event-triggered reporting, etc.

Reporting period of a prediction content is used to indicate a time spacing of periodic reporting of a prediction content. The reporting period may also be a prediction time of the reported data. For example, if there is no content about this field, a single reporting is indicated, and the reporting time of the single reporting is from the prediction start time to the prediction end time.

Configuration of prediction information of a coverage and/or capacity policy indicates a configuration of the prediction information of a coverage and/or capacity policy, which may be a report configuration or a prediction configuration. The configuration information of the prediction information of a coverage and/or capacity policy may include one or more of the following:

Cell ID indicates a cell corresponding to the requested prediction information of a coverage and/or capacity policy. It may be an ID or a list of IDs.

Node ID indicates a node corresponding to the requested prediction information of a coverage and/or capacity policy. It may be an ID or a list of IDs.

Beam ID indicates a beam corresponding to the requested prediction information of a coverage and/or capacity policy. It may be an ID or a list of IDs.

Slice ID indicates a slice corresponding to the requested prediction information of a coverage and/or capacity policy. It may be an ID or a list of IDs.

Event and/or condition that triggers reporting: when the event and/or condition that triggers reporting is met, the prediction information of a prediction coverage and/or capacity policy needs to be reported. The event and/or condition that triggers reporting includes one or more of the following:
the prediction information of a coverage and/or capacity policy is inconsistent with the current coverage and/or capacity policy. Configuration of the event and/or condition may include event and/or condition identification, a time when the prediction information meets the event and/or condition, etc.
the prediction time and/or applicable/validity time corresponding to the prediction information of a coverage and/or capacity policy is greater than or equal to or less than a predetermined threshold. Configuration of the event and/or condition may include event and/or condition identification, a predetermined threshold, a time when the event and/or condition is met, a time when the prediction information meets the event and/or condition, etc.

Corresponding scope of requested coverage prediction and/or capacity prediction and/or coverage prediction information reporting and/or capacity prediction information reporting is used to indicate a corresponding scope of the requested coverage prediction and/or capacity prediction and/or coverage prediction information reporting and/or capacity prediction information reporting. The scope may be the identification and/or identification list of slice, service, scenario, node, UE, cell, beam, channel, PDU session, DRB, QOS flow, QOS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

After the sixth node receives the fifth message containing the request for relevant prediction information of a coverage and/or capacity policy from the fifth node, it transmits a sixth message containing a response of the relevant prediction information of a coverage and/or capacity policy to the fifth node, to inform the fifth node whether the sixth node can perform reporting and/or prediction according to the fifth message. For example, if the sixth message received by the fifth node indicates that the sixth node can report and/or predict coverage and/or capacity policy related information, the fifth node may subsequently receive coverage and/or capacity policy related prediction information reported by the sixth node, for example, reported through a subsequent seventh message.

The sixth message may be included in one or more of the following:
a RESOURCE STATUS RESPONSE message or a RESOURCE STATUS FAILURE message or an NG-RAN NODE CONFIGURATION UPDATE message or an NG-RAN NODE CONFIGURATION UPDATE ACKNOWLEDGE message or an XN SETUP REQUEST message or an XN SETUP RESPONSE message or a DATA COLLECTION REQUEST message or a DATA COLLECTION RESPONSE message or a DATA COLLECTION FAILURE message or a DATA COLLECTION UPDATE message;
or an NG SETUP REQUEST message or an NG SETUP RESPONSE message or a RAN CONFIGURATION UPDATE message or a RAN CONFIGURATION UPDATE ACKNOWLEDGE message or an AMF CONFIGURATION UPDATE message or an AMF CONFIGURATION UPDATE ACKNOWLEDGE message or an AMF STATUS INDICATION message or an OVERLOAD START message or an OVERLOAD STOP message of NG;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS RESPONSE message or a RESOURCE STATUS FAILURE message of F1;
or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a GNB-CU-CP CONFIGURATION UPDATE ACKNOWLEDGE message or a GNB-CU-UP STATUS INDICATION message or a RESOURCE STATUS RESPONSE message or a RESOURCE STATUS FAILURE message of E1;
or a newly defined RRC and/or Xn and/or X2 and/or F1 and/or E1 and/or NG message and/or RRC container and/or MAC CE, etc.

The sixth message may include one or more of the following information and/or fields:

Transmitting node ID is used to identify the node that transmits the message.

Receiving node ID is used to identify the node that receives the message.

Measurement ID is used to identify a measurement. For example, the measurement ID may be consistent with the measurement ID in the fifth message, to associate the response message with the request message.

Request ID is used to identify a request. For example, the request ID may be consistent with the request ID in the fifth message, to associate the response message with the request message.

Prediction ID is used to identify a prediction request. For example, the prediction ID may be consistent with the prediction ID in the fifth message, to associate the response message with the request message.

Report ID is used to identify a report request. For example, the report ID may be consistent with the report ID in the fifth message, to associate the response message with the request message.

Configuration ID is used to identify a measurement and/or prediction and/or reporting configuration. For example, the configuration ID may be consistent with the configuration ID in the fifth message, to associate the response message with the request message.

Confirmation/Acknowledge of the prediction request for coverage and/or capacity policy is used to indicate whether the prediction information of a coverage and/or capacity policy can be predicted and/or reported. This information may indicate whether the prediction information of a coverage and/or capacity policy can be predicted and/or reported by one bit.

The scope in which prediction and/or reporting of a coverage and/or capacity policy can be performed is used to indicate a scope in which prediction and/or reporting of a coverage and/or capacity policy can be performed. The scope may be the identification and/or identification list of slice, service, scenario, node, UE, cell, beam, channel, PDU session, DRB, QOS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

The scope in which prediction and/or reporting of a coverage and/or capacity policy cannot be performed is used to indicate the scope in which prediction and/or reporting of a coverage and/or capacity policy cannot be performed. The scope may be the identification and/or identification list of slice, service, scenario, node, UE, cell, beam, channel, PDU session, DRB, QoS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

Cause/reason indicates the reason why prediction and/or reporting cannot be performed. The reasons may include the reporting time is unavailable, the reporting period is unavailable, the coverage and/or capacity policy prediction is unavailable, the prediction is unavailable, the prediction is temporarily unavailable, the coverage and/or capacity policy prediction is temporarily unavailable, the prediction time is unavailable, the prediction reporting time is unavailable, the valid time of prediction information is unavailable, the reporting period of prediction information is unavailable, the reporting time is unsupported, the reporting period is unsupported, the coverage and/or capacity policy prediction is unsupported, the prediction is unsupported, the prediction is temporarily unsupported, the coverage and/or capacity policy prediction is temporarily unsupported, the prediction time is unsupported, the prediction reporting time is unsupported, the valid time of prediction information is unsupported, the reporting period of prediction information is unsupported, etc.

The sixth node transmits a seventh message containing coverage and/or capacity policy related prediction information to the fifth node according to its own situation and/or according to the fifth message containing a request for the coverage and/or capacity policy related prediction information received from the fifth node. The fifth node can make relevant self-optimization decisions by using the predicted coverage and/or capacity policy. For example, if a predicted coverage and/or capacity policy of a neighboring cell is received, which is that the neighboring cell will reduce its coverage at a certain time in the future, the node will not select this neighboring cell as a handover target cell when performing handover for a UE, to avoid the need for handover again when the coverage of the neighboring cell is reduced after the UE is handed over to the neighboring cell.

The seventh message may be included in one or more of the following:
a RESOURCE STATUS UPDATE message or an NG-RAN NODE CONFIGURATION UPDATE message or an NG-RAN NODE CONFIGURATION UPDATE ACKNOWLEDGE message or an XN SETUP REQUEST message or an XN SETUP RESPONSE message or a DATA COLLECTION UPDATE message of Xn;
or an NG SETUP REQUEST message or an NG SETUP RESPONSE message or a RAN CONFIGURATION UPDATE message or a RAN CONFIGURATION UPDATE ACKNOWLEDGE message or an AMF CONFIGURATION UPDATE message or an AMF CONFIGURATION UPDATE ACKNOWLEDGE message or an AMF STATUS INDICATION message or an OVERLOAD START message or an OVERLOAD STOP message of NG;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS UPDATE message of F1;
or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a GNB-CU-CP CONFIGURATION UPDATE ACKNOWLEDGE message or a GNB-CU-UP STATUS INDICATION message or a RESOURCE STATUS UPDATE message of E1;
or another and/or newly defined RRC and/or Xn and/or X2 and/or F1 and/or E1 and/or NG message and/or RRC container and/or MAC CE, etc.

The seventh message may include one or more of the following information and/or fields:

Transmitting node ID is used to identify the node that transmits the message.

Receiving node ID is used to identify the node that receives the message.

Measurement ID is used to identify a measurement. For example, the measurement ID may be consistent with the measurement ID in the fifth message, to associate the reporting message with the request message.

Request ID is used to identify a request. For example, the request ID may be consistent with the request ID in the fifth message, to associate the reporting message with the request message.

Prediction ID is used to identify a prediction request. For example, the prediction ID may be consistent with the prediction ID in the fifth message, to associate the reporting message with the request message.

Report ID is used to identify a report request. For example, the report ID may be consistent with the report ID in the fifth message, to associate the reporting message with the request message.

Configuration ID is used to identify a measurement and/or prediction and/or reporting configuration. For example, the configuration ID may be consistent with the configuration ID in the fifth message, to associate the reporting message with the request message.

Predicted coverage and/or capacity policy information is used to indicate the predicted coverage and/or capacity policy information.

Applicable/validity scope corresponding to the predicted coverage and/or capacity policy information is used to indicate a scope corresponding to the predicted coverage and/or capacity policy information. The scope may be the identification and/or identification list of slice, service, scenario, node, UE, cell, beam, channel, PDU session, DRB, QOS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

Applicable/validity time corresponding to the predicted coverage and/or capacity policy information is used to indicate a time and/or time interval corresponding to the predicted coverage and/or capacity policy information. The time may be relative or absolute. The time interval may be indicated by a timer, a combination of a start time and an end time, or a combination of a start time and a time duration, etc. The time interval may be represented by 2*n bits, e.g., the first n bits represent the start time and the last n bits represent the end time. It may also be represented by separate fields, including one or more of the following:

Start time is used to indicate the start time of the applicable/validity time. The start time may be relative or absolute.

End time is used to indicate the end time of the applicable/validity time. The end time may be relative or absolute.

Event and/or condition that triggered reporting indicates the event and/or condition that triggered the reporting. The event and/or condition that triggered the reporting may be an event and/or condition of the events and/or conditions that trigger reporting in the fifth message.

### Example 4

Disclosed is a method for supporting coverage optimization, including a seventh node transmits an eighth message containing a coverage and/or capacity-related performance request to an eighth node to request the eighth node to report the requested coverage and/or capacity-related performance. The seventh node can use the coverage and/or capacity-related performance to evaluate a coverage and/or capacity decision. For example, a good coverage and/or capacity-related performance may indicate that a coverage and/or capacity decision (of the seventh node, for example) is appropriate, and poor coverage and/or capacity-related performance indicates that a coverage and/or capacity decision is inappropriate and needs to be optimized and updated. Alternatively, the seventh node may also use the coverage and/or capacity-related performance to evaluate an AI ML model, and may evaluate whether the model can continue to be used, and whether the model needs to be trained and/or adjusted, etc. Alternatively, the seventh node can also make subsequent coverage and/or capacity decisions by using the coverage and/or capacity-related performance. For example, the coverage and/or capacity-related performance may be input into a decision generation model for making coverage and/or capacity decisions, and the decision generation model outputs relevant coverage and/or capacity decisions. The decision generation model may be a mathematical algorithm or an AI ML model. Alternatively, the seventh node may also use the coverage and/or capacity-related performance to evaluate an AI ML model, for example, it may evaluate whether the model can continue to be used, and whether the model needs to be trained and/or adjusted, etc. The model may be an ML model for any function. Alternatively, the seventh node can also use the coverage and/or capacity-related performance to make subsequent decisions. For example, the coverage and/or capacity-related performance may be input into a decision generation model, and the decision generation model outputs relevant decisions. The decision generation model may be a mathematical algorithm or an AI ML model. The decision may be any decision, such as a coverage and/or capacity related decision, slice related decision, mobility related decision and self-optimization related decision.

The eighth message may be included in one or more of the following:
a RESOURCE STATUS REQUEST message or an NG-RAN NODE CONFIGURATION UPDATE message or an NG-RAN NODE CONFIGURATION UPDATE ACKNOWLEDGE message or an XN SETUP REQUEST message or an XN SETUP RESPONSE message or a DATA COLLECTION REQUEST message of Xn;
or an NG SETUP REQUEST message or an NG SETUP RESPONSE message or a RAN CONFIGURATION UPDATE message or a RAN CONFIGURATION UPDATE ACKNOWLEDGE message or an AMF CONFIGURATION UPDATE message or an AMF CONFIGURATION UPDATE ACKNOWLEDGE message or an AMF STATUS INDICATION message or an OVERLOAD START message or an OVERLOAD STOP message of NG;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS REQUEST message of F1;
or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a GNB-CU-CP CONFIGURATION UPDATE ACKNOWLEDGE message or a GNB-CU-UP STATUS INDICATION message or a RESOURCE STATUS REQUEST message of E1;
or a newly defined RRC and/or Xn and/or X2 and/or F1 and/or E1 and/or NG message and/or RRC container and/or MAC CE, etc.

The eighth message may include one or more of the following information and/or fields:

Transmitting node ID is used to identify the node that transmits the message.

Receiving node ID is used to identify the node that receives the message.

Request ID is used to identify a request.

Measurement ID is used to identify a measurement.

Prediction ID is used to identify a prediction.

Report ID is used to identify a report request.

Configuration ID is used to identify a measurement and/or prediction and/or reporting configuration.

Indication of a coverage and/or capacity-related performance request is used to indicate that coverage and/or capacity-related performance is requested to be reported. The coverage and/or capacity-related performance may be measured performance or predicted performance.

Requested content is used to indicate the content requested to be reported. The content may include QOS parameters, QoE parameters, load information, coverage and/or capacity optimization problems, corresponding time information, etc. The content may be measured information or predicted information.

Reporting mode of a requested content is used to indicate the reporting mode of the requested content. It may include single reporting, periodic reporting, on-demand reporting and event-triggered reporting, etc.

Reporting period of a requested content is used to indicate a time spacing of periodic reporting of a content. The reporting period may also be a measurement time of the reported data. If there is no content about this field, a single reporting is indicated, and the reporting time of the single reporting is from a measurement start time to a measurement end time.

Configuration of measurement and/or reporting and/or prediction of coverage and/or capacity-related performance indicates a configuration of measurement and/or reporting and/or prediction of the coverage and/or capacity-related performance. The configuration information of measurement and/or reporting and/or prediction of the coverage and/or capacity-related performance may include one or more of the following:

Indication of measurement and/or reporting and/or prediction of relevant performance before implementation of a coverage and/or capacity decision.

Indication of measurement and/or reporting and/or prediction of relevant performance after implementation of a coverage and/or capacity decision.

Indication of measurement and/or reporting and/or prediction of a difference of relevant performance before and after implementation of a coverage and/or capacity decision.

Measurement time is used to indicate a time and/or time interval of a measurement. The time may be relative or absolute. It may be a time and/or time interval before an event, a time and/or time interval after an event, or a combination of the above. The event may be implementation of a coverage and/or capacity decision, receipt of an indication to trigger collection, etc. The time interval may be indicated by a timer, a combination of a start time and an end time, or a combination of a start time and a time duration, etc. The time interval may be represented by 2*n bits, e.g., the first n bits represent a measurement start time and the last n bits represent a measurement end time. It may also be represented by separate fields, including one or more of the following:

Measurement start time is used to indicate the start time of a measurement. The start time may be relative or absolute.

Measurement end time is used to indicate the end time of a measurement. The end time may be relative or absolute.

Cell ID indicates a cell corresponding to the requested performance information. It may be an ID or a list of IDs. The cell ID may be a cell ID corresponding to a cell managed by the first node, a cell ID corresponding to a cell managed by the second node, a cell ID of a neighboring cell of the first node and/or the second node, or a cell ID of any cell.

Node ID indicates a node corresponding to the requested performance information. It may be an ID or a list of IDs.

Beam ID indicates a beam corresponding to the requested performance information. It may be an ID or a list of IDs. The beam ID may be a beam ID corresponding to a cell managed by the first node, a beam ID corresponding to a cell managed by the second node, a beam ID corresponding to a neighboring cell of the first node and/or the second node, or a beam ID corresponding to any cell.

Slice ID indicates a slice corresponding to the requested performance information. It may be an ID or a list of IDs.

User ID indicates a user corresponding to the requested performance information. It may be an ID or a list of IDs.

Coverage and/or capacity decision indicates a coverage and/or capacity decision corresponding to the requested performance.

Location information corresponding to performance information that needs to be collected and/or predicted: the location information may be coordinate, area, cell identification, beam identification, identification for indicating a location and/or area, and the like. The cell identification may be accessing cell identification, connecting cell identification, serving cell identification, etc. The beam identification may be an access beam identification, connecting beam identification, accessed beam identification, etc. The identification for indicating a location and/or area is used to represent one or more locations and/or one or more areas. If the identification for indicating a location and/or area is used, the information shall include one or more of the following information:

Location and/or area identification may be an ID or an ID list.

Correspondence between the location information and the above-mentioned identification: which may be a correspondence or a group of correspondences. The correspondence may be expressed in the following modes:

Mode 1 may be an area in which the location coordinates meet a predetermined condition, which is represented by an identification. In this case, the correspondence includes a predetermined condition, a corresponding location and/or an area identification.

Mode 2 may be an area whose distance from a reference point is greater than or equal to or less than a threshold, which is represented by an identification. In this case, the correspondence should include a reference point, a threshold, corresponding location and/or area identification, etc. The reference point may be a location of a node, a center point of a cell, a center point of a beam, a reference point with a known location or any other reference point.

In Mode 3, a correspondence may be configured in advance. In this case, the correspondence includes a configuration, a configuration index, etc.

Mode 4 may be an area with signal quality greater than or equal to or less than a threshold, which is represented by an identification. In this case, the correspondence should include a signal quality type, a threshold, a corresponding location and/or area identification, etc.

Signal strength and/or signal strength scope corresponding to performance information that needs to be collected and/or predicted: Only performance of UEs for which their signal strength meets a condition needs to be collected and/or predicted. The information may include a signal strength type, a threshold, and a condition that needs to be met. The condition that needs to be met may include greater than or equal to or less than a threshold, a time corresponding to meeting a condition, etc.

Event and/or condition that triggers measurement and/or reporting and/or prediction: when the event and/or condition that triggers measurement and/or reporting and/or prediction is met, measurement and/or reporting and/or prediction is performed. The event and/or condition may include measurement and/or reporting and/or prediction of a coverage and/or capacity decision is implemented, a coverage and/or capacity decision is to be changed, a coverage and/or capacity decision of a neighboring cell is to be changed, a coverage and/or capacity decision of a neighboring cell is implemented and/or changed, a coverage and/or capacity optimization problem is found, a coverage and/or capacity optimization problem is predicted to occur.

Requested scope of measurement and/or reporting and/or prediction of coverage and/or capacity-related performance is used to indicate a requested scope of measurement and/or reporting and/or prediction of the coverage and/or capacity-related performance. The scope may be the identification and/or identification list of slice, service, scenario, node, UE, cell, beam, channel, PDU session, DRB, QOS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

Prediction registration request is used to indicate the type of a prediction request. For example, it may include start, end, add, update, etc.

Registration request is used to indicate the type of a request. For example, it may include start, end, add, update, etc.

Report registration request is used to indicate the type of a report request. For example, it may include start, end, add, update, etc.

Requested prediction time is used to indicate a time and/or time interval for prediction. The time may be relative or absolute. The time interval may be indicated by a timer, a combination of a start time and an end time, and a combination of a start time and a time duration, etc. The time interval may be represented by 2*n bits, e.g., the first n bits represent the prediction start time and the last n bits represent the prediction end time. It may also be represented by separate fields, including one or more of the following:

Prediction start time is used to indicate the start time of a prediction. The start time may be relative or absolute.

Prediction end time is used to indicate the end time of a prediction. The end time may be relative or absolute.

Applicable/validity time of a requested prediction content is used to indicate the time and/or time interval corresponding to the prediction content. The time may be relative or absolute. The time interval may be indicated by a timer, a combination of a start time and an end time, or a combination of a start time and a time duration, etc. The time interval may be represented by 2*n bits, e.g., the first n bits represent the start time and the last n bits represent the end time. It may also be represented by separate fields, including one or more of the following:

Start time is used to indicate the start time of the applicable/validity time. The start time may be relative or absolute.

End time is used to indicate the end time of the applicable/validity time. The end time may be relative or absolute.

Reporting time of a requested prediction content is used to indicate the time and/or time interval for reporting the prediction content. The time may be relative or absolute. The time interval may be indicated by a timer, a combination of a start time and an end time, or a combination of a start time and a time duration, etc. The time interval may be represented by 2*n bits, e.g., the first n bits represent the start time and the last n bits represent the end time. It may also be represented by separate fields, including one or more of the following:

Start time is used to indicate the start time of the reporting time. The start time may be relative or absolute.

End time is used to indicate the end time of the reporting time. The end time may be relative or absolute.

Reporting mode of a prediction content is used to indicate a requested content reporting mode. It may include single reporting, periodic reporting, on-demand reporting and event-triggered reporting, etc.

Reporting period of a prediction content is used to indicate a time spacing of periodic reporting of a prediction content. The reporting period may also be a prediction time of the reported data. For example, if there is no content about this field, a single reporting is indicated, and the reporting time of the single reporting is from the prediction start time to the prediction end time.

After receiving the eighth message containing the coverage and/or capacity-related performance information request from the seventh node, the eighth node transmits a ninth message containing a coverage and/or capacity-related performance information response to the seventh node, to inform the seventh node whether the eighth node can perform report and/or measurement according to the eighth message. For example, if the ninth message received by the seventh node indicates that the eighth node can report and/or measure coverage and/or capacity-related performance information, the seventh node may subsequently receive coverage and/or capacity prediction information reported by the eighth node, e.g., reported through a subsequent tenth message.

The ninth message may be included in one or more of the following:
a RESOURCE STATUS RESPONSE message or a RESOURCE STATUS FAILURE message or an NG-RAN NODE CONFIGURATION UPDATE message or an NG-RAN NODE CONFIGURATION UPDATE ACKNOWLEDGE message or a XN SETUP REQUEST message or a XN SETUP RESPONSE message or a DATA COLLECTION RESPONSE message or a DATA COLLECTION FAILURE message of Xn;
or an NG SETUP REQUEST message or an NG SETUP RESPONSE message or a RAN CONFIGURATION UPDATE message or a RAN CONFIGURATION UPDATE ACKNOWLEDGE message or an AMF CONFIGURATION UPDATE message or an AMF CONFIGURATION UPDATE ACKNOWLEDGE message or an AMF STATUS INDICATION message or an OVERLOAD START message or an OVERLOAD STOP message of NG;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS RESPONSE message or a RESOURCE STATUS FAILURE message of F1;
or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a GNB-CU-CP CONFIGURATION UPDATE ACKNOWLEDGE message or a GNB-CU-UP STATUS INDICATION message or a RESOURCE STATUS RESPONSE message or a RESOURCE STATUS FAILURE message of E1;
or a newly defined RRC and/or Xn and/or X2 and/or F1 and/or E1 and/or NG message and/or RRC container and/or MAC CE, etc.

The ninth message may include one or more of the following information and/or fields:

Transmitting node ID is used to identify the node that transmits the message.

Receiving node ID is used to identify the node that receives the message.

Measurement ID is used to identify a measurement. For example, the measurement ID may be consistent with the measurement ID in the eighth message, to associate the response message with the request message.

Request ID is used to identify a request. For example, the request ID may be consistent with the request ID in the eighth message, to associate the response message with the request message.

Prediction ID is used to identify a prediction request. For example, the prediction ID may be consistent with the prediction ID in the eighth message, to associate the response message with the request message.

Report ID is used to identify a report request. For example, the report ID may be consistent with the report ID in the eighth message, to associate the response message with the request message.

Configuration ID is used to identify a measurement and/or prediction and/or reporting configuration. For example, the configuration ID may be consistent with the configuration ID in the eighth message, to associate the response message with the request message.

Confirmation/Acknowledge of the coverage and/or capacity-related performance information request is used to indicate whether the coverage and/or capacity-related performance information can be measured and/or reported and/or predicted. This information may indicate whether the coverage and/or capacity-related performance information can be measured and/or reported and/or predicted by one bit.

Scope of measurement and/or reporting and/or prediction of coverage and/or capacity-related performance that can be performed is used to indicate the scope of measurement and/or reporting and/or prediction of coverage and/or capacity-related performance that can be performed. The scope may be the identification and/or identification list of slice, service, scenario, node, UE, cell, beam, channel, PDU session, DRB, QOS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

Information corresponding to measurement and/or reporting and/or prediction of coverage and/or capacity-related performance that can be performed indicates information corresponding to measurement and/or reporting and/or prediction of the coverage and/or capacity-related performance that can be performed. This information may be one or more of the configuration of measurement and/or reporting and/or prediction of coverage and/or capacity-related performance in the eighth message.

Information corresponding to measurement and/or reporting and/or prediction of coverage and/or capacity-related performance that cannot be performed indicates information corresponding to measurement and/or reporting and/or prediction of the coverage and/or capacity-related performance that cannot be performed. This information may be one or more of the configuration of measurement and/or reporting and/or prediction of coverage and/or capacity-related performance in the eighth message.

Scope of measurement and/or reporting and/or prediction of coverage and/or capacity-related performance that cannot be performed is used to indicate the scope of measurement and/or reporting and/or prediction of coverage and/or capacity-related performance that cannot be performed. The scope may be the identification and/or identification list of slice, service, scenario, node, UE, cell, beam, channel, PDU session, DRB, QOS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

Cause/reason indicates the reason why prediction and/or reporting and/or measurement cannot be performed. The reasons may include the reporting time is unavailable, the reporting period is unavailable, the coverage and/or capacity-related performance measurement is unavailable, the coverage and/or capacity-related performance measurement is temporarily unavailable, the reporting time is unsupported, the reporting period is unsupported, the coverage and/or capacity-related performance measurement is unsupported, the coverage and/or capacity-related performance measurement is temporarily unsupported, the coverage and/or capacity-related performance prediction is unavailable, the prediction is unavailable, the prediction is temporarily unavailable, the coverage and/or capacity-related performance prediction is temporarily unavailable, the prediction time is unavailable, the prediction reporting time is unavailable, the valid time of prediction information is unavailable, the reporting period of prediction information is unavailable, the coverage and/or capacity-related performance prediction is unsupported, the prediction is unsupported, the prediction is temporarily unsupported, the coverage and/or capacity-related performance prediction is temporarily unsupported, the prediction time is unsupported, the prediction reporting time is unsupported, the valid time of prediction information is unsupported, the reporting period of prediction information is unsupported, etc.

The eighth node transmits a tenth message containing coverage and/or capacity-related performance to the seventh node according to its own situation and/or according to the eighth message containing a coverage and/or capacity-related performance request received from the seventh node. The seventh node can evaluate a coverage and/or capacity decision by using the coverage and/or capacity-related performance. For example, good coverage and/or capacity-related performance can indicate that the coverage and/or capacity decision is appropriate, and a poor coverage and/or capacity-related performance can indicate that the coverage and/or capacity decision is inappropriate and needs to be optimized and updated. Alternatively, the seventh node may also use the coverage and/or capacity-related performance to evaluate an AI ML model, e.g., it may evaluate whether the model can continue to be used, and whether the model needs to be trained and/or adjusted, etc. Alternatively, the seventh node can also make subsequent coverage and/or capacity decisions by using the coverage and/or capacity-related performance. For example, the coverage and/or capacity-related performance may be input into a decision generation model for making coverage and/or capacity decisions, and the decision generation model outputs relevant coverage and/or capacity decisions. The decision generation model may be a mathematical algorithm or an AI ML model. Alternatively, the seventh node may also use the coverage and/or capacity-related performance to evaluate an AI ML model, e.g., it may evaluate whether the model can continue to be used, and whether the model needs to be trained and/or adjusted, etc. The model may be an ML model for any function. Alternatively, the seventh node can also use the coverage and/or capacity-related performance to make subsequent decisions. For example, the coverage and/or capacity-related performance may be input into a decision generation model, and the decision generation model outputs relevant decisions. The decision generation model may be a mathematical algorithm or an AI ML model. The decision may be any decision, such as a coverage and/or capacity related decision, slice related decision, mobility related decision and self-optimization related decision.

The tenth message may be included in one or more of the following:
a RESOURCE STATUS UPDATE message or an NG-RAN NODE CONFIGURATION UPDATE message or an NG-RAN NODE CONFIGURATION UPDATE ACKNOWLEDGE message or an XN SETUP REQUEST message or an XN SETUP RESPONSE message or a DATA COLLECTION UPDATE message of Xn;
or an NG SETUP REQUEST message or an NG SETUP RESPONSE message or a RAN CONFIGURATION UPDATE message or a RAN CONFIGURATION UPDATE ACKNOWLEDGE message or an AMF CONFIGURATION UPDATE message or an AMF CONFIGURATION UPDATE ACKNOWLEDGE message or an AMF STATUS INDICATION message or an OVERLOAD START message or an OVERLOAD STOP message of NG;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS UPDATE message of F1;
or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a GNB-CU-CP CONFIGURATION UPDATE ACKNOWLEDGE message or a GNB-CU-UP STATUS INDICATION message or a RESOURCE STATUS UPDATE message of E1;
or a newly defined RRC and/or Xn and/or X2 and/or F1 and/or E1 and/or NG message and/or RRC container and/or MAC CE, etc.

The tenth message may include one or more of the following information and/or fields:

Transmitting node ID is used to identify the node that transmits the message.

Receiving node ID is used to identify the node that receives the message.

Measurement ID is used to identify a measurement. For example, the measurement ID may be consistent with the measurement ID in the eighth message, to associate the reporting message with the request message.

Request ID is used to identify a request. For example, the request ID may be consistent with the request ID in the eighth message, to associate the reporting message with the request message.

Prediction ID is used to identify a prediction request. For example, the prediction ID may be consistent with the prediction ID in the eighth message, to associate the reporting message with the request message.

Report ID is used to identify a report request. For example, the report ID may be consistent with the report ID in the eighth message, to associate the reporting message with the request message.

Configuration ID is used to identify a measurement and/or prediction and/or reporting configuration. For example, the configuration ID may be consistent with the configuration ID in the eighth message, to associate the reporting message with the request message.

Reported performance information is used to indicate performance information requested to be reported. The performance information may include QoS parameters, QoE parameters, load information, coverage and/or capacity optimization problems, corresponding time information, corresponding location information, corresponding signal strength information, etc. The performance may be measured performance or predicted performance.

Applicable/validity scope corresponding to coverage and/or capacity performance information is used to indicate a scope corresponding to the reported coverage and/or capacity performance information. The scope may be the identification and/or identification list of slice, service, scenario, node, UE, cell, beam, channel, PDU session, DRB, QOS flow, QoS level, etc. The service may be a service type, a QoS, a scenario, etc. The service type may include voice service, video service, virtual reality service, augmented reality service, call service, etc. The quality of service may include delay, throughput, reliability, packet loss rate, data rate, etc., which may be identified by a 5QI, a QCI, etc. The scenario may include URLLC, eMBB, mMTC, etc.

Applicable/validity time corresponding to coverage and/or capacity-related performance information is used to indicate a time and/or time interval corresponding to the coverage and/or capacity-related performance information. The time may be relative or absolute. The time interval may be indicated by a timer, a combination of a start time and an end time, or a combination of a start time and a time duration, etc. The time interval may be represented by 2*n bits, e.g., the first n bits represent the start time and the last n bits represent the end time. It may also be represented by separate fields, including one or more of the following:

Start time is used to indicate the start time of the applicable/validity time. The start time may be relative or absolute.

End time is used to indicate the end time of the applicable/validity time. The end time may be relative or absolute.

Event and/or condition that triggered measurement and/or reporting and/or prediction indicates the event and/or condition that triggered the measurement and/or reporting and/or prediction. The event and/or condition that triggered the measurement and/or reporting and/or prediction may be an event and/or condition of the events and/or conditions that trigger that trigger measurement and/or reporting and/or prediction in the eighth message.

### Example 5

Disclosed is a method for supporting coverage optimization, including a ninth node transmits an eleventh message containing a first handover configuration and/or first handover request to a tenth node, so that the node can quickly hand over the UE to a target node, or invalidate and/or deactivate an execution condition configured for the UE and quickly invalidate and/or deactivate a (conditional) handover configured for the UE when a relevant decision is made. In some implementations, e.g., a node is going to change its coverage and/or capacity decision and the UE needs to be handed over to a neighboring cell. In this case, after receiving the eleventh message, the UE can quickly switch to the target node when the node changes its coverage and/or capacity decision, to avoid that the relevant UE cannot be handed over to a cell which can provide coverage in time when the node changes its coverage and/or capacity decision. A node changes its decision and a (conditional) handover configured for the UE needs to be cancelled. In this case, after receiving the eleventh message in which the node may transmit a signaling for invalidation and/or deactivation of an execution condition to the UE, the UE does not perform handover, and/or, the UE does not detect some other configured execution condition, and/or, the UE does not perform handover and/or does not access to a target node even if the UE detects that some other configured execution condition is met.

The eleventh message may be included in one or more of the following:
a HANDOVER REQUEST message or an S-NODE ADDITION REQUEST message or an S-NODE MODIFICATION REQUEST message or an S-NODE CHANGE REQUIRED message of Xn;
or an RRC reconfiguration (RRCReconfiguration) message of RRC;
or another and/or newly defined RRC and/or Xn and/or X2 and/or F1 and/or E1 and/or NG message and/or RRC container and/or MAC CE, etc.

The eleventh message may include one or more of the following information and/or fields:

Transmitting node ID is used to identify the node that transmits the message.

Receiving node ID is used to identify the node that receives the message.

UE ID is used to identify the UE corresponding to the handover configuration and/or handover. It may be an ID or a list of IDs.

First execution condition is used to indicate an execution condition configured to the UE for conditional handover. The condition may be receiving a signaling that a node is to change a coverage and/or capacity decision, receiving a signaling that handover can be performed, receiving a signaling for triggering handover, receiving a signaling for validation and/or activation of an execution condition, and receiving a signaling for invalidation and/or deactivation of an execution condition, etc. In some implementations, for example, after the UE receives the execution condition, the UE performs handover if the UE receives a signaling that a node (e.g., a source node and/or a target node) is to change its coverage and/or capacity decision, and/or, the UE performs handover if some other configured execution condition is met, and/or, the UE further checks whether some other configured execution condition is met if the UE receives a signaling that a node (e.g., a source node and/or a target node) is to change its coverage and/or capacity decision, and if some other configured execution condition is met, the UE performs handover. Alternatively, after the UE receives the execution condition, the UE performs handover if the UE receives a signaling that handover can be performed and/or a signaling for triggering handover (e.g., a signaling for triggering handover defined in a twelfth message) and/or a signaling for validation and/or activation of an execution condition, and/or, the UE performs handover if some other configured execution condition is met, and/or, the UE further checks whether some other configured execution condition is met if the UE receives a signaling that handover can be performed and/or a signaling for triggering handover (e.g., a signaling for triggering handover defined in a twelfth message) and/or a signaling for validation and/or activation of an execution condition, and if some other configured execution condition is met, the UE performs handover. Alternatively, after the UE receives the execution condition, the UE does not perform handover if the UE receives a signaling for invalidation and/or deactivation of an execution condition, and/or, the UE does not detect some other configured execution condition, and/or, the UE does not perform handover and/or does not access to a target node even if the UE detects that some other configured execution condition is met.

Information of serving a predicted replacing cell as a handover target cell is used to indicate that handover to a predicted replacing cell is requested. This information indicates that it is requested to hand over the UE to a predicted replacing cell. In some implementations, e.g., if the node receives a predicted coverage and/or capacity decision of a neighboring cell in which a predicted replacing cell is included, the node can hand over the UE to the predicted replacing cell. This information may include information corresponding to one handover target cell or information corresponding to a plurality of handover target cells. This information includes one or more of the following:

Identification of a replacing cell: the identification of a replacing cell may be set based on the identification of a replacing cell in a predicted coverage and/or capacity policy.

Time for handover to a replacing cell: the time for handover to a replacing cell may be determined according to the applicable/validity time corresponding to a predicted coverage and/or capacity policy information in a predicted coverage and/or capacity policy, e.g., the applicable/validity time corresponding to a predicted coverage and/or capacity policy information in the seventh message.

Information of a handover target cells is used to indicate the information of a handover target cell. The information of a handover target cell is information of a target cell for UE handover, that is, the UE can only hand over to the target cell indicated by the information of a handover target cell. In some other implementations, the information of a handover target cell is information of a suggested handover target cell, that is, the UE can hand over to the cell indicated in the information of a handover target cell, or the UE can hand over to other cells. The information of a handover target cell is information of an allowed handover target cell or information of a handover target cell that can be handed over to, that is, the UE can only hand over to the target cell indicated by the information of a handover target cell. The target cell may also be a candidate target cell or a candidate target cell in conditional handover. The target cell may be a primary cell or a secondary cell. This information may include information corresponding to one handover target cell or information corresponding to a plurality of handover target cells. This information includes one or more of the following:

### Identification of a Target Cell.

Time for handover to a target cell: the time for handover to a target cell may be determined according to the applicable/validity time corresponding to a predicted coverage and/or capacity policy information in a predicted coverage and/or capacity policy, e.g., the applicable/validity time corresponding to a predicted coverage and/or capacity policy information in the seventh message.

### Example 6

Disclosed is a method for supporting coverage optimization, including an eleventh node transmits a twelfth message containing a transmitting request for a signaling for triggering handover to a twelfth node, which may be to request the twelfth node to transmit and/or broadcast a signaling for triggering handover to the UE, or may be to request the twelfth node to perform handover for the UE, or may be for the twelfth node to forward the request to other nodes to request the other nodes to transmit and/or broadcast a signaling for triggering handover to the UE or to request the other nodes to perform handover for the UE. It may also be to request the twelfth node to transmit and/or broadcast a signaling for triggering handover to the UE, or may be to request the twelfth node not to perform handover for the UE, or may be for the twelfth node to forward the request to other nodes to request the other nodes to transmit and/or broadcast a signaling for triggering handover to the UE or request the other nodes not to perform handover for the UE.

The twelfth message may be included in one or more of the following:
a RESOURCE STATUS REQUEST message or a RESOURCE STATUS RESPONSE message or a RESOURCE STATUS FAILURE message or a RESOURCE STATUS UPDATE message or an NG-RAN NODE CONFIGURATION UPDATE message or an NG-RAN NODE CONFIGURATION UPDATE ACKNOWLEDGE message or an XN SETUP REQUEST message or an XN SETUP RESPONSE message or a DATA COLLECTION REQUEST message or a DATA COLLECTION RESPONSE message or a DATA COLLECTION FAILURE message or a DATA COLLECTION UPDATE message;
or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU STATUS INDICATION message or a RESOURCE STATUS REQUEST message or a RESOURCE STATUS RESPONSE message or a RESOURCE STATUS FAILURE message or a RESOURCE STATUS UPDATE message of F1;
or newly defined RRC and/or Xn and/or X2 and/or F1 and/or E1 and/or NG message and/or RRC container and/or MAC CE, etc.

The twelfth message may include one or more of the following information and/or fields:

Transmitting node ID is used to identify the node that transmits the message.

Receiving node ID is used to identify the node that receives the message.

UE ID is used to identify a UE corresponding to the triggering of handover. It may be an ID or a list of IDs.

Signaling requested to be transmitted: used for the transmission of a requested signaling for triggering handover.

Signaling for triggering handover may be one or more of the following:

Signaling related to change of a coverage and/or capacity decision: a signaling for informing that a node is to change and/or has changed a coverage and/or capacity decision.

Signaling indicating that handover can be performed is used to indicate that handover can be performed.

Signaling indicating triggering of handover is used to trigger the UE to perform handover and/or trigger handover for the UE.

Signaling for validation and/or activation of an execution condition: a signaling used to indicate the validation and/or activation of an execution condition. In some implementations, e.g., after the message receiving node transmits the signaling for validation and/or activation of an execution condition to the UE, the UE detects whether some other configured execution condition is met. If some other execution condition is met, the UE performs handover and/or access to a target node.

Signaling for invalidation and/or deactivation of an execution condition: a signaling used to indicate the invalidation and/or deactivation of an execution condition. In some implementations, e.g., after a message receiving node transmits the signaling for invalidation and/or deactivation of an execution condition to the UE, the UE does not perform handover, and/or, the UE does not detect some other configured execution condition, and/or the UE does not perform handover and/or does not access to a target node even if the UE detects that some other configured execution condition is met.

After the twelfth node receives the request and/or based on its own situation, the twelfth node may transmit and/or broadcast a signaling for triggering handover to the UE, or perform handover for the UE, or forward it to other nodes to request the other nodes to transmit and/or broadcast a signaling for triggering handover to the UE or perform handover for the UE. The signaling for triggering handover may refer to the signaling for triggering handover in the twelfth message. The signaling for triggering handover may be a MAC CE and/or an RRC message and/or an RRC container and/or a physical layer signaling.

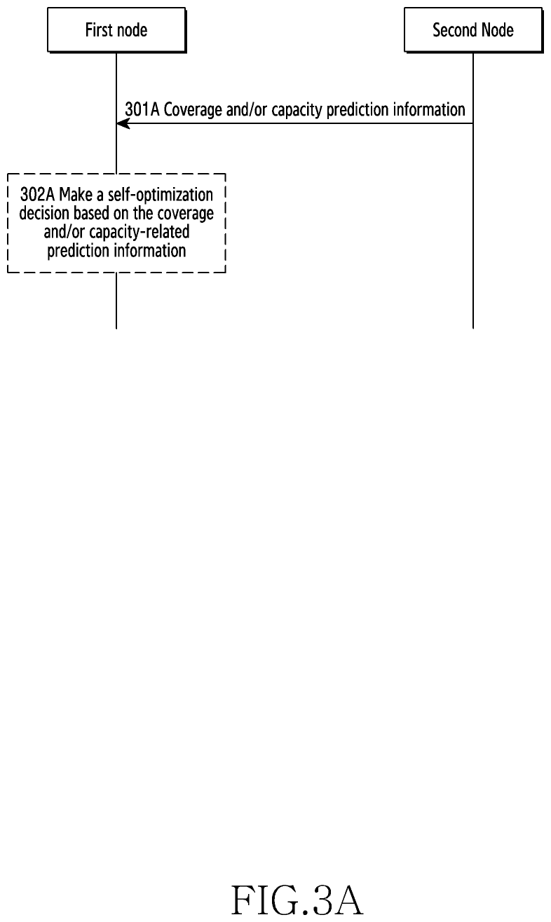

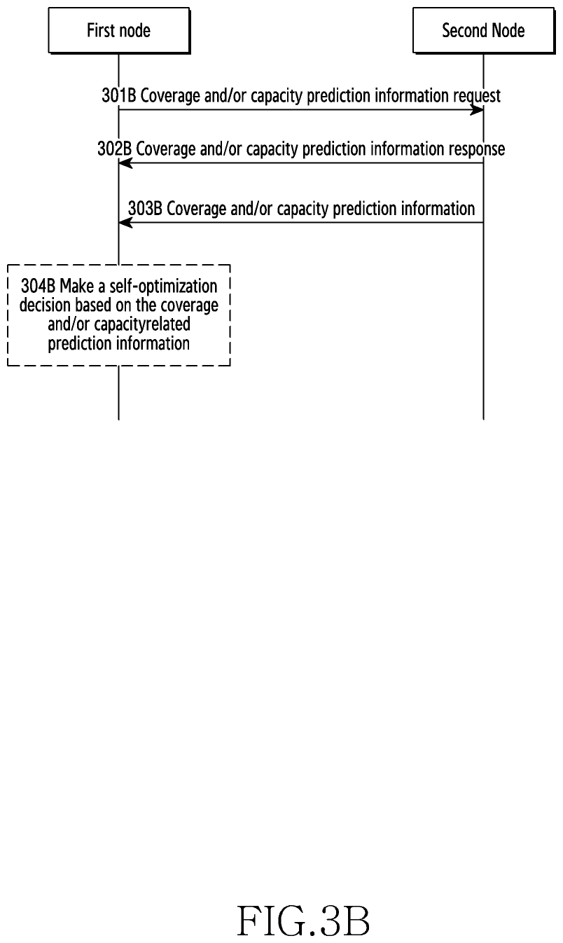

FIG. 3A illustrates a method for supporting coverage optimization according to an embodiment. Referring to FIG. 3A, a process is shown for exchanging coverage and/or capacity prediction information between two nodes, so that the first node can make a self-optimization decision based on the coverage and/or capacity-related prediction information obtained from the second node.

For example, the first node may be a gNB or a gNB-CU or a gNB-DU or a gNB CU-CP or a gNB CU-UP or an en-gNB or an eNB or an ng-eNB, and the second node may be a UE. Alternatively, the first node may be a gNB or a gNB-CU or a gNB CU-CP or an en-gNB or an eNB or an ng-eNB, and the second node may be a gNB or a gNB-CU or a gNB-DU or a gNB CU-CP or a gNB CU-UP or an en-gNB or an eNB or an ng-eNB. Alternatively, the first node may be an AMF or an SMF or an MME, and the second node may be a gNB or a gNB-CU or a gNB CU-CP or an en-gNB or an eNB or an ng-eNB. Alternatively, the first node may be a gNB or a gNB-CU or a gNB CU-CP or an en-gNB or an eNB or an ng-eNB, and the second node may be an AMF or an SMF or an MME. Alternatively, for example, the first node is a primary node and the second node is a secondary node, the first node is a secondary node and the second node is a primary node, the first node is a source node and the second node is a target node, or the first node is a target node and the second node is a source node.

In step 301A, the second node transmits coverage and/or capacity prediction information to the first node. The coverage and/or capacity prediction information may be the aforementioned third message.

In step 302A, the first node can make a self-optimization decision based on the coverage and/or capacity-related prediction information obtained from the second node. The first node may also forward the coverage and/or capacity-related prediction information to other nodes.

FIG. 3B illustrates a method for supporting coverage optimization according to an embodiment. Referring to FIG. 3B, a process is shown for exchanging coverage and/or capacity prediction information between two nodes, so that the first node can make a self-optimization decision based on the coverage and/or capacity-related prediction information obtained from the second node.

For example, the first node may be a gNB or a gNB-CU or a gNB-DU or a gNB CU-CP or a gNB CU-UP or an en-gNB or an eNB or an ng-eNB, and the second node may be a UE. Alternatively, the first node may be a gNB or a gNB-CU or a gNB CU-CP or an en-gNB or an eNB or an ng-eNB, and the second node may be a gNB or a gNB-CU or a gNB-DU or a gNB CU-CP or a gNB CU-UP or an en-gNB or an eNB or an ng-eNB. Alternatively, the first node may be an AMF or an SMF or an MME, and the second node may be a gNB or a gNB-CU or a gNB CU-CP or an en-gNB or an eNB or an ng-eNB. Alternatively, the first node may be a gNB or a gNB-CU or a gNB CU-CP or an en-gNB or an eNB or an ng-eNB, and the second node may be an AMF or an SMF or an MME. Alternatively, for example, the first node is a primary node and the second node is a secondary node, the first node is a secondary node and the second node is a primary node, the first node is a source node and the second node is a target node, or the first node is a target node and the second node is a source node.

In step 301B, the first node transmits a request for coverage and/or capacity prediction information to the second node. The request for coverage and/or capacity prediction information may be the aforementioned first message.

In step 302B, the second node transmits a coverage and/or capacity prediction information response to the first node. The coverage and/or capacity prediction information response may be the aforementioned second message.

In step 303B, the second node transmits coverage and/or capacity prediction information to the first node. The coverage and/or capacity prediction information may be the aforementioned third message.

In step 304B, the first node can make a self-optimization decision based on the coverage and/or capacity-related prediction information obtained from the second node. The first node may also forward the coverage and/or capacity-related prediction information to other nodes.

Step 302B is optional.

If step 301B indicates periodic reporting, steps 303B and/or 304B are performed periodically.

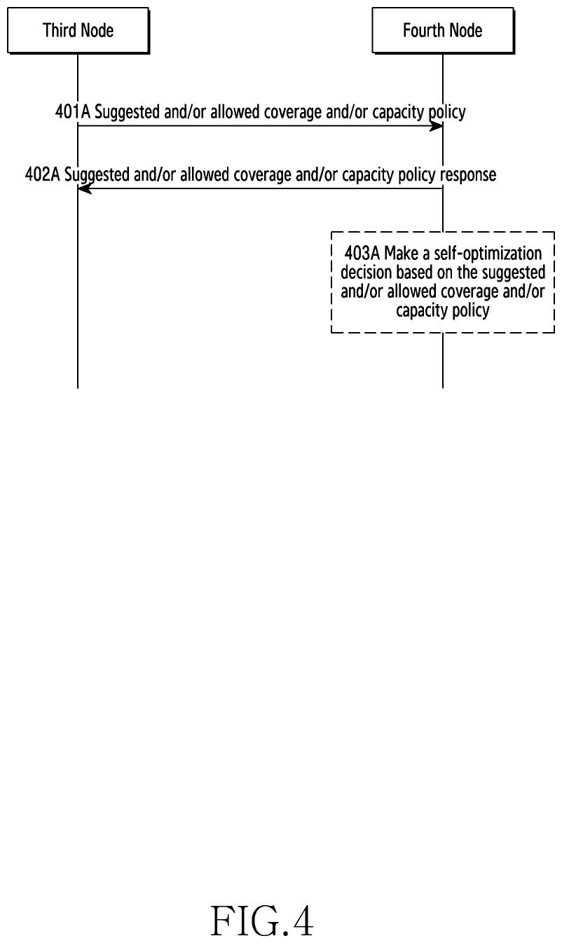

FIG. 4 illustrates a method for supporting coverage optimization according to an embodiment. Specifically, FIG. 4 shows a process of exchanging a suggested and/or allowed coverage and/or capacity policy between two nodes, so that the fourth node can formulate a coverage and/or capacity policy according to the suggested and/or allowed coverage and/or capacity policy.

For example, the third node may be a gNB-CU and the fourth node may be a gNB DU. Alternatively, the third node may be a gNB or a gNB-CU or a gNB CU-CP or an en-gNB or an eNB or an ng-eNB, and the fourth node may be a gNB or a gNB-CU or a gNB-DU or a gNB CU-CP or a gNB CU-UP or an en-gNB or an eNB or an ng-eNB. Alternatively, the third node may be an AMF or an SMF or an MME, and the fourth node may be a gNB or a gNB-CU or a gNB CU-CP or an en-gNB or an eNB or an ng-eNB. Alternatively, the third node may be a gNB or a gNB-CU or a gNB CU-CP or an en-gNB or an eNB or an ng-eNB, and the fourth node may be an AMF or an SMF or an MME. Alternatively, for example, the third node is a primary node and the fourth node is a secondary node; for example, the third node is a secondary node and the fourth node is a primary node; for example, the third node is a source node and the fourth node is a target node; for example, the third node is a target node and the fourth node is a source node.

In step 401A, the third node transmits a suggested and/or allowed coverage and/or capacity policy to the fourth node. The suggested and/or allowed coverage and/or capacity policy may be the aforementioned fourth message.

In step 402A, the fourth node transmits a response of the suggested and/or allowed coverage and/or capacity policy to the third node to inform the third node that the fourth node knows the suggested and/or allowed coverage and/or capacity policy.

In step 403A, the fourth node may formulate a coverage and/or capacity policy according to the suggested and/or allowed coverage and/or capacity policy, by making a self-optimization decision. The fourth node may also forward the suggested and/or allowed coverage and/or capacity policy to other nodes.

Step 402A is optional.

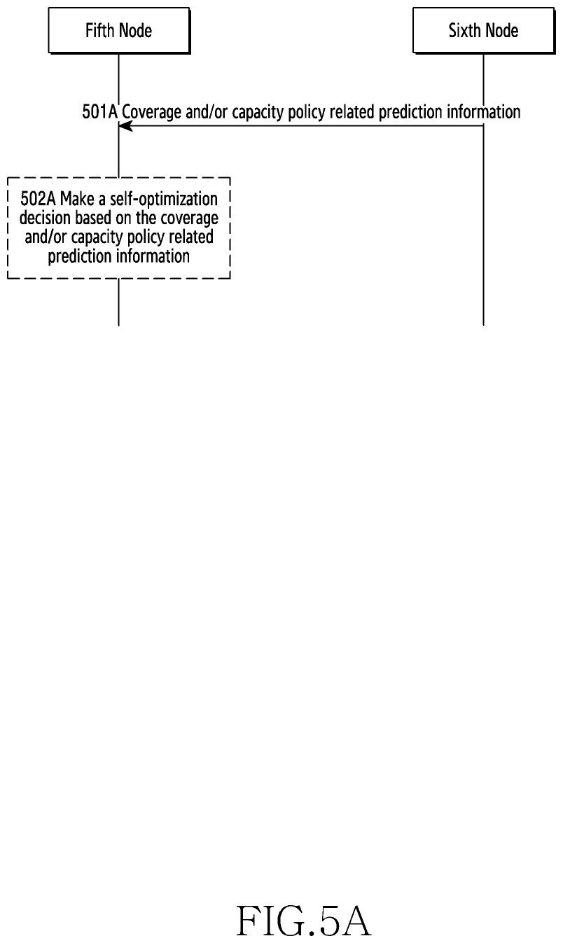

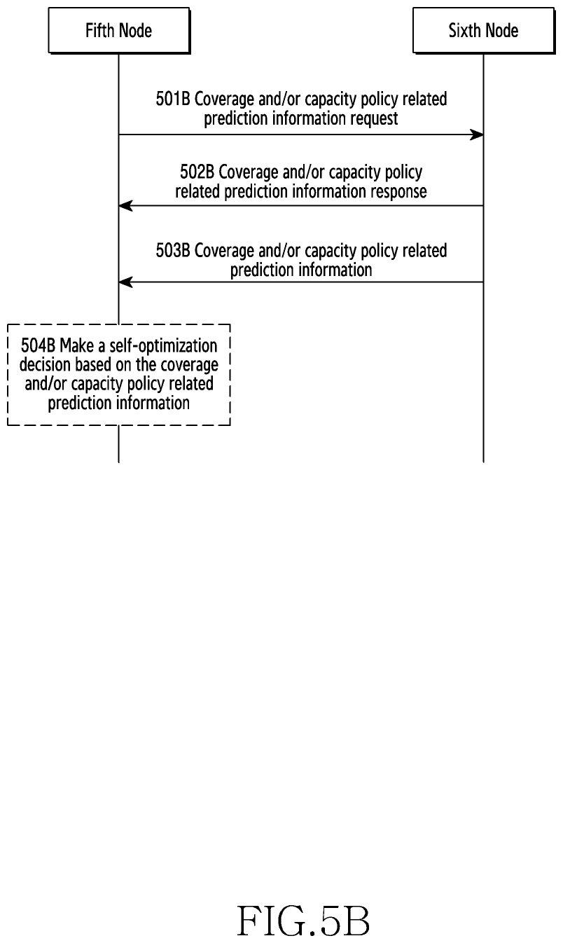

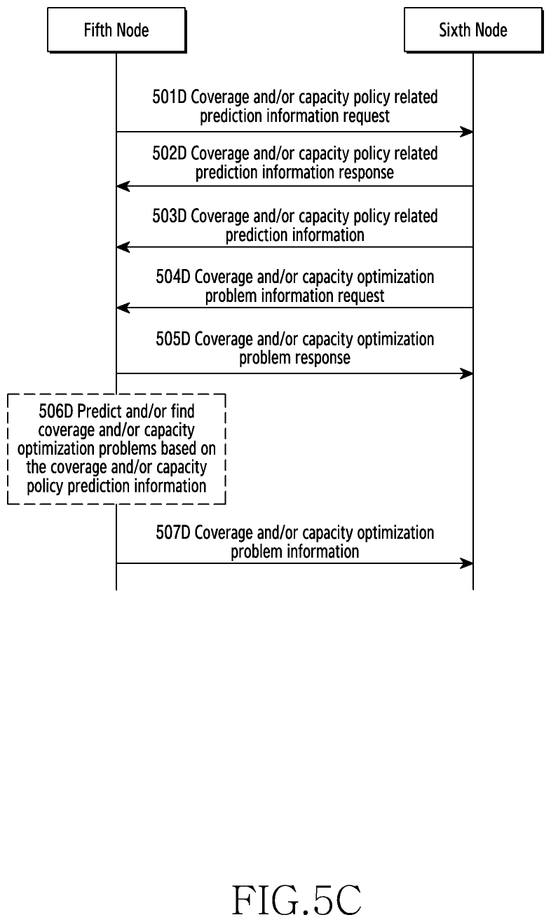

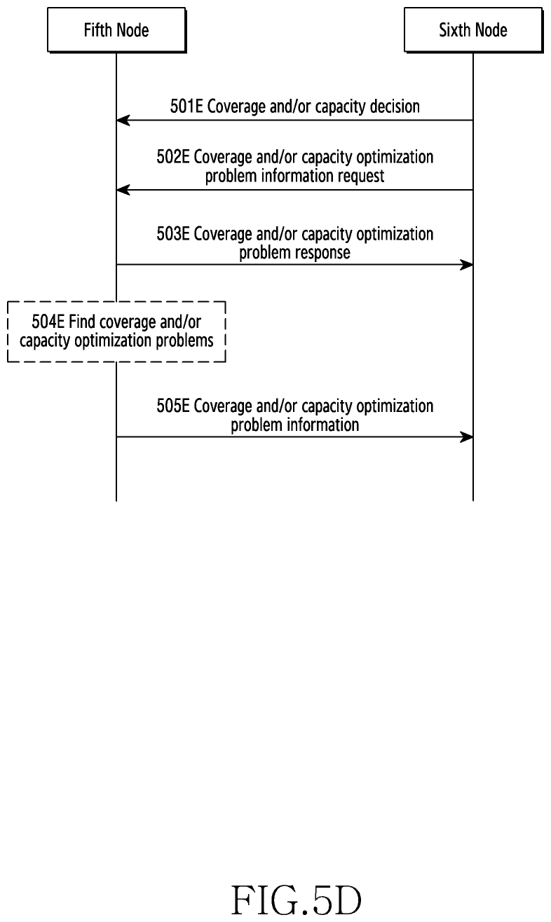

FIG. 5A illustrates a method for supporting coverage optimization according to an embodiment.

Referring to FIG. 5A, a process is shown for exchanging coverage and/or capacity policy related prediction information between two nodes, so that the fifth node can make relevant self-optimization decisions by using the received coverage and/or capacity policy related prediction information. For example, if a predicted coverage and/or capacity policy of a neighboring cell is received, which is that the neighboring cell will reduce its coverage at a certain time in the future, the node will not select this neighboring cell as a handover target cell when performing handover for a UE, to avoid the need for handover again when the coverage of the neighboring cell is reduced after the UE is handed over to the neighboring cell.

For example, the fifth node may be a UE, and the sixth node may be a gNB or a gNB-CU or a gNB-DU or a gNB CU-CP or a gNB CU-UP or an en-gNB or an eNB or an ng-eNB. Alternatively, the fifth node may be a gNB or a gNB-CU or a gNB CU-CP or an en-gNB or an eNB or an ng-eNB, and the sixth node may be a gNB or a gNB-CU or a gNB-DU or a gNB CU-CP or a gNB CU-UP or an en-gNB or an eNB or an ng-eNB. Alternatively, the fifth node may be an AMF or an SMF or an MME, and the sixth node may be a gNB or a gNB-CU or a gNB CU-CP or an en-gNB or an eNB or an ng-eNB. Alternatively, the fifth node may be a gNB or a gNB-CU or a gNB CU-CP or an en-gNB or an eNB or an ng-eNB, and the sixth node may be an AMF or an SMF or an MME. Alternatively, for example, the fifth node is a primary node and the sixth node is a secondary node; for example, the fifth node is a secondary node and the sixth node is a primary node; for example, the fifth node is a source node and the sixth node is a target node; for example, the fifth node is a target node and the sixth node is a source node.

In step 501A, the sixth node transmits coverage and/or capacity policy related prediction information to the fifth node. The coverage and/or capacity policy related prediction information may be the aforementioned seventh message.

In step 502A, the fifth node may make relevant self-optimization decisions based on the received coverage and/or capacity policy related prediction information. For example, if a predicted coverage and/or capacity policy of a neighboring cell is received, which is that the neighboring cell will reduce its coverage at a certain time in the future, the node will not select this neighboring cell as a handover target cell when performing handover for a UE, to avoid the need for handover again when the coverage of the neighboring cell is reduced after the UE is handed over to the neighboring cell. The fifth node may also forward the coverage and/or capacity policy related prediction information to other nodes.

FIG. 5B illustrates a method for supporting coverage optimization according to an embodiment.

Referring to FIG. 5B, a process is shown for exchanging coverage and/or capacity policy related prediction information between two nodes, so that the fifth node can make relevant self-optimization decisions by using the received coverage and/or capacity policy related prediction information. For example, if a predicted coverage and/or capacity policy of a neighboring cell is received, which is that the neighboring cell will reduce its coverage at a certain time in the future, the node will not select this neighboring cell as a handover target cell when performing handover for a UE, to avoid the need for handover again when the coverage of the neighboring cell is reduced after the UE is handed over to the neighboring cell.

For example, the fifth node may be a UE, and the sixth node may be a gNB or a gNB-CU or a gNB-DU or a gNB CU-CP or a gNB CU-UP or an en-gNB or an eNB or an ng-eNB. Alternatively, the fifth node may be a gNB or a gNB-CU or a gNB CU-CP or an en-gNB or an eNB or an ng-eNB, and the sixth node may be a gNB or a gNB-CU or a gNB-DU or a gNB CU-CP or a gNB CU-UP or an en-gNB or an eNB or an ng-eNB. Alternatively, the fifth node may be an AMF or an SMF or an MME, and the sixth node may be a gNB or a gNB-CU or a gNB CU-CP or an en-gNB or an eNB or an ng-eNB. Alternatively, the fifth node may be a gNB or a gNB-CU or a gNB CU-CP or an en-gNB or an eNB or an ng-eNB, and the sixth node may be an AMF or an SMF or an MME. Alternatively, for example, the fifth node is a primary node and the sixth node is a secondary node; for example, the fifth node is a secondary node and the sixth node is a primary node; for example, the fifth node is a source node and the sixth node is a target node; for example, the fifth node is a target node and the sixth node is a source node.

In step 501B, the fifth node transmits a request for coverage and/or capacity policy related prediction information to the sixth node. The request for coverage and/or capacity policy related prediction information may be the aforementioned fifth message.

in step 502B, the sixth node transmits a response of coverage and/or capacity policy related prediction information to the fifth node. The response of coverage and/or capacity policy related prediction information may be the aforementioned sixth message.

In step 503B, the sixth node transmits coverage and/or capacity policy related prediction information to the fifth node. The coverage and/or capacity policy related prediction information may be the aforementioned seventh message.

In step 504B, the fifth node may make relevant self-optimization decisions based on the received coverage and/or capacity policy related prediction information. For example, if a predicted coverage and/or capacity policy of a neighboring cell is received, which is that the neighboring cell will reduce its coverage at a certain time in the future, the node will not select this neighboring cell as a handover target cell when performing handover for a UE, to avoid the need for handover again when the coverage of the neighboring cell is reduced after the UE is handed over to the neighboring cell. The fifth node may also forward the coverage and/or capacity policy related prediction information to other nodes.

Step 502B is optional.

If step 501B indicates periodic reporting, steps 503B and/or 504B are performed periodically.

FIG. 5C illustrates a method for supporting coverage optimization according to an embodiment.

Referring to FIG. 5C, a process is shown for exchanging coverage and/or capacity policy related prediction information between two nodes, so that the fifth node can use the received coverage and/or capacity policy related prediction information to predict and/or find coverage and/or capacity optimization problems. The fifth node may transmit the predicted and/or found coverage and/or capacity optimization problems to the sixth node, and the sixth node may make coverage and/or capacity decisions based on the coverage and/or capacity optimization problems or adjust the coverage and/or capacity decisions.

For example, the fifth node may be a gNB CU and the sixth node may be a gNB-DU. Alternatively, the fifth node may be a gNB and the sixth node may be another gNB. Alternatively, the fifth node may be a gNB or a gNB-CU or a gNB CU-CP or an en-gNB or an eNB or an ng-eNB, and the sixth node may be a gNB or a gNB-CU or a gNB-DU or a gNB CU-CP or a gNB CU-UP or an en-gNB or an eNB or an ng-eNB. Alternatively, the fifth node may be an AMF or an SMF or an MME, and the sixth node may be a gNB or a gNB-CU or a gNB CU-CP or an en-gNB or an eNB or an ng-eNB. Alternatively, the fifth node may be a gNB or a gNB-CU or a gNB CU-CP or an en-gNB or an eNB or an ng-eNB, and the sixth node may be an AMF or an SMF or an MME. Alternatively, for example, the fifth node is a primary node and the sixth node is a secondary node; for example, the fifth node is a secondary node and the sixth node is a primary node; for example, the fifth node is a source node and the sixth node is a target node; for example, the fifth node is a target node and the sixth node is a source node.

In step 501D, the fifth node transmits a request for coverage and/or capacity policy related prediction information to the sixth node. The request for coverage and/or capacity policy related prediction information may be the aforementioned fifth message.

In step 502D, the sixth node transmits a response of coverage and/or capacity policy related prediction information to the fifth node. The response of coverage and/or capacity policy related prediction information may be the aforementioned sixth message.

In step 503D, the sixth node transmits coverage and/or capacity policy related prediction information to the fifth node. The coverage and/or capacity policy related prediction information may be the aforementioned seventh message.

In step 504D, the sixth node transmits a coverage and/or capacity optimization problem information request to the fifth node to request the fifth node to transmit coverage and/or capacity optimization problems to the sixth node. The coverage and/or capacity optimization problem may be predicted or currently found. The predicted coverage and/or optimization problem may be predicted based on the received coverage and/or capacity policy related prediction information. If the coverage and/or capacity optimization problem information request is to request a predicted coverage and/or capacity optimization problem, the coverage and/or capacity optimization problem request may be the aforementioned first message. The coverage and/or capacity optimization problem request may include one or more of the following:

Reporting request is used to request the reporting and/or prediction of coverage and/or capacity optimization problem information.

Reporting type: it may include single reporting, multiple reporting, periodic reporting and event-triggered reporting.

### Reporting Time.

Reporting period: an interval between two reporting. For example, it may be the interval between two reporting under the periodic reporting. For example, if there is no content about this field, a single reporting is indicated.

Event and/or condition that triggers reporting and/or prediction: when the event and/or condition that triggers reporting and/or prediction is met, reporting and/or prediction is performed. It may include one or more of the following events and/or conditions:

It is predicted that a coverage and/or capacity optimization problem will occur. The event and/or condition includes event and/or condition identification, meeting time, event and/or condition.

A coverage and/or capacity optimization problem is found. The event and/or condition includes event and/or condition identification, meeting time, event and/or condition.

This step may be combined with step 502D or step 503D.

In step 505D, the fifth node transmits a coverage and/or capacity optimization problem response to the sixth node, to inform the sixth node whether the fifth node can report and/or predict coverage and/or capacity optimization problems. If the coverage and/or capacity optimization problem information is a predicted coverage and/or capacity optimization problem, the coverage and/or capacity optimization problem response may be the aforementioned second message. The response may include whether coverage and/or capacity optimization problems can be reported and/or predicted, information corresponding to a reporting that can be performed, information corresponding to a reporting that cannot be performed, and causes/reasons why reporting cannot be performed. The information corresponding to a reporting that can be performed may include one or more of the following information: reporting type, reporting time, reporting period, and events that trigger the reporting and/or prediction. The information corresponding to a reporting that cannot be performed may include one or more of reporting type, reporting time, reporting period, and events that trigger the reporting and/or prediction. The reporting type, reporting time, reporting period, and events that trigger the reporting and/or prediction may refer to the description in detail in step 504D.

In step 506D, the fifth node may predict and/or find coverage and/or capacity optimization problems based on the received coverage and/or capacity policy related prediction information, or it may make relevant self-optimization decisions. For example, if a predicted coverage and/or capacity policy of a neighboring cell is received, which is that the neighboring cell will reduce its coverage at a certain time in the future, the node will not select this neighboring cell as a handover target cell when performing handover for a UE, to avoid the need for handover again when the coverage of the neighboring cell is reduced after the UE is handed over to the neighboring cell. The fifth node may also forward the coverage and/or capacity policy related prediction information to other nodes.

In step 507D, the fifth node transmits coverage and/or capacity optimization problem information to the sixth node. The sixth node can make coverage and/or capacity decisions or adjust coverage and/or capacity decisions based on the coverage and/or capacity optimization problems. If the coverage and/or capacity optimization problem information is a predicted coverage and/or capacity optimization problem, the coverage and/or capacity optimization problem information may be the aforementioned third message. The coverage and/or capacity optimization problem information may include coverage and/or capacity optimization problem, the time when a problem occurs, cells where a problem occurs (ID and/or ID list), nodes where the problem occurs (ID and/or ID list), slices where a problem occurs (ID and/or ID list), UEs affected by an occurred problem (ID and/or ID list), the coverage and/or capacity policy corresponding to a problem, a coverage and/or capacity policy which needs to be modified, a suggested and/or allowed coverage and/or capacity policy. The suggested and/or allowed coverage and/or capacity policy may be the aforementioned fourth message.

If step 501D indicates periodic reporting, step 503D is performed periodically. If step 504D indicates periodic reporting, step 507D is performed periodically.

Herein, step 504D and/or step 505D may be performed before and/or at the same time and/or after step 501D and/or step 502D and/or step 503D.

FIG. 5D illustrates a method for supporting coverage optimization according to an embodiment.

Referring to FIG. 5D, a process is provided for exchanging coverage and/or capacity optimization problems between two nodes, so that fifth node may transmit the predicted and/or found coverage and/or capacity optimization problems to the sixth node, and the sixth node may make coverage and/or capacity decisions based on the coverage and/or capacity optimization problems, or adjust the coverage and/or capacity decisions.

For example, the fifth node may be a gNB CU and the sixth node may be a gNB-DU. Alternatively, the fifth node may be a gNB and the sixth node may be another gNB. Alternatively, the fifth node may be a gNB or a gNB-CU or a gNB CU-CP or an en-gNB or an eNB or an ng-eNB, and the sixth node may be a gNB or a gNB-CU or a gNB-DU or a gNB CU-CP or a gNB CU-UP or an en-gNB or an eNB or an ng-eNB. Alternatively, the fifth node may be an AMF or an SMF or an MME, and the sixth node may be a gNB or a gNB-CU or a gNB CU-CP or an en-gNB or an eNB or an ng-eNB. Alternatively, the fifth node may be a gNB or a gNB-CU or a gNB CU-CP or an en-gNB or an eNB or an ng-eNB, and the sixth node may be an AMF or an SMF or an MME. Alternatively, for example, the fifth node is a primary node and the sixth node is a secondary node; for example, the fifth node is a secondary node and the sixth node is a primary node; for example, the fifth node is a source node and the sixth node is a target node; for example, the fifth node is a target node and the sixth node is a source node.

In step 501E, the fifth node transmits a coverage and/or capacity decision to the sixth node. It may be transmitted through a configuration update message or a configuration update acknowledge message.

In step 502E, the sixth node transmits a coverage and/or capacity optimization problem information request to the fifth node to request the fifth node to transmit coverage and/or capacity optimization problems to the sixth node. The coverage and/or capacity optimization problem may be predicted or currently found. The predicted coverage and/or optimization problem may be predicted based on the received coverage and/or capacity policy related prediction information. If the coverage and/or capacity optimization problem information request is to request a predicted coverage and/or capacity optimization problem, the coverage and/or capacity optimization problem request may be the aforementioned first message. The coverage and/or capacity optimization problem request may include one or more of the following:

Reporting request is used to request the reporting and/or prediction of coverage and/or capacity optimization problem information.

Reporting type: it may include single reporting, multiple reporting, periodic reporting and event-triggered reporting.

### Reporting Time.

Reporting period: an interval between two reporting. For example, it may be the interval between two reporting under the periodic reporting. For example, if there is no content about this field, a single reporting is indicated.

Event and/or condition that triggers reporting and/or prediction: when the event and/or condition that triggers reporting and/or prediction is met, reporting and/or prediction is performed. It may include one or more of the following events and/or conditions:

It is predicted that a coverage and/or capacity optimization problem will occur. The event and/or condition includes event and/or condition identification, meeting time, event and/or condition.

A coverage and/or capacity optimization problem is found. The event and/or condition includes event and/or condition identification, meeting time, event and/or condition.

This step may be combined with step 501E.

In step 503E, the fifth node transmits a coverage and/or capacity optimization problem response to the sixth node, to inform the sixth node whether the fifth node can report and/or predict coverage and/or capacity optimization problems. If the coverage and/or capacity optimization problem information is a predicted coverage and/or capacity optimization problem, the coverage and/or capacity optimization problem response may be the aforementioned second message. The response may include whether coverage and/or capacity optimization problems can be reported and/or predicted, information corresponding to a reporting that can be performed, information corresponding to a reporting that cannot be performed, and causes/reasons why reporting cannot be performed. The information corresponding to a reporting that can be performed may include one or more of the following information: reporting type, reporting time, reporting period, and events that trigger the reporting and/or prediction. The information corresponding to a reporting that cannot be performed may include one or more of the following information: reporting type, reporting time, reporting period, and events that trigger the reporting and/or prediction. The reporting type, reporting time, reporting period, and events that trigger the reporting and/or prediction may refer to the description in detail in step 502E.

In step 504E, the fifth node may find coverage and/or capacity optimization problems. The coverage and/or capacity optimization problems may be found based on the received coverage and/or capacity decision.

In step 505E, the fifth node transmits coverage and/or capacity optimization problem information to the sixth node. The sixth node can make coverage and/or capacity decisions or adjust coverage and/or capacity decisions based on the coverage and/or capacity optimization problems. If the coverage and/or capacity optimization problem information is a predicted coverage and/or capacity optimization problem, the coverage and/or capacity optimization problem information may be the aforementioned third message. The coverage and/or capacity optimization problem information may include coverage and/or capacity optimization problem, the time when a problem occurs, cells where a problem occurs (ID and/or ID list), nodes where the problem occurs (ID and/or ID list), slices where a problem occurs (ID and/or ID list), UEs affected by an occurred problem (ID and/or ID list), the coverage and/or capacity policy corresponding to a problem, a coverage and/or capacity policy which needs to be modified, a suggested and/or allowed coverage and/or capacity policy. The suggested and/or allowed coverage and/or capacity policy may be the aforementioned fourth message.

If step 502E indicates periodic reporting, step 505E is performed periodically.

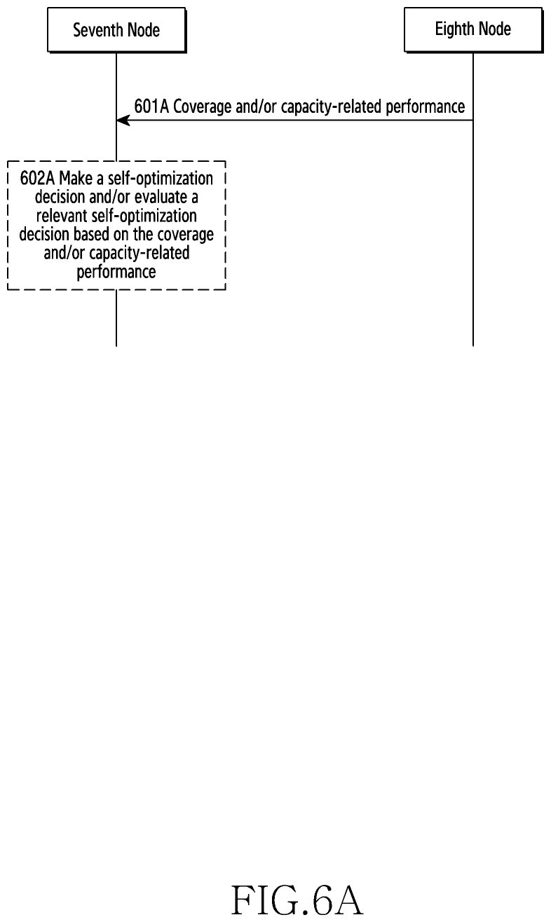

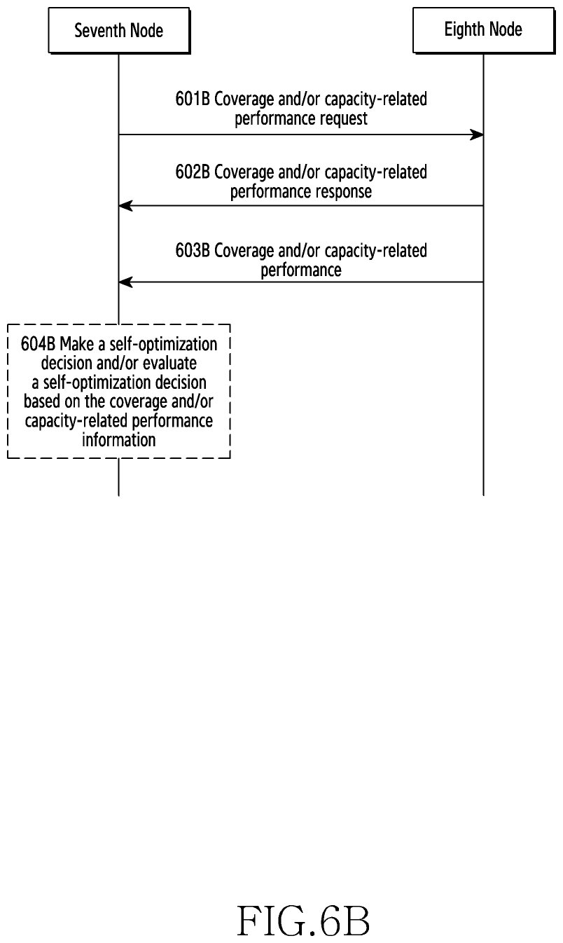

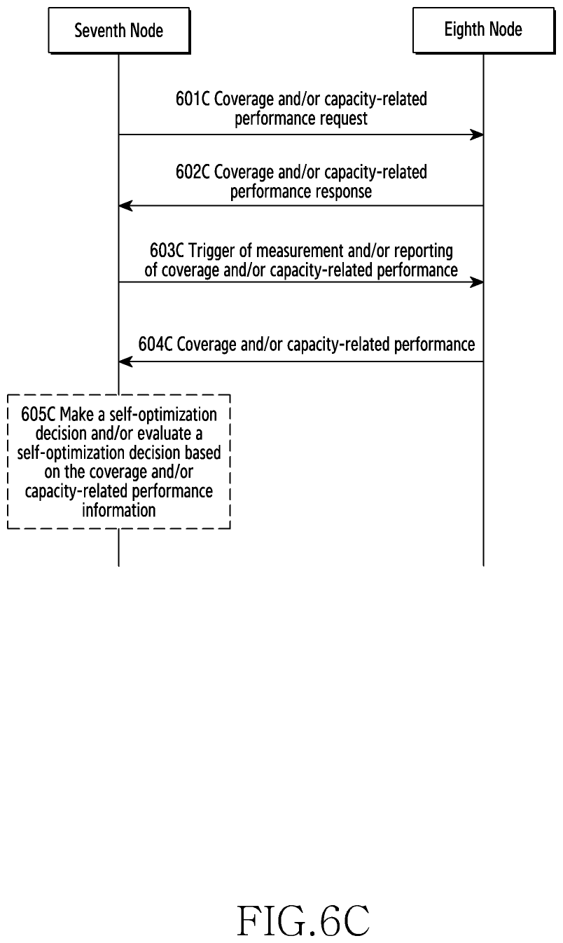

FIG. 6A illustrates a method for supporting coverage optimization according to an embodiment.

Referring to FIG. 6A, a process is shown of exchanging coverage and/or capacity-related performance information between two nodes, in which the seventh node can evaluate a coverage and/or capacity decision by using the coverage and/or capacity-related performance. For example, good coverage and/or capacity-related performance can indicate that the coverage and/or capacity decision is appropriate, and a poor coverage and/or capacity-related performance can indicate that the coverage and/or capacity decision is inappropriate and needs to be optimized and updated. Alternatively, the seventh node may also use the coverage and/or capacity-related performance to evaluate an AI ML model, e.g., it may evaluate whether the model can continue to be used, and whether the model needs to be trained and/or adjusted, etc. Alternatively, the seventh node can also make subsequent coverage and/or capacity decisions by using the coverage and/or capacity-related performance. For example, the coverage and/or capacity-related performance may be input into a decision generation model for making coverage and/or capacity decisions, and the decision generation model outputs relevant coverage and/or capacity decisions. The decision generation model may be a mathematical algorithm or an AI ML model. Alternatively, the seventh node may also use the coverage and/or capacity-related performance to evaluate an AI ML model, e.g., it may evaluate whether the model can continue to be used, and whether the model needs to be trained and/or adjusted, etc. The model may be an ML model for any function. Alternatively, the seventh node can also use the coverage and/or capacity-related performance to make subsequent decisions. For example, the coverage and/or capacity-related performance may be input into a decision generation model, and the decision generation model outputs relevant decisions. The decision generation model may be a mathematical algorithm or an AI ML model. The decision may be any decision, such as a coverage and/or capacity related decision, slice related decision, mobility related decision and self-optimization related decision.

For example, the seventh node may be a gNB or a gNB-CU or a gNB-DU or a gNB CU-CP or a gNB CU-UP or an en-gNB or an eNB or an ng-eNB, and the eighth node may be a UE. Alternatively, the seventh node may be a gNB or a gNB-CU or a gNB CU-CP or an en-gNB or an eNB or an ng-eNB, and the eighth node may be a gNB or a gNB-CU or a gNB-DU or a gNB CU-CP or a gNB CU-UP or an en-gNB or an eNB or an ng-eNB. Alternatively, the seventh node may be an AMF or an SMF or an MME, and the eighth node may be a gNB or a gNB-CU or a gNB CU-CP or an en-gNB or an eNB or an ng-eNB. Alternatively, the seventh node may be a gNB or a gNB-CU or a gNB CU-CP or an en-gNB or an eNB or an ng-eNB, and the eighth node may be an AMF or an SMF or an MME. Alternatively, for example, the seventh node is a primary node and the eighth node is a secondary node; for example, the seventh node is a secondary node and the eighth node is a primary node; for example, the seventh node is a source node and the eighth node is a target node; for example, the seventh node is a target node and the eighth node is a source node.

In step 601A, the eighth node transmits coverage and/or capacity-related performance information to the seventh node. The coverage and/or capacity-related performance information may be the aforementioned tenth message.

In step 602A, the seventh node can evaluate a coverage and/or capacity decision by using the coverage and/or capacity-related performance. For example, good coverage and/or capacity-related performance can indicate that the coverage and/or capacity decision is appropriate, and a poor coverage and/or capacity-related performance can indicate that the coverage and/or capacity decision is inappropriate and needs to be optimized and updated. Alternatively, the seventh node may also use the coverage and/or capacity-related performance to evaluate an AI ML model, e.g., it may evaluate whether the model can continue to be used, and whether the model needs to be trained and/or adjusted, etc. Alternatively, the seventh node can also make subsequent coverage and/or capacity decisions by using the coverage and/or capacity-related performance. For example, the coverage and/or capacity-related performance may be input into a decision generation model for making coverage and/or capacity decisions, and the decision generation model outputs relevant coverage and/or capacity decisions. The decision generation model may be a mathematical algorithm or an AI ML model. Alternatively, the seventh node may also use the coverage and/or capacity-related performance to evaluate an AI ML model, e.g., it may evaluate whether the model can continue to be used, and whether the model needs to be trained and/or adjusted, etc. The model may be an ML model for any function. Alternatively, the seventh node can also use the coverage and/or capacity-related performance to make subsequent decisions. For example, the coverage and/or capacity-related performance may be input into a decision generation model, and the decision generation model outputs relevant decisions. The decision generation model may be a mathematical algorithm or an AI ML model. The decision may be any decision, such as a coverage and/or capacity related decision, slice related decision, mobility related decision and self-optimization related decision. The seventh node can also forward the coverage and/or capacity-related performance information to other nodes.

FIG. 6B illustrates a method for supporting coverage optimization according to an embodiment.

Referring to FIG. 6B, exchanging coverage and/or capacity-related performance information between two nodes, in which the seventh node can evaluate a coverage and/or capacity decision by using the coverage and/or capacity-related performance. For example, good coverage and/or capacity-related performance can indicate that the coverage and/or capacity decision is appropriate, and a poor coverage and/or capacity-related performance can indicate that the coverage and/or capacity decision is inappropriate and needs to be optimized and updated. Alternatively, the seventh node may also use the coverage and/or capacity-related performance to evaluate an AI ML model, e.g., it may evaluate whether the model can continue to be used, and whether the model needs to be trained and/or adjusted, etc. Alternatively, the seventh node can also make subsequent coverage and/or capacity decisions by using the coverage and/or capacity-related performance. For example, the coverage and/or capacity-related performance may be input into a decision generation model for making coverage and/or capacity decisions, and the decision generation model outputs relevant coverage and/or capacity decisions. The decision generation model may be a mathematical algorithm or an AI ML model. Alternatively, the seventh node may also use the coverage and/or capacity-related performance to evaluate an AI ML model, e.g., it may evaluate whether the model can continue to be used, and whether the model needs to be trained and/or adjusted, etc. The model may be an ML model for any function. Alternatively, the seventh node can also use the coverage and/or capacity-related performance to make subsequent decisions. For example, the coverage and/or capacity-related performance may be input into a decision generation model, and the decision generation model outputs relevant decisions. The decision generation model may be a mathematical algorithm or an AI ML model. The decision may be any decision, such as a coverage and/or capacity related decision, slice related decision, mobility related decision and self-optimization related decision.

For example, the seventh node may be a gNB or a gNB-CU or a gNB-DU or a gNB CU-CP or a gNB CU-UP or an en-gNB or an eNB or an ng-eNB, and the eighth node may be a UE. Alternatively, the seventh node may be a gNB or a gNB-CU or a gNB CU-CP or an en-gNB or an eNB or an ng-eNB, and the eighth node may be a gNB or a gNB-CU or a gNB-DU or a gNB CU-CP or a gNB CU-UP or an en-gNB or an eNB or an ng-eNB. Alternatively, the seventh node may be an AMF or an SMF or an MME, and the eighth node may be a gNB or a gNB-CU or a gNB CU-CP or an en-gNB or an eNB or an ng-eNB. Alternatively, the seventh node may be a gNB or a gNB-CU or a gNB CU-CP or an en-gNB or an eNB or an ng-eNB, and the eighth node may be an AMF or an SMF or an MME. Alternatively, for example, the seventh node is a primary node and the eighth node is a secondary node; for example, the seventh node is a secondary node and the eighth node is a primary node; for example, the seventh node is a source node and the eighth node is a target node; for example, the seventh node is a target node and the eighth node is a source node.

In step 601B, the seventh node transmits a coverage and/or capacity-related performance request to the eighth node. The coverage and/or capacity-related performance request may be the aforementioned eighth message.

In step 602B, the eighth node transmits a coverage and/or capacity-related performance response to the seventh node. The coverage and/or capacity-related performance response may be the aforementioned ninth message.

In step 603B, the eighth node transmits coverage and/or capacity-related performance information to the seventh node. The coverage and/or capacity-related performance information may be the aforementioned tenth message.

In step 604B, the seventh node can evaluate a coverage and/or capacity decision by using the coverage and/or capacity-related performance. For example, a good coverage and/or capacity-related performance can indicate that the coverage and/or capacity decision is appropriate, and a poor coverage and/or capacity-related performance can indicate that the coverage and/or capacity decision is inappropriate and needs to be optimized and updated. Alternatively, the seventh node may also use the coverage and/or capacity-related performance to evaluate an AI ML model, e.g., it may evaluate whether the model can continue to be used, and whether the model needs to be trained and/or adjusted, etc. Alternatively, the seventh node can also make subsequent coverage and/or capacity decisions by using the coverage and/or capacity-related performance. For example, the coverage and/or capacity-related performance may be input into a decision generation model for making coverage and/or capacity decisions, and the decision generation model outputs relevant coverage and/or capacity decisions. The decision generation model may be a mathematical algorithm or an AI ML model. Alternatively, the seventh node may also use the coverage and/or capacity-related performance to evaluate an AI ML model, e.g., it may evaluate whether the model can continue to be used, and whether the model needs to be trained and/or adjusted, etc. The model may be a ML model for any function. Alternatively, the seventh node can also use the coverage and/or capacity-related performance to make subsequent decisions. For example, the coverage and/or capacity-related performance may be input into a decision generation model, and the decision generation model outputs relevant decisions. The decision generation model may be a mathematical algorithm or an AI ML model. The decision may be any decision, such as a coverage and/or capacity related decision, slice related decision, mobility related decision and self-optimization related decision. The seventh node can also forward the coverage and/or capacity-related performance information to other nodes.

Step 602B is optional.

If step 601B indicates periodic reporting, steps 603B and/or 604B are performed periodically.

FIG. 6C illustrates a method for supporting coverage optimization according to an embodiment.

Referring to FIG. 6C, a process is shown for exchanging coverage and/or capacity-related performance information between two nodes, in which the seventh node can evaluate a coverage and/or capacity decision by using the coverage and/or capacity-related performance. For example, good coverage and/or capacity-related performance can indicate that the coverage and/or capacity decision is appropriate, and a poor coverage and/or capacity-related performance can indicate that the coverage and/or capacity decision is inappropriate and needs to be optimized and updated. Alternatively, the seventh node may also use the coverage and/or capacity-related performance to evaluate an AI ML model, e.g., it may evaluate whether the model can continue to be used, and whether the model needs to be trained and/or adjusted, etc. Alternatively, the seventh node can also make subsequent coverage and/or capacity decisions by using the coverage and/or capacity-related performance. For example, the coverage and/or capacity-related performance may be input into a decision generation model for making coverage and/or capacity decisions, and the decision generation model outputs relevant coverage and/or capacity decisions. The decision generation model may be a mathematical algorithm or an AI ML model. Alternatively, the seventh node may also use the coverage and/or capacity-related performance to evaluate an AI ML model, e.g., it may evaluate whether the model can continue to be used, and whether the model needs to be trained and/or adjusted, etc. The model may be an ML model for any function. Alternatively, the seventh node can also use the coverage and/or capacity-related performance to make subsequent decisions. For example, the coverage and/or capacity-related performance may be input into a decision generation model, and the decision generation model outputs relevant decisions. The decision generation model may be a mathematical algorithm or an AI ML model. The decision may be any decision, such as a coverage and/or capacity related decision, slice related decision, mobility related decision and self-optimization related decision.

For example, the seventh node may be a gNB or a gNB-CU or a gNB-DU or a gNB CU-CP or a gNB CU-UP or an en-gNB or an eNB or an ng-eNB, and the eighth node may be a UE. Alternatively, the seventh node may be a gNB or a gNB-CU or a gNB CU-CP or an en-gNB or an eNB or an ng-eNB, and the eighth node may be a gNB or a gNB-CU or a gNB-DU or a gNB CU-CP or a gNB CU-UP or an en-gNB or an eNB or an ng-eNB. Alternatively, the seventh node may be an AMF or an SMF or an MME, and the eighth node may be a gNB or a gNB-CU or a gNB CU-CP or an en-gNB or an eNB or an ng-eNB. Alternatively, the seventh node may be a gNB or a gNB-CU or a gNB CU-CP or an en-gNB or an eNB or an ng-eNB, and the eighth node may be an AMF or an SMF or an MME. Alternatively, for example, the seventh node is a primary node and the eighth node is a secondary node; for example, the seventh node is a secondary node and the eighth node is a primary node; for example, the seventh node is a source node and the eighth node is a target node; for example, the seventh node is a target node and the eighth node is a source node.

In step 601C, the seventh node transmits a coverage and/or capacity-related performance request to the eighth node. The coverage and/or capacity-related performance request may be the aforementioned eighth message.

In step 602C, the eighth node transmits a coverage and/or capacity-related performance response to the seventh node. The coverage and/or capacity-related performance response may be the aforementioned ninth message.

In step 603C, the seventh node transmits a trigger of collection and/or reporting of coverage and/or capacity-related performance to the eighth node. Configuration information for the collection and/or reporting is transmitted in step 601C, while step 603C is to trigger the collection and/or reporting. The trigger of collection and/or reporting of coverage and/or capacity-related performance may be request ID, measurement ID, prediction ID, configuration ID, coverage and/or capacity-related performance collection and/or reporting indication, etc. The request ID, measurement ID, prediction ID and configuration ID may be the same as the request ID, measurement ID, prediction ID and configuration ID of the coverage and/or capacity-related performance request in step 601C, to inform the eighth node of the configuration information corresponding to the information that needs to be collected and/or reported. The message may be carried by a message that transmits a related decision. The related decision may include coverage and/or capacity optimization decision, mobility decision, etc. This message may be carried by one or more of the following messages: HANDOVER REQUEST, HANDOVER REQUEST ACKNOWLEDGE, S-NODE ADDITION REQUEST, S-NODE ADDITION REQUEST ACKNOWLEDGE, NG-RAN NODE CONFIGURATION UPDATE message, NG-RAN NODE CONFIGURATION UPDATE ACKNOWLEDGE message, GNB-CU CONFIGURATION UPDATE message, GNB-CU CONFIGURATION UPDATE ACKNOWLEDGE message, GNB-DU CONFIGURATION UPDATE message and GNB-DU CONFIGURATION UPDATE ACKNOWLEDGE message.

In step 604C, the eighth node transmits coverage and/or capacity-related performance information to the seventh node. The coverage and/or capacity-related performance information may be the aforementioned tenth message.

In step 605C, the seventh node can evaluate a coverage and/or capacity decision by using the coverage and/or capacity-related performance. For example, good coverage and/or capacity-related performance can indicate that the coverage and/or capacity decision is appropriate, and a poor coverage and/or capacity-related performance can indicate that the coverage and/or capacity decision is inappropriate and needs to be optimized and updated. Alternatively, the seventh node may also use the coverage and/or capacity-related performance to evaluate an AI ML model, e.g., it may evaluate whether the model can continue to be used, and whether the model needs to be trained and/or adjusted, etc. Alternatively, the seventh node can also make subsequent coverage and/or capacity decisions by using the coverage and/or capacity-related performance. For example, the coverage and/or capacity-related performance may be input into a decision generation model for making coverage and/or capacity decisions, and the decision generation model outputs relevant coverage and/or capacity decisions. The decision generation model may be a mathematical algorithm or an AI ML model. Alternatively, the seventh node may also use the coverage and/or capacity-related performance to evaluate an AI ML model, e.g., it may evaluate whether the model can continue to be used, and whether the model needs to be trained and/or adjusted, etc. The model may be an ML model for any function. Alternatively, the seventh node can also use the coverage and/or capacity-related performance to make subsequent decisions. For example, the coverage and/or capacity-related performance may be input into a decision generation model, and the decision generation model outputs relevant decisions. The decision generation model may be a mathematical algorithm or an AI ML model. The decision may be any decision, such as a coverage and/or capacity related decision, slice related decision, mobility related decision and self-optimization related decision. The seventh node can also forward the coverage and/or capacity-related performance information to other nodes.

Step 602C is optional.

Step 603C is optional.

If step 601C indicates periodic reporting, steps 604C and/or 605C are performed periodically.

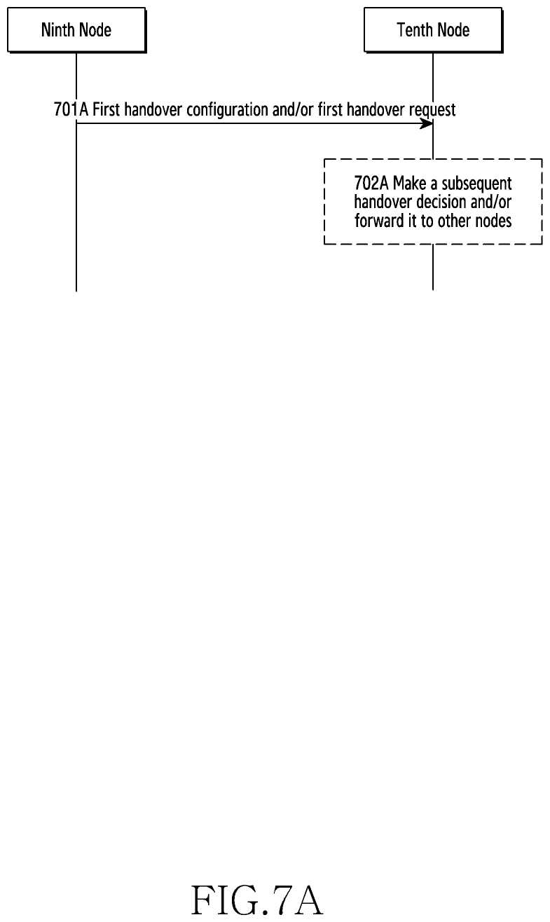

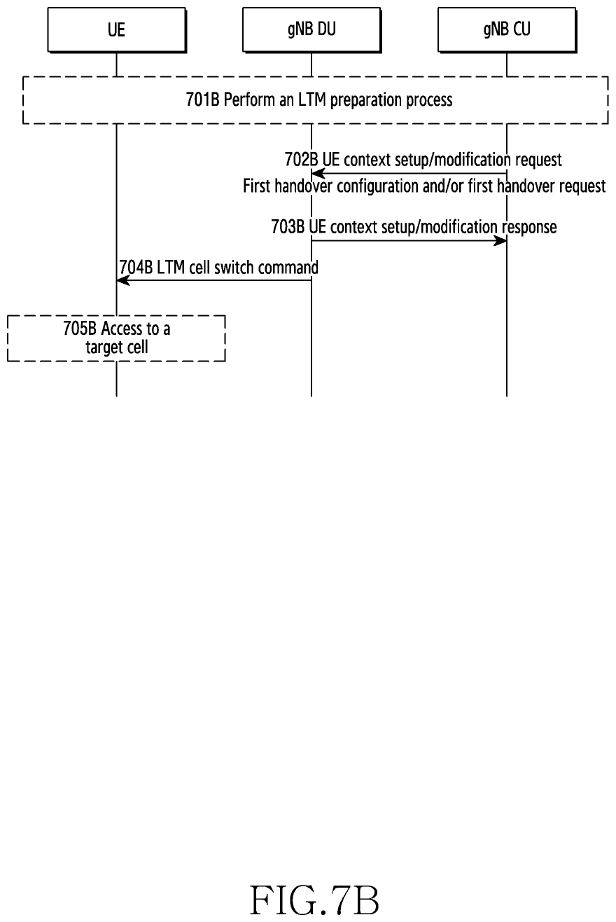

FIG. 7A illustrates a method for supporting coverage optimization according to an embodiment.

Referring to FIG. 7A, a process is shown for exchanging a first handover configuration and/or first handover request between two nodes, so that the tenth node can make a subsequent handover decision based on the received first handover configuration and/or first handover request and/or forward it to other nodes.

For example, the ninth node may be a gNB or a gNB-CU or a gNB-DU or a gNB CU-CP or a gNB CU-UP or an en-gNB or an eNB or an ng-eNB, and the tenth node may be a UE. Alternatively, the ninth node may be a gNB or a gNB-CU or a gNB CU-CP or an en-gNB or an eNB or an ng-eNB, and the tenth node may be a gNB or a gNB-CU or a gNB-DU or a gNB CU-CP or a gNB CU-UP or an en-gNB or an eNB or an ng-eNB. Alternatively, the ninth node may be an AMF or an SMF or an MME, and the tenth node may be a gNB or a gNB-CU or a gNB CU-CP or an en-gNB or an eNB or an ng-eNB. Alternatively, the ninth node may be a gNB or a gNB-CU or a gNB CU-CP or an en-gNB or an eNB or an ng-eNB, and the tenth node may be an AMF or an SMF or an MME. Alternatively, for example, the ninth node is a primary node and the tenth node is a secondary node; for example, the ninth node is a secondary node and the tenth node is a primary node; for example, the ninth node is a source node and the tenth node is a target node; for example, the ninth node is a target node and the tenth node is a source node.

In step 701A, the ninth node transmits a first handover configuration and/or first handover request to the tenth node. The first handover configuration and/or first handover request may be the aforementioned eleventh message.

In step 702A, the tenth node can make a subsequent handover decision based on the received first handover configuration and/or first handover request and/or forward it to other nodes.

FIG. 7B illustrates a method for supporting coverage optimization according to an embodiment.

Referring to FIG. 7B, a process is shown in which gNB CU and gNB DU exchange a first handover configuration and/or first handover request in an LTM, and gNB DU can make subsequent handover decisions based on the received first handover configuration and/or first handover request.

In step 701B, an LTM preparation process is performed.

In step 702B, the gNB CU transmits a first handover configuration and/or first handover request to the gNB DU. The first handover configuration and/or first handover request may be the aforementioned eleventh message. The gNB CU may determine the first handover configuration and/or first handover request based on assistance information received from other nodes, e.g., select an appropriate handover target cell according to a coverage and/or capacity decision received from other nodes, and/or (predicted) resource status information, user performance information, etc. After receiving the first handover configuration and/or first handover request, the gNB DU may make a handover decision for LTM handover, e.g., to hand over the UE to a target cell indicated by handover target cell information received from the gNB CU. The first handover configuration and/or first handover request may be carried by a UE context setup request message and/or a UE context modification request message.

In step 703B, the gNB DU transmits a UE context setup response message and/or a UE context modification response message to the gNB CU.

In step 704B, the gNB DU can make subsequent handover decisions based on the received first handover configuration and/or first handover request, and transmits an LTM cell switch command to the UE.

In step 705B, the UE accesses the target cell.

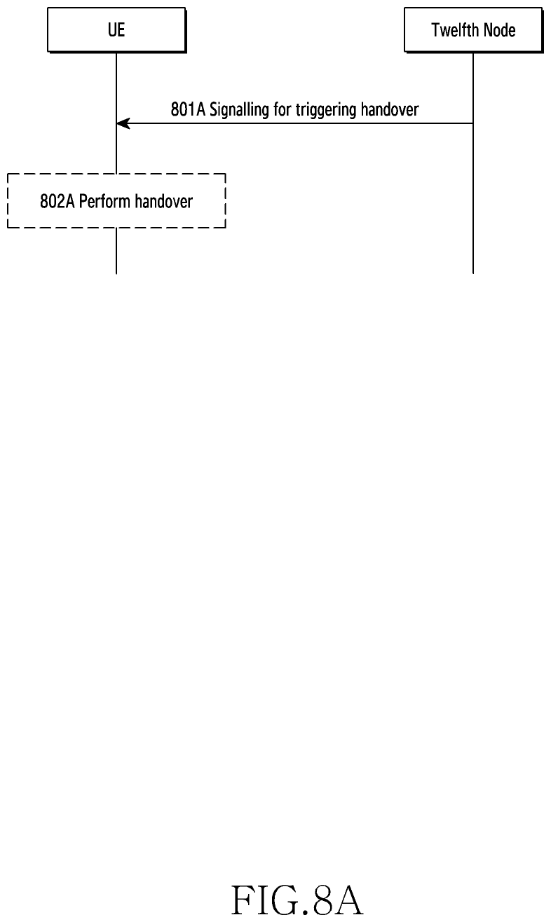

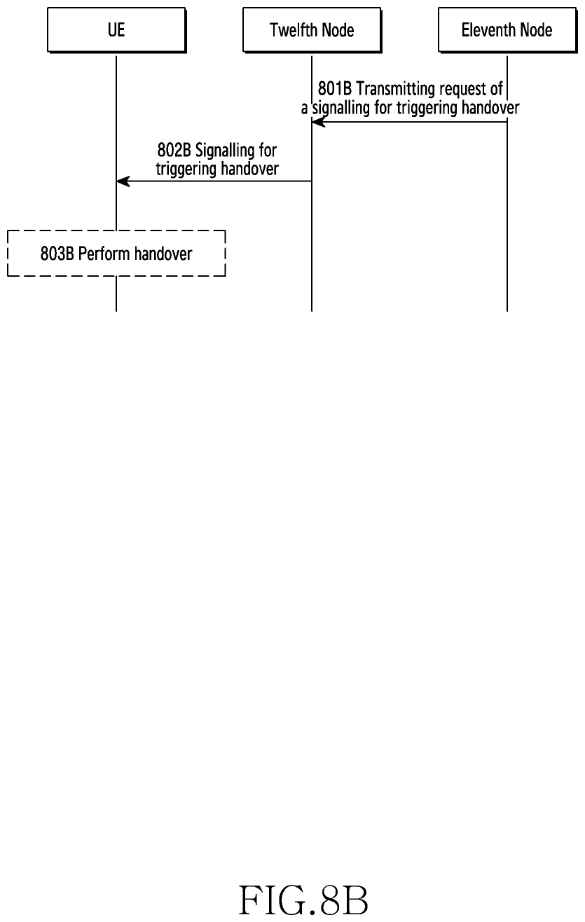

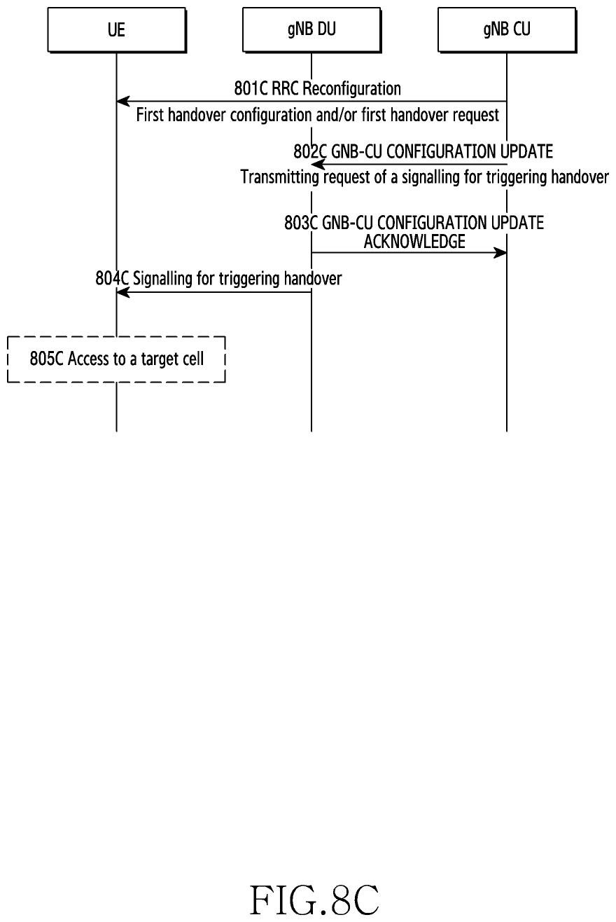

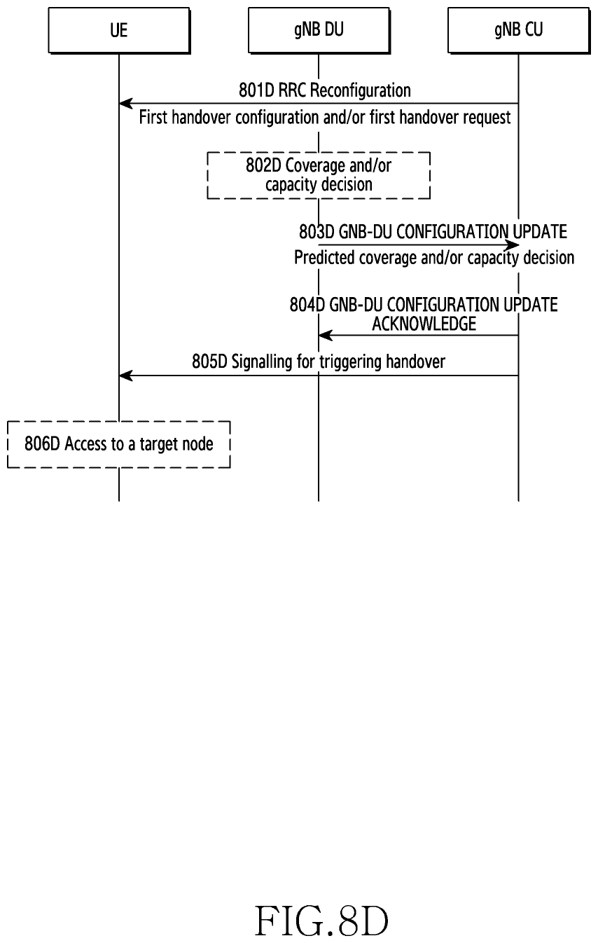

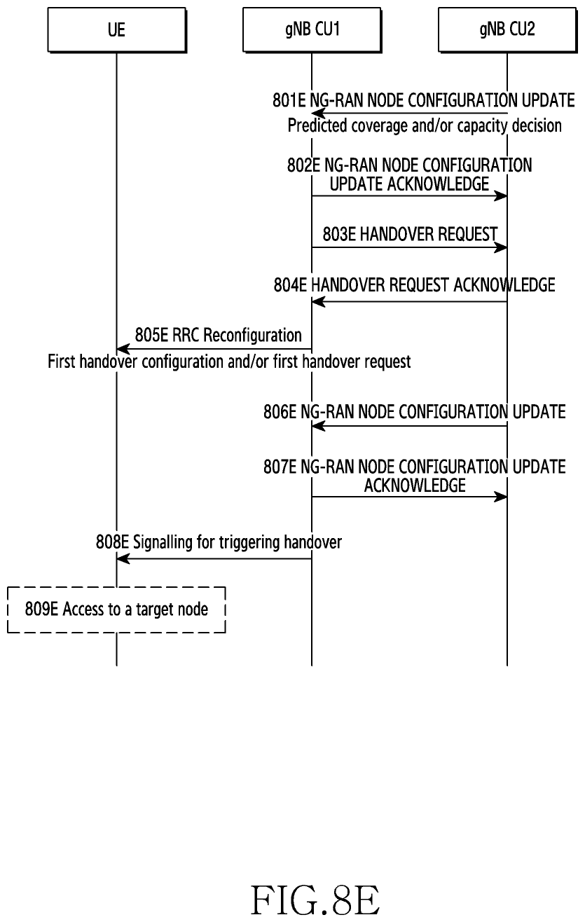

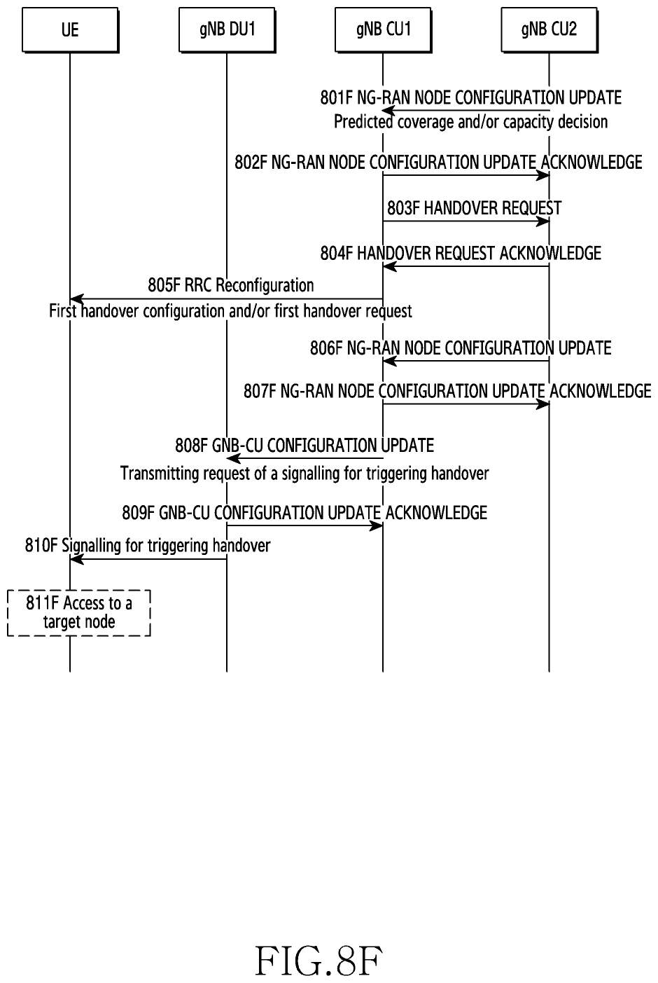

FIG. 8A illustrates a method for supporting coverage optimization according to an embodiment. Referring to FIG. 8A, a process is shown for exchanging a signaling for triggering handover between two nodes, in which the UE performs handover after receiving the signaling for triggering handover. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

For example, the twelfth node may be a gNB or a gNB-CU or a gNB-DU or a gNB CU-CP or a gNB CU-UP or an en-gNB or an eNB or an ng-eNB or an AMF or an SMF or an MME.

In step 801A, the twelfth node transmits and/or broadcasts a signaling for triggering handover to the UE. The signaling for triggering handover may refer to the signaling for triggering handover in the twelfth message. The signaling for triggering handover may be a MAC CE and/or an RRC message and/or an RRC container and/or a physical layer signaling.

In step 802A, the UE performs handover. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

FIG. 8B illustrates a method for supporting coverage optimization according to an embodiment.

Referring to FIG. 8B, a process is shown for exchanging a signaling for triggering handover between two nodes, in which the UE performs handover after receiving the signaling for triggering handover. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

For example, the eleventh node may be a gNB or a gNB-CU or a gNB CU-CP or an en-gNB or an eNB or an ng-eNB, and the twelfth node may be a gNB or a gNB-CU or a gNB-DU or a gNB CU-CP or a gNB CU-UP or an en-gNB or an eNB or an ng-eNB. Alternatively, the eleventh node may be an AMF or an SMF or an MME, and the twelfth node may be a gNB or a gNB-CU or a gNB CU-CP or an en-gNB or an eNB or an ng-eNB. Alternatively, the eleventh node may be a gNB or a gNB-CU or a gNB CU-CP or an en-gNB or an eNB or an ng-eNB, and the twelfth node may be an AMF or an SMF or an MME. Alternatively, for example, the eleventh node is a primary node and the twelfth node is a secondary node; for example, the eleventh node is a secondary node, and the twelfth node is a primary node; for example, the eleventh node is a source node and the twelfth node is a target node; for example, the eleventh node is a target node and the twelfth node is a source node.

In step 801B, the eleventh node transmits a transmitting request for a signaling for triggering handover to the twelfth node. The transmitting request for a signaling for triggering handover may be the aforementioned twelfth message. The transmitting request for a signaling for triggering handover may be to request the twelfth node to transmit and/or broadcast a signaling for triggering handover to the UE, or may be to request the twelfth node to perform handover for the UE/not to perform handover for the UE, or may be for the twelfth node to forward the request to other nodes to request the other nodes to transmit and/or broadcast a signaling for triggering handover to the UE or request the other nodes to perform handover for the UE/not to perform handover for the UE.

For example, steps 802B and 803B are performed.

In step 802B, the twelfth node transmits and/or broadcasts a signaling for triggering handover to the UE. The signaling for triggering handover may refer to the signaling for triggering handover in the twelfth message. The signaling for triggering handover may be a MAC CE and/or an RRC message and/or an RRC container and/or a physical layer signaling.

In step 803B, the UE performs handover. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

FIG. 8C illustrates a method for supporting coverage optimization according to an embodiment.

Referring to FIG. 8C, a process is shown for exchanging a first handover configuration and/or first handover request and a signaling for triggering handover between nodes, to ensure that a plurality of UE can be handed over to an appropriate target node in a short time. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

In step 801C, the gNB CU transmits a first handover configuration and/or first handover request to the UE. The first handover configuration and/or first handover request may be the aforementioned eleventh message. For example, when the gNB CU and/or gNB DU is to execute a related decision, the message is transmitted to the UE. The relevant decision may include self-optimization decision, coverage and/or capacity decision, etc. For example, when the gNB CU receives the coverage and/or capacity policy related prediction information predicted by the gNB DU, it transmits this message to relevant users. This message may be carried by an RRC reconfiguration (RRCReconfiguration) message. In some implementations, e.g., after receiving the RRC reconfiguration (RRCReconfiguration) message, the UE transmits an RRC reconfiguration complete (RRCReconfigurationComplete) message to the gNB CU.

In step 802C, the gNB CU transmits a transmitting request for a signaling for triggering handover to the gNB DU. The transmitting request for a signaling for triggering handover may be the aforementioned twelfth message. This message may be carried by a gNB CU configuration update (GNB-CU CONFIGURATION UPDATE) message.

In step 803C, the gNB DU transmits a gNB CU configuration update acknowledge (GNB-CU CONFIGURATION UPDATE ACKNOWLEDGE) message to the gNB CU.

In step 804C, the gNB DU transmits and/or broadcasts a signaling for triggering handover to the UE. The signaling for triggering handover may refer to the signaling for triggering handover in the twelfth message. When the gNB DU is to modify and/or currently decides to modify a coverage and/or capacity decision, it transmits and/or broadcasts a signaling for triggering handover to the UE. Alternatively, when the (predicted) load condition and/or resource status of the gNB DU is to be overloaded, a signaling for triggering handover is transmitted and/or broadcast to the UE. The signaling for triggering handover may be a MAC CE and/or an RRC message and/or an RRC container and/or a physical layer signaling.

In step 805C, the UE accesses to the target cell. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

FIG. 8D illustrates a method for supporting coverage optimization according to an embodiment.

Referring to FIG. 8D, a process is shown for exchanging a first handover configuration and/or first handover request and a signaling for triggering handover between nodes, to ensure that a plurality of UE can be handed over to an appropriate target node in a short time. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

in step 801D, the gNB CU transmits the first handover configuration and/or first handover request to the UE. The first handover configuration and/or first handover request may be the aforementioned eleventh message. For example, when the gNB CU and/or gNB DU is to execute a related decision, the message is transmitted to the UE. The relevant decision may include self-optimization decision, coverage and/or capacity decision, etc. For example, when the gNB CU receives the coverage and/or capacity policy related prediction information predicted by the gNB DU, it transmits this message to relevant users. This message may be carried by an RRC reconfiguration (RRCReconfiguration) message. After receiving the RRC reconfiguration (RRCReconfiguration) message, the UE transmits an RRC reconfiguration complete (RRCReconfigurationComplete) message to the gNB CU.

In step 802D, the gNB DU makes a coverage and/or capacity decision, for example, coverage and/or capacity decision changes are made and/or to be made.

in step 803D, the gNB DU transmits a (predicted) coverage and/or capacity decision to the gNB CU. Herein the predicted coverage and/or capacity decision may be the aforementioned seventh message. This message may be carried by a gNB DU configuration update (GNB-DU CONFIGURATION UPDATE) message.

In step 804D, the gNB CU transmits a gNB DU configuration update acknowledge (GNB-DU CONFIGURATION UPDATE ACKNOWLEDGE) message to the gNB DU.

In step 805D, the gNB CU transmits and/or broadcasts a signaling for triggering handover to the UE. The signaling for triggering handover may refer to the signaling for triggering handover in the twelfth message. The gNB CU transmits and/or broadcasts a signaling for triggering handover to the UE when it receives that the gNB DU is to modify and/or currently decides to modify a coverage and/or capacity decision. Alternatively, when the (predicted) load condition and/or resource status of the gNB DU and/or gNB CU is to be overloaded, a signaling for triggering handover is transmitted and/or broadcast to the UE. The signaling for triggering handover may be a MAC CE and/or an RRC message and/or an RRC container and/or a physical layer signaling.

In step 806D, the UE accesses to the target cell. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

FIG. 8E illustrates a method for supporting coverage optimization according to an embodiment.

Referring to FIG. 8E, a process is shown for exchanging a first handover configuration and/or first handover request and a signaling for triggering handover between nodes, to ensure that a plurality of UE can be handed over to an appropriate target node in a short time. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

In step 801E, the gNB CU2 transmits a (predicted) coverage and/or capacity decision to gNB CU1. Herein the predicted coverage and/or capacity decision may be the aforementioned seventh message. This message may be carried by an NG-RAN node configuration update (NG-RAN NODE CONFIGURATION UPDATE) message.

In step 802E, the gNB CU1 transmits an NG-RAN node configuration update acknowledge (NG-RAN NODE CONFIGURATION UPDATE ACKNOWLEDGE) message to gNB CU2.

In step 803E, the gNB CU1 transmits a handover request (HANDOVER REQUEST) message to gNB CU2.

In step 804E, the gNB CU2 transmits a handover request acknowledge (HANDOVER REQUEST ACKNOWLEDGE) message to gNB CU1.

In step 805E, the gNB CU1 transmits a first handover configuration and/or first handover request to the UE. The first handover configuration and/or first handover request may be the aforementioned eleventh message. For example, when the gNB CU and/or gNB DU is to execute a related decision, the message is transmitted to the UE. The relevant decision may include self-optimization decision, coverage and/or capacity decision, etc. For example, when gNB CU1 receives the coverage and/or capacity policy related prediction information predicted by gNB CU2, it transmits this message to relevant users. This message may be carried by an RRC reconfiguration (RRCReconfiguration) message. In some implementations, e.g., after receiving the RRC reconfiguration (RRCReconfiguration) message, the UE transmits an RRC reconfiguration complete (RRCReconfigurationComplete) message to gNB CU1.

The following steps 806E and 807E are performed.

In step 806E, the gNB CU2 transmits a coverage and/or capacity decision to gNB CU1. This message may be carried by an NG-RAN node configuration update (NG-RAN NODE CONFIGURATION UPDATE) message.

In step 807E, the gNB CU1 transmits an NG-RAN node configuration update acknowledge (NG-RAN NODE CONFIGURATION UPDATE ACKNOWLEDGE) message to gNB CU2.

In step 808E, the gNB CU1 transmits and/or broadcasts a signaling for triggering handover to the UE. The signaling for triggering handover may refer to the signaling for triggering handover in the twelfth message. In some implementations, for example, when gNB CU1 receives that a neighboring cell (e.g., gNB CU2) is to modify and/or currently decides to modify a coverage and/or capacity decision, it transmits and/or broadcasts a signaling for triggering handover to the UE. Alternatively, when the (predicted) load condition and/or resource status of gNB DU1 and/or gNB CU1 and/or gNB CU2 received from gNB CU2 is to be overloaded, a signaling for triggering handover is transmitted and/or broadcast to the UE. The signaling for triggering handover may be a MAC CE and/or an RRC message and/or an RRC container and/or a physical layer signaling.

In step 809E, the UE accesses the target cell. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

Steps 806E and/807E are optional.

FIG. 8F illustrates a method for supporting coverage optimization according to an embodiment.

Referring to FIG. 8F, a process is shown for exchanging a first handover configuration and/or first handover request and a signaling for triggering handover between nodes, to ensure that a plurality of UE can be handed over to an appropriate target node in a short time.

In step 801F, the gNB CU2 transmits a (predicted) coverage and/or capacity decision to gNB CU1. The predicted coverage and/or capacity decision may be the aforementioned seventh message. This message may be carried by an NG-RAN node configuration update (NG-RAN NODE CONFIGURATION UPDATE) message.

In step 802F, the gNB CU1 transmits an NG-RAN node configuration update acknowledge (NG-RAN NODE CONFIGURATION UPDATE ACKNOWLEDGE) message to gNB CU2.

In step 803F, the gNB CU1 transmits a handover request (HANDOVER REQUEST) message to gNB CU2. This step may be that gNB CU1 transmits a first handover configuration and/or first handover request to gNB CU2. The first handover configuration and/or first handover request may be the aforementioned eleventh message. The message may be a handover request (HANDOVER REQUEST) message.

In step 804F, the gNB CU2 transmits a handover request acknowledge (HANDOVER REQUEST ACKNOWLEDGE) message to gNB CU1.

In step 805F, the gNB CU1 transmits a first handover configuration and/or first handover request to the UE. The first handover configuration and/or first handover request may be the aforementioned eleventh message. For example, when the gNB CU and/or gNB DU is to execute a related decision, the message is transmitted to the UE. The relevant decision may include self-optimization decision, coverage and/or capacity decision, etc. For example, when gNB CU1 receives the coverage and/or capacity policy related prediction information predicted by gNB CU2, it transmits this message to relevant users. This message may be carried by an RRC reconfiguration (RRCReconfiguration) message. In some implementations, e.g., after receiving the RRC reconfiguration (RRCReconfiguration) message, the UE transmits an RRC reconfiguration complete (RRCReconfigurationComplete) message to gNB CU1.

In step 805F, the gNB CU1 transmits an RRC reconfiguration (RRCReconfiguration) message to the UE. After receiving the RRC reconfiguration (RRCReconfiguration) message, the UE transmits an RRC reconfiguration complete (RRCReconfigurationComplete) message to gNB CU1.

In step 806F, the gNB CU2 transmits a coverage and/or capacity decision to gNB CU1. This message may be carried by an NG-RAN node configuration update (NG-RAN NODE CONFIGURATION UPDATE) message.

In step 807F, the gNB CU1 transmits an NG-RAN node configuration update acknowledge (NG-RAN NODE CONFIGURATION UPDATE ACKNOWLEDGE) message to gNB CU2.

In step 808F, the gNB CU1 transmits a transmitting request for a signaling for triggering handover to gNB DU1. The transmitting request for a signaling for triggering handover may be the aforementioned twelfth message. This message may be carried by a gNB CU configuration update (GNB-CU CONFIGURATION UPDATE) message.

In step 809F, the gNB DU1 transmits a gNB CU configuration update acknowledge (GNB-CU CONFIGURATION UPDATE ACKNOWLEDGE) message to gNB CU1.

In step 810F, the gNB DU1 transmits and/or broadcasts a signaling for triggering handover to the UE. The signaling for triggering handover may refer to the signaling for triggering handover in the twelfth message. In some implementations, e.g., when gNB DU1 is to modify and/or currently decides to modify a coverage and/or capacity decision, it transmits and/or broadcasts a signaling for triggering handover to the UE. Alternatively, when the (predicted) load condition and/or resource status of gNB DU1 is to be overloaded, a signaling for triggering handover is transmitted and/or broadcast to the UE. The signaling for triggering handover may be a MAC CE and/or an RRC message and/or an RRC container and/or a physical layer signaling.

In step 811F, the UE accesses to the target cell. The signaling for triggering handover received by the UE is a signaling for invalidation and/or deactivation of an execution condition, the UE does not perform handover, and/or, the UE does not detect some other configured execution condition, and/or, the UE does not perform handover and/or does not access to a target node even if the UE detects that some other configured execution condition is met.

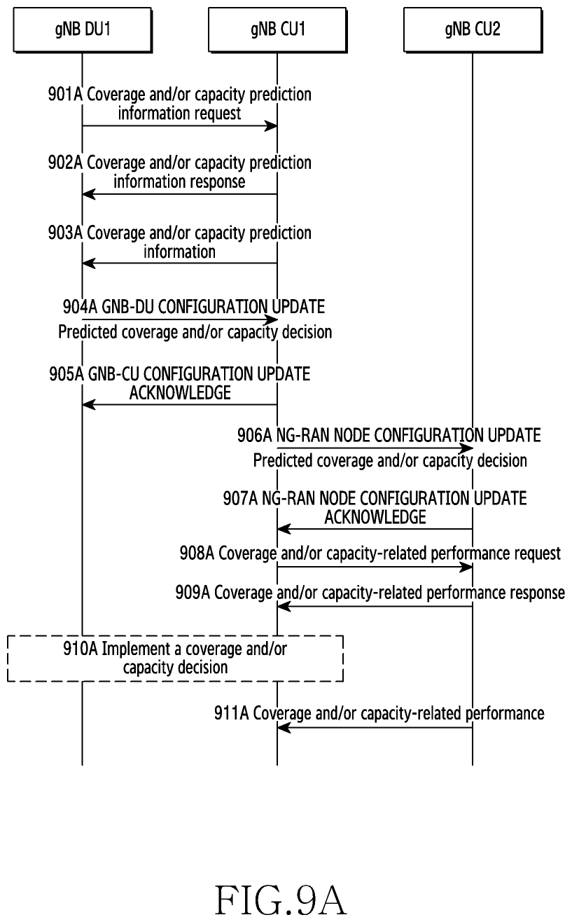

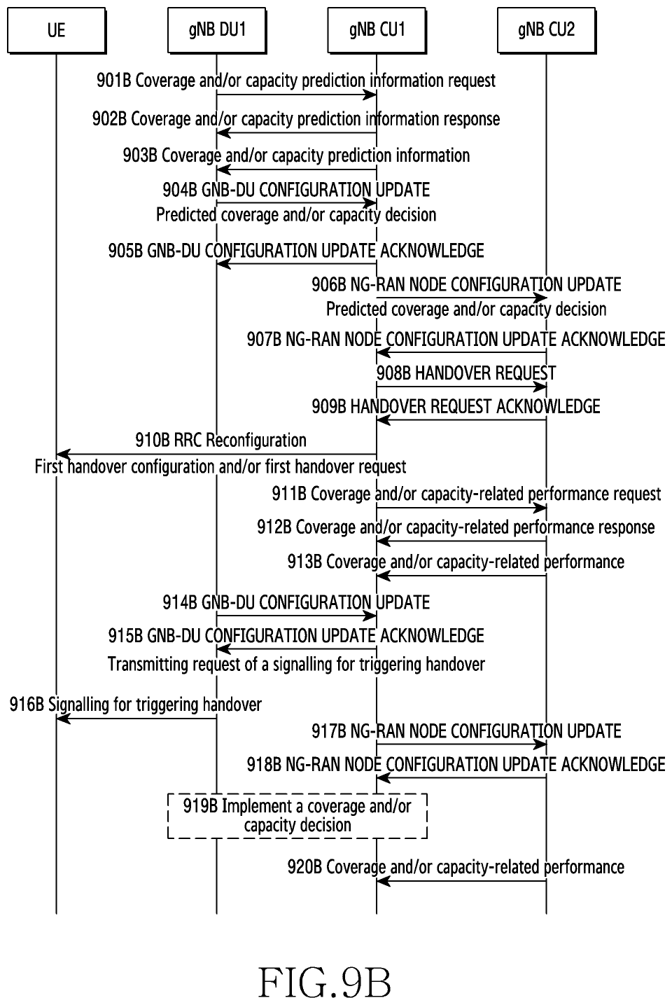

FIG. 9A illustrates a method for supporting coverage optimization according to an embodiment.

Referring to FIG. 9A, a process is shown for exchanging coverage and/or capacity-related prediction information, coverage and/or capacity-related prediction information and coverage and/or capacity-related performance information among nodes.

In step 901A, the gNB DU1 transmits a request for coverage and/or capacity prediction information to gNB CU1. The request for coverage and/or capacity prediction information may be the aforementioned first message.

In step 902A, the gNB CU1 transmits a coverage and/or capacity prediction information response to gNB DU1. The coverage and/or capacity prediction information response may be the aforementioned second message.

In step 903A, the gNB CU1 transmits coverage and/or capacity prediction information (also referred to as first prediction information herein) to gNB DU1. The coverage and/or capacity prediction information may be the aforementioned third message. For example, the coverage and/or capacity prediction information may include first prediction information related to coverage and/or capacity of one or more of gNB DU1, gNB CU1 and their neighboring nodes and/or cells. GNB DU1 can make a self-optimization decision, such as a (predicted) coverage and/or capacity decision, based on the coverage and/or capacity-related prediction information obtained from gNB DU1.

In step 904A, the gNB DU1 transmits a (predicted) coverage and/or capacity decision to gNB CU1. Herein the predicted coverage and/or capacity decision may be the aforementioned seventh message. This message may be carried by a gNB DU configuration update (GNB-DU CONFIGURATION UPDATE) message.

In step 905A, the gNB CU1 transmits a gNB DU configuration update acknowledge (GNB-DU CONFIGURATION UPDATE ACKNOWLEDGE) message to gNB DU1.

In step 906A, the gNB CU1 transmits a (predicted) coverage and/or capacity decision to gNB CU2. The predicted coverage and/or capacity decision may be the aforementioned seventh message and may also be referred to as a thirteenth message here. The predicted coverage and/or capacity decision included in the thirteenth message may include the predicted coverage and/or capacity decision transmitted by gNB DU1 and/or other gNB DUs to gNB CU1. This message may be carried by an NG-RAN node configuration update (NG-RAN NODE CONFIGURATION UPDATE) message.

In step 907A, the gNB CU2 transmits an NG-RAN node configuration update acknowledge (NG-RAN NODE CONFIGURATION UPDATE ACKNOWLEDGE) message to gNB CU1.

In step 908A, the gNB CU1 transmits a coverage and/or capacity-related performance request to gNB CU2. The coverage and/or capacity-related performance request may be the aforementioned eighth message.

In step 909A, the gNB CU2 transmits a coverage and/or capacity-related performance response to gNB CU1. The coverage and/or capacity-related performance response may be the aforementioned ninth message.

In step 910A, the gNB DU1 and/or gNB CU1 change coverage and/or capacity decisions.

In step 911A, the gNB CU2 transmits coverage and/or capacity-related performance information to gNB CU1. The coverage and/or capacity-related performance information may be the aforementioned tenth message. GNB CU1 can evaluate a coverage and/or capacity decision by using the coverage and/or capacity-related performance. For example, a good coverage and/or capacity-related performance can indicate that the coverage and/or capacity decision is appropriate, and a poor coverage and/or capacity-related performance can indicate that the coverage and/or capacity decision is inappropriate and needs to be optimized and updated. Alternatively, gNB CU1 may also use the coverage and/or capacity-related performance to evaluate an AI ML model, e.g., it may evaluate whether the model can continue to be used, and whether the model needs to be trained and/or adjusted, etc. Alternatively, gNB CU1 can also make subsequent coverage and/or capacity decisions by using the coverage and/or capacity-related performance. For example, the coverage and/or capacity-related performance may be input into a decision generation model for making coverage and/or capacity decisions, and the decision generation model outputs relevant coverage and/or capacity decisions. The decision generation model may be a mathematical algorithm or an AI ML model. Alternatively, gNB CU1 may also use the coverage and/or capacity-related performance to evaluate an AI ML model, e.g., it may evaluate whether the model can continue to be used, and whether the model needs to be trained and/or adjusted, etc. The model may be an ML model for any function. Alternatively, gNB CU1 can also use the coverage and/or capacity-related performance to make subsequent decisions. For example, the coverage and/or capacity-related performance may be input into a decision generation model, and the decision generation model outputs relevant decisions. The decision generation model may be a mathematical algorithm or an AI ML model. The decision may be any decision, such as a coverage and/or capacity related decision, slice related decision, mobility related decision and self-optimization related decision. The seventh node can also forward the coverage and/or capacity-related performance information to other nodes. For example, the other node may be gNB DU1.

Steps 901A, 902A, 908A and 909A are optional.

FIG. 9B illustrates a method for supporting coverage optimization according to an embodiment.

Referring to FIG. 9B, a process is shown for exchanging coverage and/or capacity-related prediction information, coverage and/or capacity-related prediction information and coverage and/or capacity-related performance information among nodes.

In step 901B, the gNB DU1 transmits a request for coverage and/or capacity prediction information to gNB CU1. The request for coverage and/or capacity prediction information may be the aforementioned first message.

In step 902B, the gNB CU1 transmits a coverage and/or capacity prediction information response to gNB DU1. The coverage and/or capacity prediction information response may be the aforementioned second message.

In step 903B, the gNB CU1 transmits coverage and/or capacity prediction information (also referred to as first prediction information herein) to gNB DU1. The coverage and/or capacity prediction information may be the aforementioned third message. For example, the coverage and/or capacity prediction information may include first prediction information related to coverage and/or capacity of one or more of gNB DU1, gNB CU1 and their neighboring nodes and/or cells. GNB DU1 can make a self-optimization decision, such as a (predicted) coverage and/or capacity decision, based on the coverage and/or capacity-related prediction information obtained from gNB DU1.

In step 904B, the gNB DU1 transmits a (predicted) coverage and/or capacity decision to gNB CU1 (this may also be referred to as second prediction information related to a coverage and/or capacity decision of gNB DU1). Herein the predicted coverage and/or capacity decision may be the aforementioned seventh message. This message may be carried by a gNB DU configuration update (GNB-DU CONFIGURATION UPDATE) message.

In step 905B, the gNB CU1 transmits a gNB DU configuration update acknowledge (GNB-DU CONFIGURATION UPDATE ACKNOWLEDGE) message to gNB DU1.

In step 906B, the gNB CU1 transmits a (predicted) coverage and/or capacity decision to gNB CU2. Herein the predicted coverage and/or capacity decision may be the aforementioned seventh message. This may also be referred to as a thirteenth message here. The predicted coverage and/or capacity decision included in the thirteenth message may include the predicted coverage and/or capacity decision transmitted by gNB DU1 and/or other gNB DUs to gNB CU1. This message may be carried by an NG-RAN node configuration update (NG-RAN NODE CONFIGURATION UPDATE) message.

In step 907B, the gNB CU2 transmits an NG-RAN node configuration update acknowledge (NG-RAN NODE CONFIGURATION UPDATE ACKNOWLEDGE) message to gNB CU1.

In step 908B, the gNB CU1 transmits a handover request (HANDOVER REQUEST) message to gNB CU2, to hand over the UEs affected by the predicted coverage and/or capacity decision to gNB CU2 to ensure the performance of the UEs. For example, if the predicted coverage and/or capacity decision (related to or acquired by gNB CU1) is to narrow the coverage, UEs that cannot be covered (e.g., cannot be covered by gNB CU1) after the coverage is narrowed may be handed over to a cell that can provide services (e.g., a cell managed by gNB CU2) by this step.

In step 909B, the gNB CU2 transmits a handover request acknowledge (HANDOVER REQUEST ACKNOWLEDGE) message to gNB CU1.

In step 910B, the gNB CU1 transmits a first handover configuration and/or first handover request to the UE. The first handover configuration and/or first handover request may be the aforementioned eleventh message. For example, when the gNB CU and/or gNB DU is to execute a related decision, the message is transmitted to the UE. The relevant decision may include self-optimization decision, coverage and/or capacity decision, etc. For example, when gNB CU1 receives the coverage and/or capacity policy related prediction information predicted by gNB DU1, it transmits this message to relevant users. This message may be carried by an RRC reconfiguration (RRCReconfiguration) message. In some implementations, e.g., after receiving the RRC reconfiguration (RRCReconfiguration) message, the UE transmits an RRC reconfiguration complete (RRCReconfigurationComplete) message to gNB CU1.

In step 911B, the gNB CU1 transmits a coverage and/or capacity-related performance request to gNB CU2. The coverage and/or capacity-related performance request may be the aforementioned eighth message.

In step 912B, the gNB CU2 transmits a coverage and/or capacity-related performance response to gNB CU1. The coverage and/or capacity-related performance response may be the aforementioned ninth message.

In step 913B, the gNB CU2 transmits coverage and/or capacity-related performance information to gNB CU1. The coverage and/or capacity-related performance information may be the aforementioned tenth message. This performance may be the performance before the implementation of a coverage and/or capacity decision (herein, it may be referred to as first performance information).

In step 914B, the gNB DU1 transmits a coverage and/or capacity decision to gNB CU1 by a gNB DU configuration update (GNB-DU CONFIGURATION UPDATE) message. For example, more generally, gNB DU1 may transmit a fourteenth message including a coverage and/or capacity decision of gNB DU1 to gNB CU1.

In step 915B, the gNB CU1 transmits a transmitting request for a signaling for triggering handover to gNB DU1. The transmitting request for a signaling for triggering handover may be the aforementioned twelfth message. This message may be carried by a gNB DU configuration update acknowledge (GNB-DU CONFIGURATION UPDATE ACKNOWLEDGE) message.

In step 916B, the gNB DU1 transmits and/or broadcasts a signaling for triggering handover to the UE. The signaling for triggering handover may refer to the signaling for triggering handover in the twelfth message. In some implementations, e.g., when gNB DU1 is to modify and/or currently decides to modify a coverage and/or capacity decision, it transmits and/or broadcasts a signaling for triggering handover to the UE. Alternatively, when the (predicted) load condition and/or resource status of gNB DU1 is to be overloaded, a signaling for triggering handover is transmitted and/or broadcast to the UE. After receiving the signaling for triggering handover, the UE accesses the target cell (e.g., a cell managed by gNB CU2), and/or, the UE accesses the target cell (e.g., a cell managed by gNB CU2) when other execution conditions received in in step 910B are met. The signaling for triggering handover may be a MAC CE and/or an RRC message and/or an RRC container and/or a physical layer signaling.

In step 917B, the gNB CU1 transmits a coverage and/or capacity decision to gNB CU2 by using an NG-RAN node configuration update (NG-RAN NODE CONFIGURATION UPDATE) message.

In step 918B, the gNB CU2 transmits an NG-RAN node configuration update acknowledge (NG-RAN NODE CONFIGURATION UPDATE ACKNOWLEDGE) message to gNB CU1.

In step 919B, the gNB DU1 and/or gNB CU1 change coverage and/or capacity decisions.

In step 920B, the gNB CU2 transmits coverage and/or capacity-related performance information (this may be referred to as second performance information) to gNB CU1. The coverage and/or capacity-related performance information may be the aforementioned tenth message. GNB CU1 can evaluate a coverage and/or capacity decision by using the coverage and/or capacity-related performance. For example, a good coverage and/or capacity-related performance can indicate that the coverage and/or capacity decision is appropriate, and a poor coverage and/or capacity-related performance can indicate that the coverage and/or capacity decision is inappropriate and needs to be optimized and updated. Alternatively, gNB CU1 may also use the coverage and/or capacity-related performance to evaluate an AI ML model, e.g., it may evaluate whether the model can continue to be used, and whether the model needs to be trained and/or adjusted, etc. Alternatively, gNB CU1 can also make subsequent coverage and/or capacity decisions by using the coverage and/or capacity-related performance. For example, the coverage and/or capacity-related performance may be input into a decision generation model for making coverage and/or capacity decisions, and the decision generation model outputs relevant coverage and/or capacity decisions. The decision generation model may be a mathematical algorithm or an AI ML model. Alternatively, gNB CU1 may also use the coverage and/or capacity-related performance to evaluate an AI ML model, e.g., it may evaluate whether the model can continue to be used, and whether the model needs to be trained and/or adjusted, etc. The model may be a ML model for any function. Alternatively, gNB CU1 can also use the coverage and/or capacity-related performance to make subsequent decisions. For example, the coverage and/or capacity-related performance may be input into a decision generation model, and the decision generation model outputs relevant decisions. The decision generation model may be a mathematical algorithm or an AI ML model. The decision may be any decision, such as a coverage and/or capacity related decision, slice related decision, mobility related decision and self-optimization related decision. The seventh node can also forward the coverage and/or capacity-related performance information to other nodes. For example, the other node may be gNB DU1. In some implementations, gNB CU1 may evaluate a coverage and/or capacity decision by comparing the first performance information and the second performance information above.

Step 901Bs 902B, 903B, 906B, 911B and 912B are optional.

The various example aspects, methods, steps, processes, etc. shown above in conjunction with the drawings can be combined and implemented in any way, which are not limited herein.

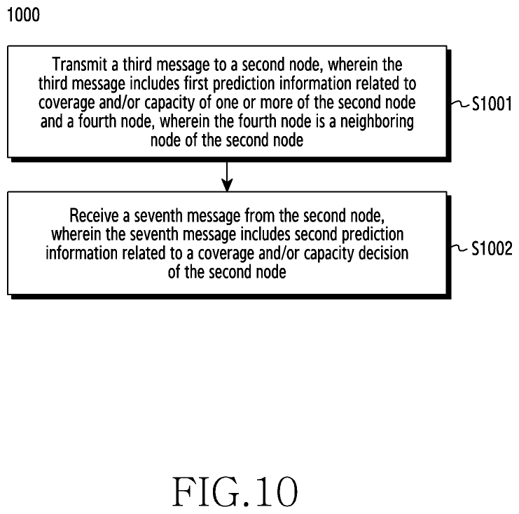

FIG. 10 illustrates a method 1000 performed by a first node in a wireless communication system according to an embodiment.

Referring to FIG. 10, in step S1001, the first node transmits a third message to a second node, wherein the third message includes first prediction information related to coverage and/or capacity of one or more of the second node and a fourth node, wherein the fourth node is a neighboring node of the second node.

In step S1002, the first node receives a seventh message from the second node, wherein the seventh message includes second prediction information related to a coverage and/or capacity decision of the second node.

The method may further include transmitting a thirteenth message to a third node, wherein the thirteenth message includes the second prediction information.

The second prediction information is determined based on the first prediction information.

The method may further include transmitting a handover request message to a third node; and transmitting an eleventh message about a first handover configuration and/or first handover request to a (UE), wherein the eleventh message includes a first execution condition for the UE to perform conditional handover, information about serving a replacing cell included in the second prediction information as a handover target cell, information of a handover target cell, wherein the first execution condition includes receiving a signaling that the second node is to change a coverage and/or capacity decision, receiving a signaling that handover can be performed, receiving a signaling for triggering handover, receiving a signaling for validation and/or activation of an execution condition, and receiving a signaling for invalidation and/or deactivation of an execution condition.

The method may further include receiving a fourteenth message from the second node, wherein the fourteenth message includes a coverage and/or capacity decision of the second node; and transmitting a twelfth message to the second node, wherein the twelfth message includes a transmitting request for a signaling for triggering a UE to perform handover, wherein the signaling for triggering the UE to perform handover is transmitted from the second node to the UE based on the transmitting request.

The method may further include transmitting the coverage and/or capacity decision of the second node to the third node.

The method may further include receiving first performance information related to coverage and/or capacity of the third node from the third node; performing the coverage and/or capacity decision; and receiving second performance information related to coverage and/or capacity of the third node from the third node.

The method may further include evaluating the coverage and/or capacity decision based on a comparison of the first performance information and the second performance information.

The method may further include transmitting a coverage and/or capacity policy suggested by the first node and/or a coverage and/or capacity policy allowed by the first node to the second node.

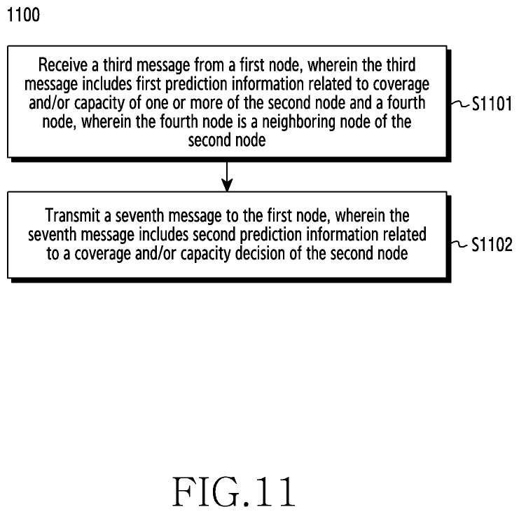

FIG. 11 illustrates a method 1100 performed by a second node in a wireless communication system according to an embodiment.

Referring to FIG. 11, in step S1101, the second node receives a third message from a first node, wherein the third message includes first prediction information related to coverage and/or capacity of one or more of the second node and a fourth node, wherein the fourth node is a neighboring node of the second node.

In step S1102, the second node transmits a seventh message to the first node, wherein the seventh message includes second prediction information related to a coverage and/or capacity decision of the second node. The second prediction information may be transmitted by the first node to a third node.

The second prediction information is determined based on the first prediction information.

The method may further include transmitting a fourteenth message to the first node, wherein the fourteenth message includes a coverage and/or capacity decision of the second node; and receiving a twelfth message from the first node, wherein the twelfth message includes a transmitting request for a signaling for triggering a UE to perform handover, wherein the signaling for triggering the UE to perform handover is transmitted from the second node to the UE based on the transmitting request.

The method may further include receiving a coverage and/or capacity policy suggested by the first node and/or a coverage and/or capacity policy allowed by the first node from the first node.

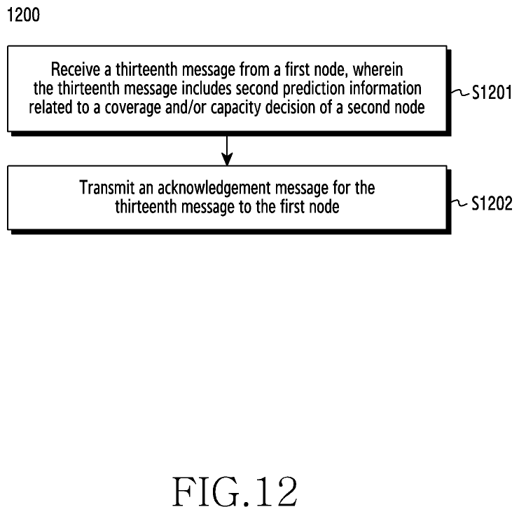

FIG. 12 illustrates a method 1200 performed by a third node in a wireless communication system according to an embodiment.

Referring to FIG. 12, in step S1201, the third node receives a thirteenth message from a first node, wherein the thirteenth message includes second prediction information related to a coverage and/or capacity decision of a second node.

In step S1202, the third node transmits an acknowledgement message for the thirteenth message to the first node. The second prediction information is received by the first node from the second node. The second prediction information is determined by the second node based on first prediction information related to coverage and/or capacity of one or more of the second node and a fourth node, where the fourth node is a neighboring node of the second node.

The method may further include receiving a handover request message from the first node.

The method may further include receiving a coverage and/or capacity decision of the second node from the first node.

The method may further include transmitting first performance information related to coverage and/or capacity of the third node to the first node; and transmitting second performance information related to coverage and/or capacity of the third node to the first node after the coverage and/or capacity decision is performed.

The coverage and/or capacity decision is evaluated based on a comparison of the first performance information and the second performance information.

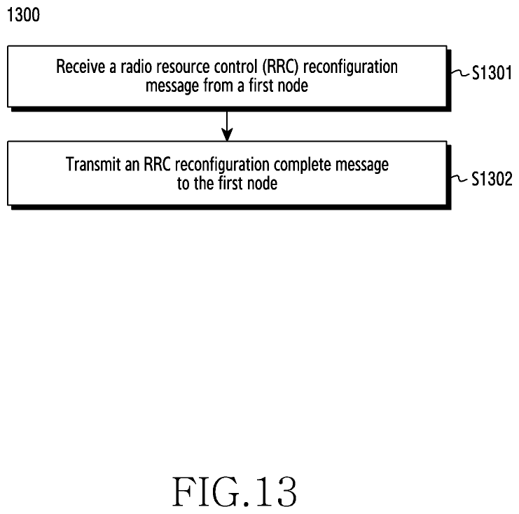

FIG. 13 illustrates a method 1300 performed by a UE in a wireless communication system according to an embodiment.

Referring to FIG. 13, in step S1301, the UE receives an RRC reconfiguration message from a first node.

In step S1302, the UE transmits an RRC reconfiguration complete message to the first node. The RRC reconfiguration message includes an eleventh message about a first handover configuration and/or first handover request. In some implementations, a third message is transmitted from the first node to a second node, wherein the third message includes first prediction information related to coverage and/or capacity of one or more of the second node and a fourth node, wherein the fourth node is a neighboring node of the second node. In some implementations, a seventh message is received by the first node from the second node, wherein the seventh message includes second prediction information related to a coverage and/or capacity decision of the second node.

The RRC reconfiguration message includes an eleventh message about a first handover configuration and/or first handover request; and wherein the eleventh message includes a first execution condition for the UE to perform conditional handover, information about serving a replacing cell included in the second prediction information as a handover target cell, information of a handover target cell, wherein the first execution condition includes receiving a signaling that the second node is to change a coverage and/or capacity decision, receiving a signaling that handover can be performed, receiving a signaling for triggering handover, receiving a signaling for validation and/or activation of an execution condition, and receiving a signaling for invalidation and/or deactivation of an execution condition.

The method may further include receiving a signaling for triggering handover from the second node.

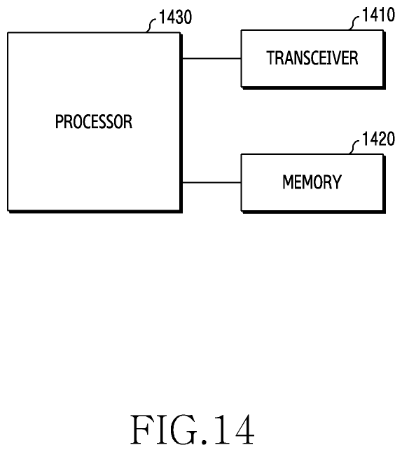

FIG. 14 illustrates a node according to an embodiment.

Referring to FIG. 14, a node (or a base station, e.g., the first node, the second node and/or the third node as described above) may include a transceiver 1410, a memory 1420, and a processor 1430. The transceiver 1410, the memory 1420, and the processor 1430 of the base station may operate according to a communication method of the base station described above. However, the components of the base station are not limited thereto. For example, the base station may include more or fewer components than those described above. In addition, the processor 1430, the transceiver 1410, and the memory 1420 may be implemented as a single chip. Also, the processor 1430 may include at least one processor. Furthermore, the base station of FIG. 14 corresponds to the base station of FIG. 2.

The transceiver 1410 collectively refers to a base station receiver and a base station transmitter, and may transmit/receive a signal to/from a terminal (UE) or a network entity. The signal transmitted or received to or from the terminal or a network entity may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the base station. Also, the memory 1420 may store control information or data included in a signal obtained by the base station. The memory 1420 may be a storage medium, such as read-only memory (ROM), random access memory (RAM), a hard disk, a CD-ROM, and a DVD, or a combination of storage media.

The processor 1430 may control a series of processes such that the base station operates as described above. For example, the transceiver 1410 may receive a data signal including a control signal transmitted by the terminal, and the processor 1430 may determine a result of receiving the control signal and the data signal transmitted by the terminal.

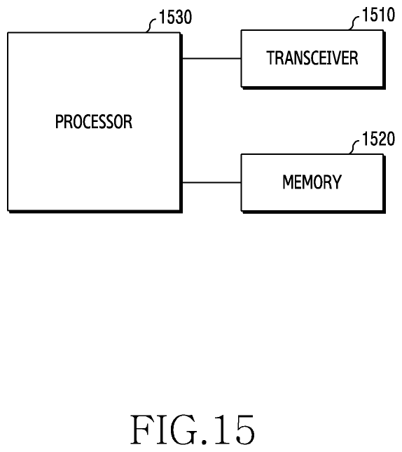

FIG. 15 illustrates a UE according to an embodiment.

As shown in FIG. 15, the UE according to an embodiment may include a transceiver 1510, a memory 1520, and a processor 1530. The transceiver 1510, the memory 1520, and the processor 1530 of the UE may operate according to a communication method of the UE described above. However, the components of the UE are not limited thereto. For example, the UE may include more or fewer components than those described above. In addition, the processor 1530, the transceiver 1510, and the memory 1520 may be implemented as a single chip. Also, the processor 1530 may include at least one processor. Furthermore, the UE of FIG. 15 corresponds to the UE of the FIG. 3.

The transceiver 1510 collectively refers to a UE receiver and a UE transmitter, and may transmit/receive a signal to/from a base station or a network entity. The signal transmitted or received to or from the base station or a network entity may include control information and data. The transceiver 1510 may include a RF transmitter for up-converting and amplifying a frequency of a transmitted signal, and a RF receiver for amplifying low-noise and down-converting a frequency of a received signal. However, this is only an example of the transceiver 1510 and components of the transceiver 1510 are not limited to the RF transmitter and the RF receiver.

Also, the transceiver 1510 may receive and output, to the processor 1530, a signal through a wireless channel, and transmit a signal output from the processor 1530 through the wireless channel.

The memory 1520 may store a program and data required for operations of the UE. Also, the memory 1520 may store control information or data included in a signal obtained by the UE. The memory 1520 may be a storage medium, such as read-only memory (ROM), random access memory (RAM), a hard disk, a CD-ROM, and a DVD, or a combination of storage media.

The processor 1530 may control a series of processes such that the UE operates as described above. For example, the transceiver 1510 may receive a data signal including a control signal transmitted by the base station or the network entity, and the processor 1530 may determine a result of receiving the control signal and the data signal transmitted by the base station or the network entity.

Embodiments of the present disclosure also provide a computer-readable medium having stored thereon computer-readable instructions which, when executed by a processor, implement any method according to an embodiment.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a first node in a wireless communication system, the method comprising:
transmitting, to a second node, via an Xn interface or an F1 interface, first information including prediction information on optimization of a capacity and a coverage; and
receiving, from the second node, via the Xn interface or the F1 interface, second information based on the first information.

2. The method of claim 1,
wherein the first information is based on artificial intelligence (AI) and machine learning (ML).

3. The method of claim 1,
wherein the first information further includes at least one of information on a cause or information on a time corresponding to the prediction information.

4. The method of claim 1,
wherein the first node includes a first g NodeB (gNB) or a gNB-distributed unit (gNB-DU), and
wherein the second node includes a second gNB or a gNB-central unit (gNB-CU).

5. A method performed by a second node in a wireless communication system, the method comprising:
receiving, from a first node, via an Xn interface or an F1 interface, first information including prediction information on optimization of a capacity and a coverage; and
transmitting, to the first node, via the Xn interface or the F1 interface, second information generated based on the first information.

6. The method of claim 5,
wherein the first information is based on artificial intelligence (AI) and machine learning (ML).

7. The method of claim 5,
wherein the first information further includes at least one of information on a cause or information on a time corresponding to the prediction information.

8. The method of claim 5,
wherein the first node includes a first g NodeB (gNB) or a gNB-distributed unit (gNB-DU), and
wherein the second node includes a second gNB or a gNB-central unit (gNB-CU).

9. A first node in a wireless communication system, the first node comprising:
a transceiver; and
at least one processor coupled with the transceiver and configured to:
transmit, to a second node, via an Xn interface or an F1 interface, first information including prediction information on optimization of a capacity and a coverage, and
receive, from the second node, via the Xn interface or the F1 interface, second information based on the first information.

10. The first node of claim 9,
wherein the first information is based on artificial intelligence (AI) and machine learning (ML).

11. The first node of claim 9,
wherein the first information further includes at least one of information on a cause or information on a time corresponding to the prediction information.

12. The first node of claim 9,
wherein the first node includes a first g NodeB (gNB) or a gNB-distributed unit (gNB-DU), and
wherein the second node includes a second gNB or a gNB-central unit (gNB-CU).

13. A second node in a wireless communication system, the second node comprising:
a transceiver; and
at least one processor coupled with the transceiver and configured to:
receive, from a first node, via an Xn interface or an F1 interface, first information including prediction information on optimization of a capacity and a coverage, and
transmit, to the first node, via the Xn interface or the F1 interface, second information generated based on the first information.

14. The second node of claim 13,
wherein the first information is based on artificial intelligence (AI) and machine learning (ML).

15. The second node of claim 13,
wherein the first information further includes at least one of information on a cause or information on a time corresponding to the prediction information.

16. The second node of claim 13,
wherein the first node includes a first g NodeB (gNB) or a gNB-distributed unit (gNB-DU), and
wherein the second node includes a second gNB or a gNB-central unit (gNB-CU).
